(19) United States
(12) Patent Application Publication
(10) Pub. No.: US 2026/0231117 A1
(43) Pub. Date: Aug. 6, 2026

(54) USER EQUIPMENT ASSISTED FALLBACK FOR TIMING ADVANCE

(71) Applicant: Telefonaktiebolaget LM Ericsson (PUBL), Stockholm (SE)

(72) Inventors: Icaro Leonardo DA SILVA, SOLNA (SE); Claes TIDESTAV, BÅLSTA (SE); Antonino ORSINO, KIRKKONUMMI (FI); Jens BERGQVIST, LINKÖPING (SE)

(21) Appl. No.: 19/147,778

(22) PCT Filed: Jan. 16, 2024
(86) PCT No.: PCT/SE2024/050031

§ 371 Date: Jul. 14, 2025

Related U.S. Application Data
(60) Provisional application No. 63/439,205, filed on Jan. 16, 2023.

(51) Int. Cl. H04W 72/044

(52) U.S. Cl. CPC H04W 72/044

(57) ABSTRACT

A method is performed by a wireless device for layer one (L1)/layer two (L2) triggered mobility (LTM). The method comprises: obtaining an uplink configuration for an LTM candidate cell; receiving an indication from a serving cell to perform an uplink transmission in the LTM candidate cell; transmitting a first uplink transmission in the LTM candidate cell; and monitoring for a response from the serving cell indicating a result of the first uplink transmission. When the response is received from the serving cell within a preconfigured threshold time, the method comprises determining the first uplink transmission cell is successful. When the response is not received from the serving cell, the method further comprises transmitting a second uplink transmission in a second LTM candidate cell.

### TECHNICAL FIELD

Embodiments of the present disclosure are directed to wireless communications and, more particularly, to user equipment (UE) assisted fallback for time alignment during mobility.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Fifth generation (5G) New Radio (NR) wireless networks use timing advance (TA) for uplink synchronization. Different user equipment (UE) in the same cell may typically be located at different positions within the cell and then with different distances to the base station (e.g., NR gNodeB). The transmissions from different UEs thus suffer from different delays until they reach the base station. To ensure that the uplink (UL) transmissions from a UE reaches the base station within the corresponding receive window for the base station, an uplink timing control procedure is therefore used. This avoids intracell interference occurring, both between UEs assigned to transmit in consecutive subframes and between UEs transmitting on adjacent subcarriers.

Time alignment of the uplink transmissions is achieved by applying a timing advance at the UE transmitter, relative to the received downlink timing. The main role of this is to counteract differing propagation delays between different UEs, as shown in the example below for an LTE eNodeB:

To achieve the time alignment, to obtain uplink synchronization, the base station (e.g., gNodeB, eNodeB) derives the TA value that the UE needs to use for the uplink transmissions to reach the base station within the receive window and indicates this to the UE. When the UE first accesses a cell, the UE uses a random-access procedure where the received Msg1 (the physical random access channel (PRACH) preamble) is used by the base station to determine the UE's initial TA to use for uplink transmissions in the cell. During the connection the base station then continuously monitors whether the UE needs to advance/delay the uplink transmissions to compensate for changes in propagation delay, and indicates to the UE if there is a need to change the TA value. The timing advance value may be referred as TA value and may either be an actual timing adjustment value to be applied and/or an index (e.g., TA) pointing to a timing adjustment value to be applied.

When the UE has a connection to several different serving cells, the same TA value may sometimes be used for more than one of the cells, e.g., if the cells are co-located and thus always would have the same distance to a UE. Such cells can then be configured as belonging to the same timing advance group (TAG). The configuration of TAGs is done per cell group, i.e., serving cells may be configured as belonging to the same TAG only if they belong to the same cell group (master cell group (MCG) or secondary cell group (SCG)). Further details are provided below.

When the UE does not perform uplink transmissions for some time in a serving cell, the TA value that the UE used earlier may no longer be accurate, e.g., because the UE has moved and thus has a different propagation delay. In that case, if the UE performs an uplink transmission using the latest received TA value, the uplink transmission may reach the base station outside the receive window and thus not be correctly received by the base station. The transmission may then even interfere with other uplink transmissions (from other UEs). A timer timeAlignmentTimer (which may be referred as a time alignment timer or TA timer) is therefore configured for each TAG to indicate how long the UE can consider itself to be uplink time aligned to serving cells belonging to the associated TAG without receiving any updates to the TA value. The timeAlignmentTimer thus indicates how long a duration of time the UE may consider a received TA value as valid. If the UE does not receive an updated value before timeAlignmentTimer expires, the UE is no longer uplink synchronized to the serving cells belonging to the corresponding TAG.

A random access (RA) procedure in NR comprises a UE first selecting a beam by selecting a synchronization signal block (SSB) or channel state information reference signal (CSI-RS) resource of a target cell in which the UE intends to perform the RA procedure. The selected SSB or CSI-RS resource maps to a RA resource (i.e., a preamble and/or a time/frequency resource of a RA channel (RACH) of the target cell).

The UE transmits the selected preamble in the selected RACH resource to a cell and expects to receive a RA response (RAR) during a configured RAR time window in that cell. If the UE transmits the preamble and does not receive the RAR during the configured RAR time window, the UE performs what is referred to as RA fallback, which consists of the UE performing a re-selection of a RA resource, by the selection of a new beam (i.e., new SSB and/or CSI-RS) mapping to a new RA resource and/or a preamble power ramping (i.e., increasing the transmission power for the preamble transmission). This may be done up to a maximum number of times configured by the network, and when the maximum number is reached, the UE declares a RA failure.

This may be summarized as follows, for the case of a contention-based random access during a reconfiguration with sync to a target cell:

[38.321]

### 5.1.4 Random Access Response Reception

Once the Random Access Preamble is transmitted and regardless of the possible occurrence

[...]

| 1> | if ra-ResponseWindow configured in RACH-ConfigCommon expires, and if the | | | |
|---|---|---|---|---|
| | Random Access Response containing Random Access Preamble identifiers that | | | |
| | matches the transmitted PREAMBLE_INDEX has not been received: | | | |
| | 2> | consider the Random Access Response reception not successful; | | |
| | 2> | increment PREAMBLE_TRANSMISSION_COUNTER by 1; | | |
| | 2> | if PREAMBLE_TRANSMISSION_COUNTER = preambleTransMax + 1: | | |
| | | 3> | if the Random Access Preamble is transmitted on the SpCell: | |
| | | | 4> | indicate a Random Access problem to upper layers; |
| | | | [...] | |
| | 2> | if the Random Access procedure is not completed: | | |
| | | 3> | select a random backoff time according to a uniform distribution between 0 and | |
| | | | the PREAMBLE_BACKOFF; | |
| | | 3> | if the criteria (as defined in clause 5.1.2) to select contention-free Random Access | |
| | | | Resources is met during the backoff time: | |
| | | | 4> | perform the Random Access Resource selection procedure (see clause 5.1.2); |
| | | 3> | else: | |
| | | | 4> | perform the Random Access Resource selection procedure (see clause 5.1.2) |
| | | | | after the backoff time. |
| [...] | | | | |

[38.321]

### 5.1.2 Random Access Resource Selection

The MAC entity shall:

| | [...] | |
|---|---|---|
| 1> | else (i.e. for the contention-based Random Access preamble selection): | |
| | 2> | if at least one of the SSBs with SS-RSRP above rsrp-ThresholdSSB is available: |

| | |
|---|---|
| 3> | select an SSB with SS-RSRP above rsrp-ThresholdSSB. |

| | |
|---|---|
| 2> | else: |

| | |
|---|---|
| 3> | select any SSB. |
| | [...] |

| | 2> | select a Random Access Preamble randomly with equal probability from the |
|---|---|---|
| | | Random Access Preambles associated with the selected SSB and the selected |
| | | Random Access Preambles group. |
| | 2> | set the PREAMBLE_INDEX to the selected Random Access Preamble. |
| | [...] | |
| 1> | else if an SSB is selected above: | |
| | 2> | determine the next available PRACH occasion from the PRACH occasions |
| | | corresponding to the selected SSB permitted by the restrictions given by the ra-ssb- |
| | | OccasionMaskIndex if configured or indicated by PDCCH (the MAC entity shall |
| | | select a PRACH occasion randomly with equal probability amongst the consecutive |
| | | PRACH occasions according to clause 8.1 of TS 38.213, corresponding to the |
| | | selected SSB; the MAC entity may take into account the possible occurrence of |
| | | measurement gaps when determining the next available PRACH occasion |
| | | corresponding to the selected SSB). |

| | |
|---|---|
| 1> | else if a CSI-RS is selected above: |

[...]

| | |
|---|---|
| 1> | perform the Random Access Preamble transmission procedure (see clause 5.1.3). |

| NOTE: | When the UE determines if there is an SSB with SS-RSRP above rsrp- |
|---|---|
| | ThresholdSSB or a CSI-RS with CSI-RSRP above rsrp-ThresholdCSI-RS, the UE |
| | uses the latest unfiltered L1-RSRP measurement. |

### 5.1.3 Random Access Preamble Transmission

The MAC entity shall, for each Random Access Preamble:

| | |
|---|---|
| 1> | if PREAMBLE_TRANSMISSION_COUNTER is greater than one; and |
| 1> | if the notification of suspending power ramping counter has not been received from |
| | lower layers; and |
| 1> | if SSB or CSI-RS selected is not changed from the selection in the last Random Access |
| | Preamble transmission: |
| | 2> increment PREAMBLE_POWER_RAMPING_COUNTER by 1. |
| 1> | select the value of DELTA_PREAMBLE according to clause 7.3; |
| 1> | set PREAMBLE_RECEIVED_TARGET_POWER to preambleReceivedTargetPower + |
| | DELTA_PREAMBLE + (PREAMBLE_POWER_RAMPING_COUNTER − 1) × |
| | PREAMBLE_POWER_RAMPING_STEP; |
| 1> | except for contention-free Random Access Preamble for beam failure recovery request, |
| | compute the RA-RNTI associated with the PRACH occasion in which the Random |
| | Access Preamble is transmitted; |
| 1> | instruct the physical layer to transmit the Random Access Preamble using the selected |
| | PRACH occasion, corresponding RA-RNTI (if available), PREAMBLE_INDEX and |
| | PREAMBLE_RECEIVED_TARGET_POWER. |
| [...] | |

Third Generation Partnership Project (3GPP) work includes a work item on further NR mobility enhancements, in particular, in a technical area entitled L1/L2 based inter-cell mobility. See Work Item Description (WID) in RP-213565 for further details.

According to the WID, when a UE moves from the coverage area of one cell to another cell, at some point a serving cell change needs to be performed. Currently, serving cell change is triggered by layer three (L3) measurements and is done by Radio Resource Control (RRC) signaling triggered Reconfiguration with Synchronization for change of PCell and PSCell, as well as release add for SCells when applicable. All cases involve complete layer two (L2) (and layer one (L1)) resets, leading to longer latency, larger overhead and longer interruption time than beam switch mobility. The goal of L1/L2 mobility enhancements is to enable a serving cell change via L1/L2 signaling to reduce the latency, overhead, and interruption time.

One goal is that L1-L2 inter-cell mobility should be like an inter-cell beam management, i.e., to support L1-L2 inter-cell mobility the UE should be configured to perform measurements on cells that are not the serving cells as defined up to Rel-17. In Rel-17, to support inter-PCI mTRP operation, a solution has been standardized where a CSI resource may be associated to a primary cell identifier (PCI) that is not the same PCI of one of the serving cells. In that solution, the UE receives an explicit indication of which beams (SSBs) and PCIs to be measured for a given reporting configuration.

The goal is to specify mechanism and procedures of L1/L2 based inter-cell mobility for mobility latency reduction. These include: configuration and maintenance for multiple candidate cells to facilitate fast application of configurations for candidate cells; dynamic switch mechanism among candidate serving cells (including SpCell and SCell) for the potential applicable scenarios based on L1/L2 signaling; L1 enhancements for inter-cell beam management, including L1 measurement and reporting, and beam indication; timing advance management; and CU-DU interface signaling to support L1/L2 mobility, if needed.

The procedure of L1/L2 based inter-cell mobility is applicable to the following scenarios: standalone, carrier aggregation (CA) and NR dual connectivity (DC) case with serving cell change within one CG; intra-DU case and intra-CU inter-DU case (applicable for standalone and CA); both intra-frequency and inter-frequency; both frequency range one (FR1) and frequency range two (FR2); and source and target cells may be synchronized or non-synchronized.

There currently exist certain challenges. For example, one of the issues to resolve for L1/L2 inter-cell mobility is the timing advance management (which may include the handling of a time alignment timer). In legacy L3 handover, the timing advance is established between the UE and the target cell with a random access procedure by the UE transmitting a preamble to the target cell and receiving a RAR from the target cell, including a time alignment value to be applied.

The performance enhancements for L1/L2-based inter-cell mobility to reduce handover interruption time include solutions to reduce the time for UE reconfiguration and downlink and uplink synchronization after handover decision. In one proposed solution, a UE transmits a RA preamble to a candidate cell and, differently from a legacy RA procedure, the UE does not expect a RAR including a TA value from the candidate cell in response. Instead, the UE transmits the RA preamble to enable the candidate target network node (e.g., candidate Distributed Unit—DU) to calculate the timing advance value (i.e., the amount of timing adjustment the UE needs to apply for uplink synchronization) and provide that value (or an index/indication of that value) to the source DU (S-DU). The S-DU may provide that value or associated value to the UE only when it is time to execute L1/L2 triggered mobility (LTM) to the candidate cell. An example is illustrated in FIGS. 1A and 1B.

FIGS. 1A and 1B is a flowchart illustrating an example in which the TA establishment based on RA preamble transmission to candidate and reception of TA value only at LTM execution, e.g., in the MAC CE for the LTM cell switch command. In this solution, the UE can transmit a preamble to enable the network to calculate the timing advance value for a candidate cell without the need for the UE to wait for the reception of a RAR in the candidate cell. This reduces the interruption in the transmissions/receptions in the source cell, because after the RA preamble transmission in the candidate cell, the UE would also have to monitor a control channel (like physical downlink control channel (PDCCH)) in the candidate cell for the possible reception of the RAR.

3GPP work items includes the following agreements regarding LTM.
On mechanism to acquire TA of the candidate cell(s) in Rel-18 LTM, at least support PDCCH ordered RACH.
   The PDCCH order is only triggered by source cell
Support TA acquisition of candidate cell(s) before cell switch command is received in L1/L2 based mobility.
For PDCCH ordered RACH in LTM, at least the following enhancements are supported
   Introduce indication of candidate cell and/or RO of candidate cell in DCI
   configuration of RACH resource for candidate cell(s) is provided prior to the PDCCH order
TA updating (i.e. re-acquisition of TA) for candidate cell can be triggered by NW.
   same triggering mechanism reuse the initial TA acquisition, i.e., PDCCH order triggered RACH in a candidate cell

The fact that the UE does not expect a RAR in the candidate cell after transmitting a RA preamble creates problems, because it is the reception of the RAR from the cell in which the UE transmits the preamble that acknowledges to the UE that a preamble transmission was successfully received by the network, based on which the UE knows that it does not need to take further actions for the network to detect the uplink preamble transmission. Thus, without a RAR from the candidate cell, the UE does not know whether the preamble was successfully received or not, and/or whether the UE needs to re-transmit the preamble. At the same time, having a RAR from the LTM candidate cell means that the UE needs to monitor the control channel of the LTM candidate cell, which increases the interruption with the source cell.

### SUMMARY

As described above, certain challenges currently exist with s fallback for time alignment during mobility. Certain aspects of the present disclosure and their embodiments may provide solutions to these or other challenges. For example, particular embodiments user equipment (UE) assisted fallback for timing advance (TA) establishment/updating.

Some embodiments include a method at a UE capable of layer one (L1)/layer two (L2) triggered mobility (LTM) and configured with at least one LTM candidate cell. The method comprises handling of failed attempt(s) to perform TA establishment and/or TA updating (e.g., by the UE performing another preamble transmission). The method comprises the UE receiving (1) a first downlink (DL) indication from a serving cell (of or served by a source network node, a Source DU (S-DU)), and (2) in response to the first DL indication the UE transmitting to the LTM candidate cell a first uplink (UL) message (e.g., a first random access (RA) preamble), wherein the UL message is transmitted with a first transmission power and on a first UL resource (e.g., RA resources in time and frequency).

In some embodiments, the UE selects a first beam, and based on the selected first beam, the UE selects a first UL resource associated to the first beam for transmitting the first UL message.

The UE starts a timer (e.g., a random access response (RAR)-like timer/supervision timer, or the UE starts a time window with start and duration/end) when the UE transmits the first UL message to the LTM candidate cell and monitors a DL response indication from the serving cell. When the UE receives the DL response indication, while the timer is running (or within the time window), the UE considers the transmission of the first UL message successful. When the timer expires (i.e., UE does not receive the DL response indication while the timer is still running, or the UE does not receive the DL response indication within the time window), the UE considers the transmission of the first UL message/signal as a failed transmission attempt (or a failed preamble transmission attempt, when the first UL message is a RA preamble), and in response to the failed attempt, the UE transmits a second UL message (e.g., a second RA preamble) to a LTM candidate cell, wherein the second UL message (e.g., second RA preamble) is transmitted to a LTM candidate cell according to: i) an incremented transmission power compared to the first transmission power or ii) on a second UL resource (e.g., RA resources in time and frequency).

In some embodiments, the UE transmits the first UL message to a first LTM candidate cell and monitors a DL response indication from the serving cell. When the timer expires (i.e., UE does not receive the DL response indication while the timer is still running, or the UE does not receive the DL response indication within the time window), the UE considers the transmission of the first UL message/signal as a failed transmission attempt and in response the UE transmits a second UL message to a second LTM candidate cell. In one option, the first and the second LTM candidate cells are the same cells. In one option, the first and the second LTM candidate cells are different cells.

In some embodiments, in response to the expiry of the timer (or the end of the time window) without the reception of the DL response indication, the UE selects a second beam (e.g., synchronization signal block (SSB) or channel state information reference signal (CSI-RS) of the LTM candidate cell), and based on the selected second beam the UE selects the second UL resource (e.g., RA resources in time and frequency) associated to the LTM candidate cell for transmitting the second UL message. The UE transmits the second UL message and starts (re-starts) the timer, and while the timer is running the UE monitors in the serving cell the reception of the DL response indication.

In some embodiments, the UE selects a first beam of a first LTM candidate cell and, based on the selected first beam of the first LTM candidate cell, the UE selects a first UL resource associated with the first beam and transmits the first UL message; when the timer expires (or the end of the time window) without the reception of the DL response indication, the UE selects a second beam (e.g., SSB or CSI-RS of the LTM candidate cell) of a second LTM candidate cell and, based on the selected second beam of the second LTM candidate cell, the UE selects the second UL resource (e.g., RA resources in time and frequency) associated to the second LTM candidate cell, for transmitting the second UL message. The UE transmits the second UL message and starts (re-starts) the timer, and while the timer is running the UE monitors in the serving cell the reception of the DL response indication.

In more general terms, the UE transmits an (n+1)-th UL message (e.g., an (n+1)-th RA preamble) to a LTM candidate cell, wherein the (n+1)-th UL message (e.g., (n+1)-th RA preamble) is transmitted to the LTM candidate cell according to: i) an incremented transmission power compared to the n-th transmission power or ii) on an (n+1)-th UL resource (e.g., RA resources in time and frequency). Upon transmitting the (n+1)-th UL message the UE starts (re-starts) the timer (supervision timer, RAR-like timer, or starts the time window) and monitors the reception of a DL response indication. In other words, the process is repeated until the UE receives a DL response indication from a serving cell, or the process is repeated until a maximum number of attempts is reached.

In some embodiments, in response to the expiry of the timer (or the end of the time window without the reception of the n-th DL response indication), the UE selects a k-th beam (e.g. SSB or CSI-RS of the LTM candidate cell), and based on the selected k-th beam the UE selects the (n+1)-th UL resource (e.g. RA resources in time and frequency) associated to the LTM candidate cell, for transmitting the (n+1)-th UL message.

In some embodiments, when the timer expires, the UE considers the transmission of the first UL message/signal as a failed transmission attempt. In response, the UE transmits a second UL message/signal to a second LTM candidate cell. In that case, instead of applying a power ramping to a previous power, the UE considers a possibly different received target power (e.g., based on a parameter configured associated with the UL configuration of the second LTM candidate cell, not necessarily having the same value configured for the first LTM candidate cell).

In some embodiments, the UE further receives a Timing Advance value. Different sets of embodiments described herein disclose different ways to provide the Timing Advance value. As one example, the Timing Advance value is received by the UE when the UE receives the DL response indication. The DL response indication possibly includes the Timing Advance value. In one option, in response to the reception of the Timing Advanced value the UE starts a Time alignment timer.

In another option, the timing advance value is included in a medium access control (MAC) control element (CE) which is multiplexed with the MAC CE in the DL response indication. In one option, the timing advance value is included in a MAC CE (e.g., timing advance command MAC CE). The MAC CE is the DL response indication, i.e. when the UE receives the MAC CE including the timing advance value the UE considers that it has received the DL response indication. In one option, the timing advance value is included (e.g., in a MAC CE) with an indication of one or more of: a timing advance group identity, indicating to which group of cells the timing advance value is applicable; and a LTM configuration ID, indicating to which LTM candidate cell (or configuration, e.g., a specific Radio Resource Control (RRC) Reconfiguration message, a cell group configuration IE instance) the timing advance value is applicable.

In another option, the timing advance value is received by the UE when the UE receives the LTM cell switch (LTM execution) command to the LTM candidate cell, wherein the LTM cell switch command includes the timing advance value. In one option, in response to the reception of the timing advance value the UE starts a time alignment timer for the LTM candidate cell.

In some embodiments, in an LTM cell switch (LTM execution) to the LTM candidate cell, the UE transmits an UL message on a physical uplink control channel (PUCCH) or physical uplink shared channel (PUSCH) based on the received TA value.

In some embodiments, the UE considers the TA establishment procedure successful when the UE receives the DL response indication.

In some embodiments, the UE monitors a counter for the number of UL signal/message transmission attempts (e.g., maximum number of RA preamble transmission attempts). Each time the UE transmits an UL message (e.g., a RA preamble) for the same TA establishment procedure the counter is incremented. There is a maximum value this counter can reach and when that value is reached, the UE declares a failure in the TA establishment procedure. Before the UE transmits a preamble, the UE checks whether the maximum value has been reached. When the maximum value has been reached, the UE declares a TA establishment failure.

Some embodiments include different actions when the UE declares a TA establishment failure (the actions are described in more detail below). As one example, when the UE declares a TA establishment failure, the UE transmits an indication to the S-DU, e.g. serving cell, such as a UE Assistance Information message that may include information about the TA establishment failure. In another option, the UE considers itself not time aligned or not synchronized with the LTM candidate cell for which the TA establishment failure was declared, so that during LTM execution the UE knows that it needs to perform a random access with that LTM candidate cell if that is the target cell indicated in the LTM cell switch (execution) command.

FIGS. 2A and 2B is a flow diagram summarizing UE actions in the UE assisted fallback for TA establishment.

FIGS. 2A and 2B is a flow diagram summarizing UE actions in the UE assisted fallback for TA establishment. The signaling flow in FIGS. 2A and 2B summarizes the steps disclosed above, with some examples (e.g., in step 7 the UE receives the timing advance value in the response DL indication).

Some embodiments comprise a method at a serving DU (S-DU). The method comprises the S-DU transmitting to a UE a first DL indication (e.g., RRC Reconfiguration including the LTM configuration and/or an indication for TA establishment or a subsequent message, such as a PDCCH order) based on which the UE shall transmit to an LTM candidate cell a first UL message (e.g., a first RA preamble).

In some embodiments, after the transmission of the first DL indication, the S-DU applies one or more scheduling restrictions, i.e., the S-DU does not schedule any UL transmissions or DL receptions in the serving cell(s) to the UE. This is a step that may be implemented by the S-DU, but may not be specified.

When the S-DU receives from the candidate DU a timing advance value (calculated by the C-DU according to the second UL signal received at the C-DU), the S-DU sends a DL response indicator to the UE. After the transmission of the DL response indicator, the S-DU considers the TA establishment procedure successful and stops applying the scheduling restrictions introduced after the transmission of the first DL indication.

In some embodiments, the S-DU determines a TA establishment failure based on one or more of the following options. In one option, the S-DU determines that a maximum number of preamble transmission attempts is reached without successful detection at the C-DU, e.g., by the reception of an indication from the UE (which knows that the maximum number has been reached) indicating that a maximum number of UL message transmission attempts has been reached. This may indicate a failure of the TA establishment procedure.

In one option, the S-DU determines the TA establishment failure when a validity timer monitored at the S-DU expires. The validity timer is started by the S-DU when the S-DU transmits the first DL indication to the UE, and is stopped when the S-DU receives a message from the C-DU (e.g., via the CU) including a timing advance value (e.g., either based on the first, second or the n-th transmission or re-transmission of the UL message from the UE). This is referred to herein as a validity timer, but the functionality may also be modeled as a time window in which the message from the C-DU is expected to be received and when it is not received in that time window the S-DU considers the TA establishment procedure as failed. The validity timer is not the same as the timer at the UE (supervision timer, RAR-like timer that is started/re-started at every transmission attempt). The expiry of the validity timer at the S-DU indicates to the S-DU the failure of the overall TA establishment procedure.

In another option, the S-DU receives from the C-DU (e.g., via the CU) an indication that a TA establishment procedure is failed, e.g., a message with the TA value absent. The C-DU may transmit the message with the TA value absent upon the expiry of a validity timer monitored at the C-DU (e.g., C-DU validity timer), wherein the validity timer is started by the C-DU when the C-DU is requested to configure a UE with a TA establishment/update procedure or when the C-DU confirms the request to the CU and/or the S-DU (e.g., when the C-DU provides the UL resources for the TA establishment/update).

The detection of a TA establishment failure is used at the S-DU so that the S-DU knows when to stop applying a scheduling restriction to the UE and whether the S-DU performs further actions upon the failure detection, e.g., removal of an LTM candidate cell and/or cancelling of the TA establishment procedure towards the C-DU.

In some embodiments, the S-DU further transmits to the UE a timing advance value (calculated by the C-DU according to the second UL signal received at the C-DU). The timing advance value may be included in the LTM cell switch command indicating the UE to move to the LTM candidate cell, or possibly included in the DL response indication, in response to the S-DU having received the TA value form the C-DU, e.g., via the CU.

Some embodiments comprise a method at a candidate DU (C-DU). The method comprises the C-DU detecting whether a first UL message is successfully (or not successfully) received at the C-DU (responsible for the LTM candidate cell); and when the first UL message is successfully received, calculating a timing advance value based on the first UL message that is received and transmitting the timing advance value to the S-DU in a message. When an UL message is not successfully received, performing one or more of: i) transmitting to the S-DU (e.g., via the CU) a message that does not include a TA value; or ii) not transmitting the message to the S-DU (e.g., via the CU), to indicate that the UL message reception was not successful.

In some embodiments, the C-DU starts a validity timer when it responds to a request from the CU and/or the S-DU to establish TA, wherein the response may include an UL configuration for TA establishment. When the C-DU receives an UL message (e.g., first UL message, n-th UL message, (n+1)-th UL message) the C-DU stops the validity timer. When the timer expires, and the C-DU does not receive the UL message, the C-DU considers a failure in the TA establishment procedure. In response to the TA establishment failure, the C-DU may indicate the failure to the CU and/or to the S-DU. The C-DU may transmit to the S-DU a message with the TA value absent upon the expiry of the validity timer monitored at the C-DU (e.g., C-DU validity timer).

In summary, a method at a UE capable of LTM and configured with at least one LTM candidate cell comprises receiving (1) a first DL indication from a serving cell (of a source network node, e.g. source DU (S-DU)), and (2) in response to the first DL indication the UE transmitting to the LTM candidate cell a first UL message (e.g., a first RA preamble), wherein the UL message is transmitted with a first transmission power and on a first UL resource (e.g., RA resources in time and frequency). The method further comprises starting a timer in response to transmitting the first UL message to the LTM candidate cell and monitoring a DL response indication from the serving cell. The method further comprises selectively performing one of the following actions: when receiving the DL response indication while the timer is running, considering the transmission of the first UL message successful and stopping the timer; when the timer expires before receiving the DL response indication, considering the transmission of the first UL message as a failed transmission attempt and in response to that, transmitting a second UL message to a second LTM candidate cell, wherein the second UL message is transmitted to the second LTM candidate cell according to: i) an incremented transmission power compared to the first transmission power or ii) on a second UL resource (e.g., RA resources in time and frequency).

In particular embodiments, the LTM candidate cell is the same as the second LTM candidate cell. In particular embodiments, the LTM candidate cell is different from the second LTM candidate cell.

In particular embodiments, the method further comprises the UE selecting a first beam, and based on the selected first beam, the UE selecting a first UL resource associated to for transmitting the first UL message.

According to some embodiments, a method is performed by a wireless device for LTM. The method comprises obtaining an uplink configuration for an LTM candidate cell; receiving an indication from a serving cell to perform an uplink transmission in the LTM candidate cell; transmitting a first uplink transmission in the LTM candidate cell with a first transmit power and on a first uplink time/frequency resource; and monitoring for a downlink response from the serving cell indicating a result of the first uplink transmission in the LTM candidate cell. When the downlink response is received from the serving cell within a preconfigured threshold time, the method comprises determining the first uplink transmission in the LTM candidate cell is successful. When the downlink response is not received from the serving cell within the preconfigured threshold time, the first uplink transmission in the LTM candidate cell is determined to be unsuccessful and the method further comprises transmitting a second uplink transmission in a second LTM candidate cell. The second uplink transmission is transmitted with one or more of a second transmit power different from the first transmit power and a second uplink time/frequency resource different from the first time/frequency resource.

In particular embodiments, the second LTM candidate cell is the same cell as the first LTM candidate cell or the second LTM candidate cell is a different cell than the first LTM candidate cell.

In particular embodiments, the downlink response received from the serving cell comprises a timing advance value for use in a LTM candidate cell.

In particular embodiments, the first uplink transmission and the second uplink transmission comprise transmission of a random access preamble. The wireless device does not expect a RAR in response to the transmission of the random access preamble.

In particular embodiments, the first uplink transmission uses a first beam and in response to determining to perform the second uplink transmission, the method further comprises selecting a second beam to use for the second uplink transmission and when the second beam is the same as the first beam the second uplink transmission is transmitted with a second transmit power different from the first transmit power and when the second beam is different from the first beam the second uplink transmission is transmitted with a second uplink time/frequency resource different from the first time/frequency resource.

In particular embodiments, the indication comprises a physical downlink control channel, PDCCH, order.

In particular embodiments, the uplink configuration for the uplink candidate cell comprises one or more random access parameters and the indication comprises an indication of which of the one or more random access parameters to use for the first uplink transmission.

In particular embodiments, the indication comprises an indication of a SSB associated with the first uplink transmission.

In particular embodiments, the uplink configuration for the uplink candidate cell comprises more than one uplink configuration for more than one uplink candidate cell and the indication comprises an indication of which uplink candidate cell in which to transmit the first uplink transmission.

According to some embodiments, a wireless device comprises processing circuitry operable to perform any of the wireless device methods described above.

Another computer program product comprises a non-transitory computer readable medium storing computer readable program code, the computer readable program code operable, when executed by processing circuitry to perform any of the methods performed by the wireless device described above.

According to some embodiments, a method is performed by a network node operating as a S-DU for TA management between a wireless device and at least one LTM candidate cell. The method comprises transmitting an indication to the wireless device to perform an uplink transmission in the LTM candidate cell and monitoring for a response from the LTM candidate cell indicating a result of the uplink transmission in the LTM candidate cell. When the response is received from the LTM candidate cell within a preconfigured threshold time, the method comprises transmitting a downlink response to the wireless device indicating a result of the first uplink transmission in the LTM candidate cell. When the response is not received from the LTM candidate cell within the preconfigured threshold time, the method comprises determining the uplink transmission in the LTM candidate cell is unsuccessful.

In particular embodiments, the method further comprises transmitting an uplink configuration for the LTM candidate cell to the wireless device.

In particular embodiments, the downlink response comprises a timing advance value for use in the LTM candidate cell.

In particular embodiments, the first uplink transmission comprises transmission of a random access preamble.

In particular embodiments, the indication comprises a physical downlink control channel, PDCCH, order.

In particular embodiments, the uplink configuration for the LTM candidate cell comprises one or more random access parameters and the indication comprises an indication of which of the one or more random access parameters to use for the first uplink transmission.

In particular embodiments, the uplink configuration for the uplink candidate cell comprises more than one uplink configuration for more than one uplink candidate cell and the indication comprises an indication of which uplink candidate cell in which to transmit the first uplink transmission.

In particular embodiments, the indication comprises an indication of a SSB associated with the first uplink transmission.

According to some embodiments, a network node comprises processing circuitry operable to perform any of the network node methods described above.

Another computer program product comprises a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments facilitate establishing and/or updating the TA between the UE and an LTM candidate cell, which may not be UL synchronized with a serving cell the UE is configured with. Thus, particular embodiments enable the UE to execute an LTM cell switch (e.g., upon reception of a MAC CE for LTM) and transmit UL information to the candidate cell (e.g., on PUSCH or PUCCH) without the need to first perform a RA procedure, which reduces the interruption time during LTM execution.

In addition, one advantage of particular embodiments is the possibility to handle failed attempts to transmit the UL signals/message (e.g., RA preambles) during TA establishment and/or updating between the UE and an LTM candidate cell. For example, some embodiments may trigger a re-transmission of an UL message (which may be a new transmission, as that may be a different UL message/signal) to the candidate LTM when the candidate DU is not able to detect a previous preamble transmission, which makes the TA establishment and updates more robust, efficient and unambiguous in an interoperable network.

Particular embodiments include UE assisted fallback for TA establishment. In one of the sets of embodiments, the UE transmits a RA preamble to the LTM candidate cell but does not rely on the reception of a RAR in the LTM candidate cell. Thus, the interruption time with the serving cell(s) for the TA establishment and updates procedure is minimized, which is beneficial for the data rates provided by the serving cell(s), as more data may be scheduled (as there would be fewer scheduling restrictions imposed by the serving cell(s)). In particular embodiments, the UE expects a DL indication response from the S-DU (i.e., from a serving cell, not from the LTM candidate cell) to indicate that the UL transmission attempt was successful. When the UE transmits the RA preamble, the UE starts a supervision timer and when the DL indication is not received while the timer is running, and the timer expires, the UE considers the attempt as a failed attempt. Based on the expected DL indication, the UE is able to determine whether the attempted transmission was successful, and knows whether the UE needs to trigger a fallback.

A benefit of the UE assisted fallback is that the UE does not have to monitor a RAR from the LTM candidate cell, but instead the UE monitors a DL indication from a serving cell. This reduces the interruption time with the serving cell(s).

In other words, a difference compared to a RA procedure is that the DL response indication, received by the UE in response to a preamble transmission on the LTM candidate cell, is received from a serving cell (from the S-DU).

Another advantage in the UE assisted fallback is that in some embodiments the UE expects to receive a DL response indication from the S-DU, which allows the reception of a single DL indication including information of a TA value and its validity for multiple cells, or multiple TA values in the same DL response indication, which represents a signaling reduction and, consequently, a reduction in UE battery consumption.

Another advantage relates to the transmission by the UE of the (n+1)-th UL message during fallback of TA establishment (e.g., upon expiry of the timer after transmitting the n-th UL message) to an (n+1)-th LTM candidate cell, which is different from the n-th LTM candidate cell in which the UE transmits the n-th UL message. That creates further diversity in the fallback procedure, because it increases the number of possible attempts without the need to trigger a new TA establishment procedure. This has an advantage to speed up the process and uses the fact that there may be multiple LTM candidate cells which may have similar properties so that a timing advance applied to the UE is valid for multiple LTM candidate cells.

### BRIEF DESCRIPTION OF THE DRAWINGS

For a more complete understanding of the disclosed embodiments and their features and advantages, reference is now made to the following description, taken in conjunction with the accompanying drawings, in which:

FIGS. 1A and 1B are a flowchart illustrating an example in which the timing advance (TA) establishment based on random access (RA) preamble transmission to candidate and reception of TA value only at layer one (L1)/layer two (L2) triggered mobility (LTM) execution;

FIGS. 2A and 2B are a flow diagram summarizing UE actions in the user equipment (UE) assisted fallback for TA establishment;

FIG. 3 is a block diagram illustrating the architecture of a central unit (CU) and a distributed unit (DU) in a radio access network (RAN);

FIGS. 4A and 4B illustrate Abstract Syntax Notation (ASN) for six examples of LTM candidate configuration;

FIG. 5 illustrates an example of a medium access control (MAC) control element (CE) octet corresponding to the downlink response indication;

FIGS. 6A, 6B and 6C are a flowchart illustrating steps for the LTM configuration and UE-assisted TA establishment/updating, according to particular embodiments;

FIGS. 7A, 7B and 7C are a flow diagram illustrating UE assisted fallback with TA management at the UE side, according to particular embodiments;

FIGS. 8A, 8B and 8C are a flow diagram illustrating a fallback procedure for the UE-assisted TA update procedure for a CU initiated TA update and a network-based TA management, according to some embodiments;

FIGS. 9A, 9B and 9C are a flowchart illustrating UE-assisted fallback procedure for the TA update procedure for an S-DU initiate TA update and a network-based TA management, according to particular embodiments;

FIGS. 10A and 10B are a flow diagram illustrating an example of actions at the S-DU upon detecting a TA establishment failure, according to particular embodiments;

FIG. 11 illustrates an example communication system, according to certain embodiments;

FIG. 12 illustrates an example user equipment (UE), according to certain embodiments;

FIG. 13 illustrates an example network node, according to certain embodiments;

FIG. 14 illustrates a method performed by a user equipment, according to certain embodiments; and

FIG. 15 illustrates a method performed by a network node, according to certain embodiments.

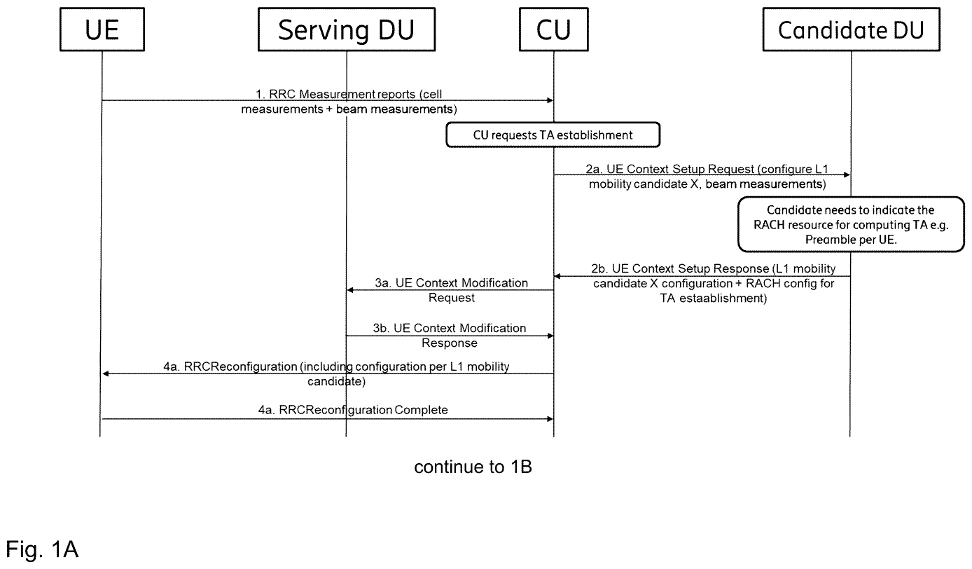

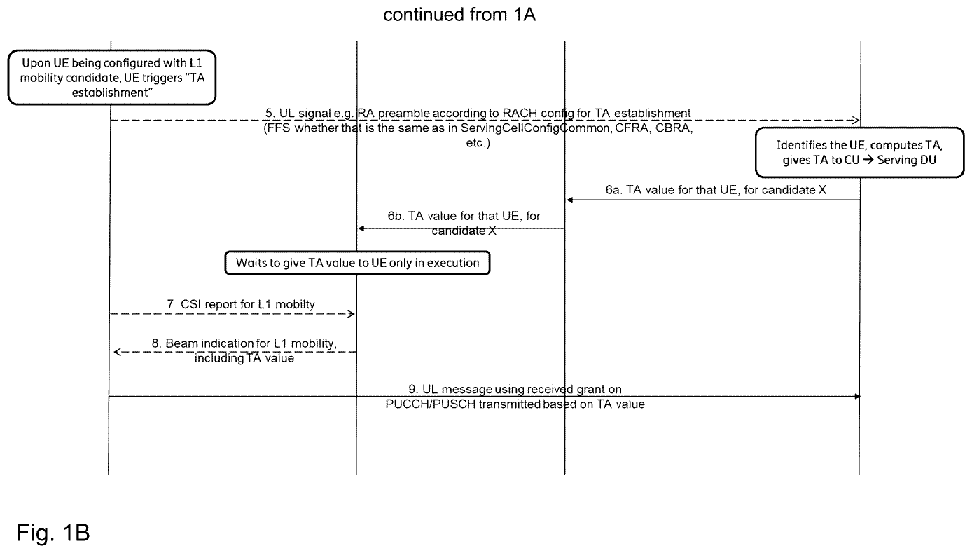

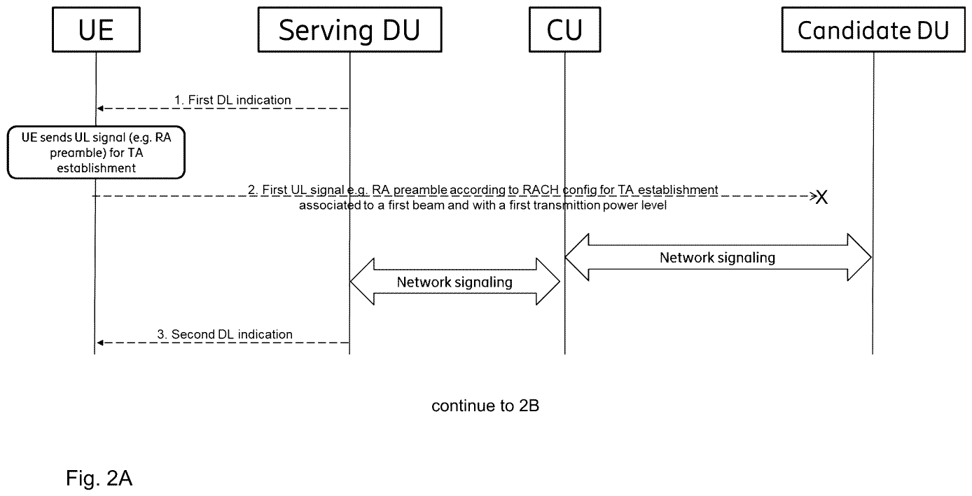

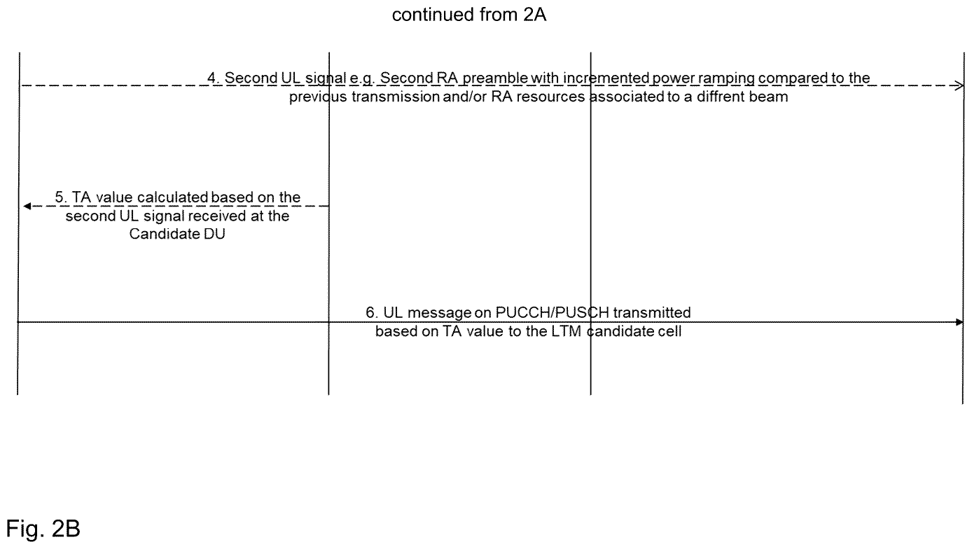

### DETAILED DESCRIPTION

As described above, certain challenges currently exist with s fallback for time alignment during mobility. Certain aspects of the present disclosure and their embodiments may provide solutions to these or other challenges. For example, particular embodiments include network based fallback for timing advance (TA) establishment/updating.

Particular embodiments are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

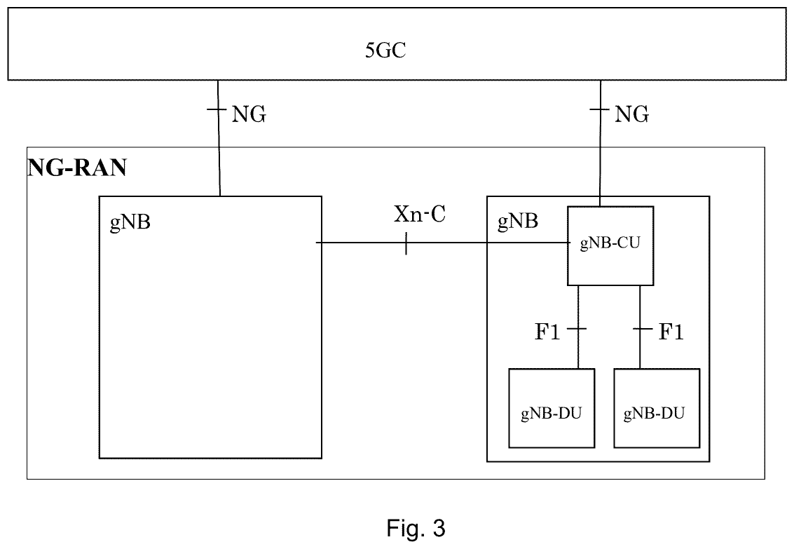

FIG. 3 is a block diagram illustrating the architecture of a central unit (CU) and a distributed unit (DU) in a radio access network (RAN). In the illustrated example, the RAN is a next-generation RAN (NG-RAN), which may be referred as the fifth generation (5G) RAN, however, particular embodiments are applicable to any RAN such as a sixth generation (6G) RAN architecture.

The illustrated architecture (with both NG-RAN and 5GC) shows the NG-RAN split in CU and DU connected via F1 interface. The RAN (e.g., NG-RAN) consists of a set of RAN nodes (e.g., gNBs) connected to a core network (e.g., a 5GC) through a RAN/CN interface (e.g., NG interface). For NG-RAN, that may comprise one or more ng-eNBs, wherein an ng-eNB may consist of an ng-eNB-CU and one or more ng-eNB-DU(s). A gNB may consist of a gNB-CU and one or more gNB-DU(s). A gNB-CU and a gNB-DU are connected via F1 interface. A gNB-DU may be connected to multiple gNB-CUs by appropriate implementation.

NG, Xn and F1 are logical interfaces. For the NG-RAN, the NG and Xn-C interfaces for a gNB consisting of a gNB-CU and gNB-DUs terminate in the gNB-CU. For EN-DC, the S1-U and X2-C interfaces for a gNB consisting of a gNB-CU and gNB-DUs terminate in the gNB-CU. The gNB-CU and connected gNB-DUs are only visible to other gNBs and the 5GC as a gNB.

Some embodiments refer to a serving DU or source DU, whose acronym is used interchangeably as S-DU. The S-DU may correspond to a gNode-DU that is responsible for one or more serving cell(s) for which a user equipment (UE) is configured.

In some embodiments the CU refers to the CU the UE is connected with, i.e. the CU wherein the higher layer protocols (e.g., Radio Resource Control (RRC)) for communication with the UE are terminated and where a UE access stratum (AS) context is stored.

Some embodiments refer to a candidate DU (C-DU), which refers to the DU (which may correspond to a gNodeB-DU) that is responsible for a layer one (L1)/layer two (L2) triggered mobility (LTM) candidate cell for which a UE is configured. As part of the LTM configuration, the CU sends a request to the C-DU for configuring the LTM candidate cell for the UE. In response, the CU receives at least an LTM candidate cell configuration, which is the configuration based on which the UE determines the configuration it needs to use when it switches to that LTM candidate cell in an LTM execution (also referred to as LTM cell switch).

The term TA establishment and/or TA update as used herein may either refer to a time alignment establishment and/or time alignment update.

Some embodiments may be extended for inter-CU scenarios, wherein the S-DU is associated to a source CU (S-CU) and the candidate DU (C-DU) is associated to a target CU (T-CU). In that case, the configuration of TA establishment is requested (and responded) from the S-CU to the T-CU via an inter-CU interface such as Xn (or X2).

The text refers to the term “L1/L2 based inter-cell mobility” as used in the Work Item Description in 3GPP, though it interchangeably also uses the terms L1/L2 mobility, L1-mobility, L1 based mobility, L1/L2-centric inter-cell mobility, L1/L2 inter-cell mobility, or L1/L2 triggered mobility. The basic principle is that the UE receives a lower layer signaling from the network indicating to the UE a change (or switch or activation) of its serving cell (e.g., change of PCell from a source to a target PCell), wherein a lower layer signaling is a message/signaling of a lower layer protocol, which may be referred as a L1/L2 inter-cell mobility execution command (or LTM cell switch command). The change of serving cell (e.g., change of PCell) may lead to a change in Scell(s) for the same cell group, e.g. when the command triggers the UE to change to another cell group configuration of the same type (e.g., another master cell group (MCG) configuration). Before the UE receives the LTM cell switch command, the UE is configured by the network with one or more LTM candidate cells (e.g., reception of an RRC Reconfiguration message with at least one candidate cell configuration) A candidate cell configuration may include parameters in the information element (IE) CellGroupConfig per candidate cell and/or an embedded RRC Reconfiguration per candidate cell.

A lower layer protocol refers to a lower layer protocol in the air interface protocol stack compared to RRC protocol, e.g. medium access control (MAC) is considered a lower layer protocol as it is “below” RRC in the air interface protocol stack, and in this case a lower layer signaling/message may correspond to a MAC control element (MAC CE). Another example of lower layer protocol is the Layer 1 (or physical layer, L1), and in this case a lower layer signaling/message may correspond to a downlink control information (DCI). Signaling information in a protocol layer lower than RRC reduces the processing time and, consequently, reduces the interruption time during mobility. In addition, it may also increase the mobility robustness because the network may respond to faster changes in the channel conditions.

Another relevant aspect in L1/L2 inter-cell mobility is that in multiple-beam scenario, a cell can be associated to multiple synchronization signal blocks (SSBs), and during a half-frame, different SSBs may be transmitted in different spatial directions (i.e., using different beams, spanning the coverage area of a cell). Similar reasoning may be applicable to channel state information reference signal (CSI-RS) resources, which may also be transmitted in different spatial directions. Thus, in L1/L2 inter-cell mobility (LTM), the reception of a lower layer signaling indicates the UE to change from one beam in the serving cell to another beam in a neighbor cell (which is a configured candidate cell), and by that changing serving cell.

The term LTM cell switch procedure refers to the process of a UE changing its cell from a source cell to a target cell (which may be referred to as a candidate cell), using L1/L2-triggered mobility. In the context of L1/L2 based inter-cell mobility or L1/L2-triggered mobility, the LTM cell switch procedure may also be referred to as dynamic switch, LTM switch, LTM cell switch, LTM serving cell change or LTM cell change. Even if the term change of cell is used, that may comprise a change of a whole cell group configuration, which includes a change in the SpCell (e.g., change of PCell, or change of PSCell) and a change in SCells of the cell group (e.g., addition, modification and/or release of one or more SCells).

Some examples use the term target candidate configuration (or configuration of a candidate cell, or configuration of an LTM candidate cell, or LTM candidate cell configuration) to refer to the configuration of a “L1/L2 inter-cell mobility candidate cell”, which is a cell the UE is configured with when configured with L1/L2 inter-cell mobility. That is a cell the UE can move to in a L1/L2 inter-cell mobility procedure, upon reception of a lower layer signaling (e.g., MAC CE including the LTM candidate cell configuration identifier). These cells may also be referred to as candidate cell(s), candidates, mobility candidates, non-serving cells, additional cells, target candidate cell, target candidate, etc. This is a cell the UE performs measurements on (e.g., CSI measurements) so that the UE reports these measurements and network may take educated decision on which beam (e.g., transmission configuration indicator (TCI) state) and/or cell to which the UE is to be switched. A L1/L2 inter-cell mobility candidate cell may be a candidate to be a target PCell or PSCell, or an SCell of a cell group (e.g., MCG SCell).

The term “beam” may correspond to a spatial direction in which a signal is transmitted (e.g., by a network node) or received (e.g., by the UE), or a spatial filter applied to a signal which is transmitted or received. Thus, transmitting signals on different beams may correspond to transmitting signals in different spatial directions. When the text refers to a “beam which is selected” it may refer to a beam index and/or a reference signal (RS) index or identifier, such as a SSB index, or a CSI-RS resource identifier. Thus, selecting a beam may correspond to selecting an SSB associated to an SSB index. Or, selecting a beam may correspond to selecting a CSI-RS associated to a CSI-RS resource identifier.

The actual LTM candidate configuration and its content and/or structure of this IE and/or embedded message may be referred to as an RRC model for the candidate configuration, or simply RRC model. An LTM candidate cell configuration comprises the configuration that the UE needs to operate accordingly when it performs (executes) L1/L2 inter-cell mobility execution to that target candidate cell, upon reception of the lower layer signaling indicating a L1/L2 based inter-cell mobility to that target candidate cell (which becomes the target cell and the current (new) PCell, or an SCell in a serving frequency). The UE may be configured with multiple target candidate cells and a candidate DU generates and sends to the CU multiple configuration(s). The target candidate configuration comprises at least parameters of a serving cell (or multiple serving cells), comprising one or more of the groups of parameters within the IE SpCellConfig (or the IE SCellConfig for a secondary cell). The actual LTM candidate cell configuration the UE receives during the LTM configuration may be a delta signaling to be applied on top of a reference configuration and the actual configuration the UE is to use in the candidate cell upon LTM cell switch is the combination of the LTM candidate cell configuration and the reference configuration (e.g., separately signaled by the network to the UE).

Some examples of how the signaling may be implemented in RRC for the LTM candidate configuration are described as RRC models for L1/L2 based inter-cell mobility, and include the following. One example includes RRC Reconfiguration per candidate cell. In this case the UE receives multiple (a list of) RRC messages (i.e., RRCReconfiguration message) within a single RRCReconfiguration message. Each RRCReconfiguration message identifies a target candidate configuration that is stored by the UE and is applied/used/activated when receiving the lower layer signaling for L1/L2 inter-cell mobility. This model enables full flexibility, as in L3 reconfigurations, for the target node to modify/release/keep any parameter/field in the RRCReconfiguration message, such as measurement configuration, bearers, etc.

Another example includes CellGroupConfig per candidate cell. With this model the UE receives within an RRCReconfiguration a list of CellGroupConfig IEs and each one of them identifies a target candidate configuration. Each CellGroupConfig IE is stored at the UE and is applied/used/activated when receiving the lower layer signaling for L1/L2 inter-cell mobility. This model facilitates the target node to modify/release/keep any parameter/field that is part of a CellGroupConfig IE while the rest of the RRCReconfiguration message (that is where the CellGroupConfig IE is received by the UE) remain unchanged. This means that, e.g., measurement configuration, bearers, and security remain the same and are not changed by the target node.

Another example includes “K” SpCellConfig or “K” ServingCellConfigCommon, or both per cell. With this model the UE receives either “K” SpCellConfig per cell, “K” ServingCellConfigCommon per cell, or “K” SpCellConfig and “K” ServingCellConfigCommon per cell as a target candidate configuration. This solution provides only minimum flexibility for the target node because only cell-specific parameters (e.g., bandwidth parts, downlink, and uplink configurations) can be modified/released/kept.

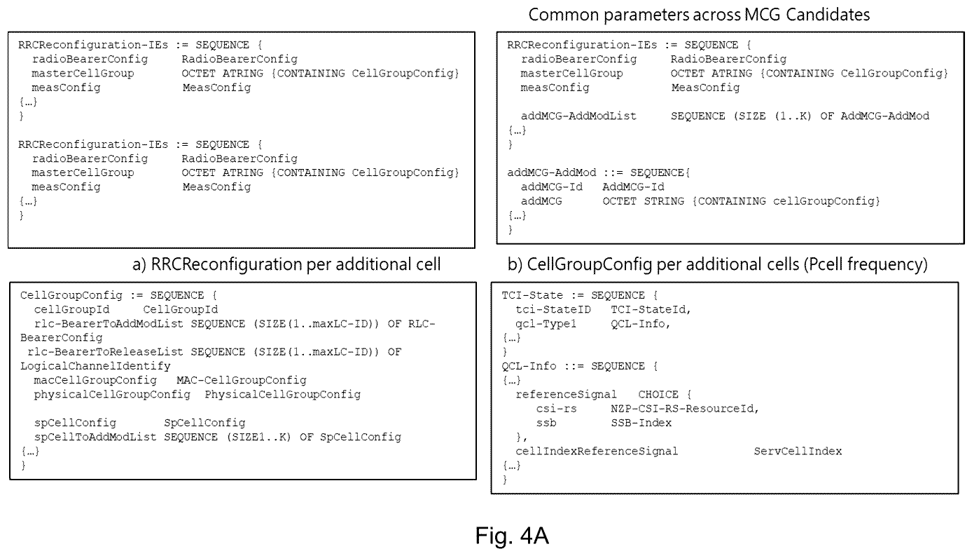

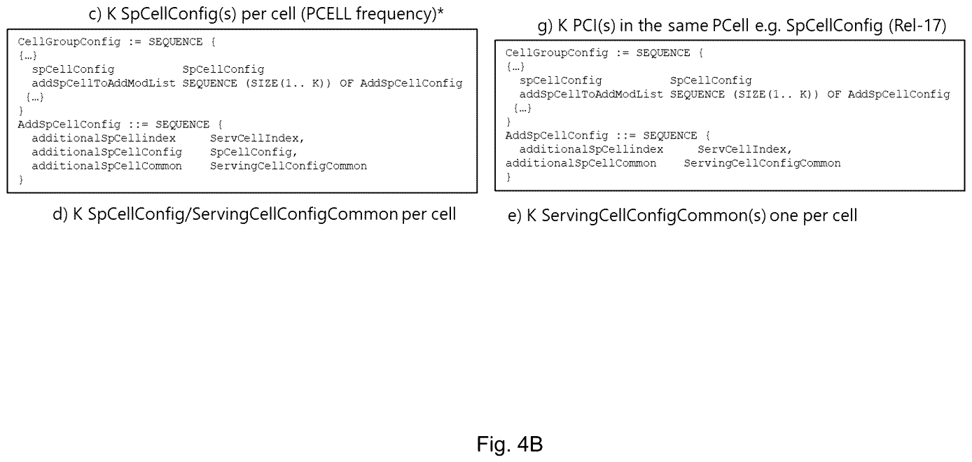

Another example includes “K” PCI in the same PCell. With this model multiple PCIs are configured for the same TCI state configuration where each PCI identify a target candidate configuration. This is approach provides less flexibility because all the parameters/fields used for configuring a target candidate configuration are fixed and only a change of PCI, scrambling Id, and C-RNTI is allowed to the target node. Examples are illustrated in FIGS. 4A and 4B.

FIGS. 4A and 4B illustrate Abstract Syntax Notation (ASN) for six examples of LTM candidate configuration. The L1/L2 inter-cell mobility configuration may correspond to a field and/or information element defined in RRC protocol (e.g., in ASN.1 format) comprising one or more target candidate cell configuration(s). The L1/L2 inter-cell mobility configuration may comprise multiple target candidate cell configuration(s) when the UE is configured with multiple target candidate cell(s) for L1/L2 inter-cell mobility. That L1/L2 inter-cell mobility configuration may be included in an RRCReconfiguration message (as defined in TS 38.331), or an RRC Resume message the UE receives, e.g., during a state transition to RRC_CONNECTED.

The L1/L2 inter-cell mobility configuration may be generated by a CU, e.g. gNB-CU, and include information generated and transmitted from a candidate DU, such as the target candidate cell configuration and/or a measurement configuration indicating the UE to perform measurements on reference signaling (RSs), e.g. SSBs and/or CSI-RS resources, of a target candidate cell, for reporting to the network to assist L1/L2 inter-cell mobility execution decisions.

According to particular embodiments, the TA establishment comprises the UE transmitting an UL signal or message to an LTM candidate cell (associated to a candidate DU), so that C-DU calculates a timing advance value and provides the timing advance value to the UE and/or the S-DU. The timing alignment (or adjustment, or UL synchronization) is said to be established, as the UL signal was successfully received and the timing advance value successfully calculated.

The UE and/or S-DU controls the validity of the time advance value for the UE and the LTM candidate cell, for example, by starting a time alignment timer when the timing advance is obtained (e.g., UE receives the time advance value from the S-DU, or the S-DU receives the TA value from the C-DU, potentially via the CU) and the time advance value is considered valid while the time alignment timer is running. When the time alignment timer expires, the time advance value is considered invalid and it is considered that the UE lost UL synchronization with the LTM candidate cell. In response to that, a TA update may be triggered (e.g., by the UE or by the network). The TA updating process shares some similarities with the TA establishment, in which the UE also transmits an UL message/signal to the LTM candidate cell, so that a TA value is calculated and provided to the S-DU and to the UE. The failed attempt in the TA update or establishment consists of the failure at the C-DU of successfully receiving the UL message/signal and successfully calculating the TA value.

Particular embodiments may use the term “TA value,” which may refer to a timing advance value. Particular embodiments may refer to a “TA timer,” which may correspond to a time alignment timer.

A “TA value” may correspond to an actual TA value to be applied or an indication to a TA value, such as an integer value the UE receives which maps to an actual TA value or shift to be applied for UL transmissions. One example of a TA value is a timing advance command, which comprises a number of bits indicating an index value TA used to control the amount of timing adjustment that the MAC entity is to apply for a candidate for an UL transmission on, e.g. sounding reference signal (SRS), physical uplink control channel (PUCCH), physical uplink shared channel (PUSCH), etc.

In a set of embodiments, a UE is capable of LTM and configured with at least one LTM candidate cell. The UE receives (1) a first DL indication from a serving cell (of a source network node, e.g. source DU (S-DU)), which may correspond to a PDCCH order, which may be subsequent to a previous configuration of the LTM candidate cell. In response to the first DL indication, the UE transmits to the LTM candidate cell a first UL message (e.g., a first RA preamble), wherein the UL message is transmitted with a first transmission power, and wherein the UE transmits the UL message using a first UL resource (e.g., RA resources in time and frequency) associated to a first beam the UE has selected.

The first DL indication that triggers the UE to transmit an UL message to the LTM candidate cell, for establishing or updating the TA, may correspond to: RRC signaling, such as an RRC message (RRC Reconfiguration) and/or IE and/or field associated to an LTM candidate cell; MAC signaling, such as a PDCCH order (e.g., message and/or IE and/or field) associated to the candidate cell; and/or L1 signaling, such as a PDCCH order, potentially indicating a beam and/or a count value and/or an indication of a power level for transmission of the UL message to the candidate cell.

The DL response indication that indicates to the UE that the transmission of an UL message to the LTM candidate cell was successful, for establishing or updating the TA, may correspond to: RRC signaling, such as an RRC message (RRC Reconfiguration) and/or IE and/or field associated to an LTM candidate cell; MAC signaling, such as a PDCCH order (e.g., message and/or IE and/or field) associated to the candidate cell; L1 signaling, such as a PDCCH order, potentially indicating a beam and/or a count value and/or an indication of a power level for transmission of the UL message to the candidate cell; a PDCCH transmission that the UE receives addressed to the UE's cell radio network temporary identifier (C-RNTI); and/or a random access response (RAR) like message in response to the preamble transmission received in the LTM candidate cell.

The first UL message (or the second UL message) transmitted by the UE to the LTM candidate cell for establishing or updating the TA may correspond to: a random access (RA) preamble; a sequence with at least one similar property to a RA preamble, e.g. orthogonal to one another, semi-orthogonal, low correlation properties, etc.; and/or a sequence that may be transmitted in an UL channel of an LTM candidate cell that does not require the UE to be tightly synchronized with the UL of the LTM candidate cell.

In the UE assisted fallback for TA establishment, the UE transmits the first UL message (e.g., RA preamble) to an LTM candidate cell and monitors the potential reception of a DL response indication from a serving cell, wherein the reception of the DL response indication from the serving cell indicates to the UE the successful reception of the first UL message at the network side, i.e. at the candidate DU responsible for the LTM candidate cell. In other words, the S-DU transmits the DL response indication to the UE when the S-DU knows that the first UL message was successfully received. The reception of the DL response indication also indicates to the UE that a fallback for the TA establishment is not necessary.

In this context, a serving cell may correspond to a special cell, a primary cell (PCell), a primary secondary cell group (SCG) cell (PScell), or an SCell o (of the master cell group or an SCell of the SCG), or a cell which the UE is connected to and/or is configured with for DL and UL transmissions/receptions.

If the UE is provided in the first DL indication with a list of information/configuration to be used for each UL message (e.g., RA preamble) transmission (and retransmissions or subsequent UL transmissions in the same TA establishment procedure), the UE transmits the first UL message (e.g., RA preamble) to an LTM candidate cell and monitors the reception of a DL response indication from a serving cell. If no DL response indication is received from the serving cell, the UE uses information/configuration not from the list received in the first DL indication to transmit a second UL message to the/an LTM candidate cell (e.g., it may instead use information/configuration stored and previous received over an RRC configuration) and monitors the potential reception of a DL response indication from a serving cell. This process continues until the DL response message is received by the UE in serving cell, or until the TA establishment procedure is considered failed by the UE.

One example is that the first DL indication indicates to the UE an LTM candidate cell for transmission of the first UL message. The UE transmits the first UL message and starts a timer, and when the timer expires without the UE having received the DL response indication the UE transmits a second UL message to a different LTM candidate cell (not indicated in the first DL indication, but possibly indicated in the UE's RRC configuration for LTM). One advantage here is that the UE may receive minimal information in the first DL indication that only indicates information for the first transmission of the UE for TA establishment, which reduces the signaling overhead. Another benefit is that often in some scenarios the UE succeeds in the first UL transmission, thus it is inefficient to provide information for a possible fallback that may not happen often.

In one set of embodiments, for the monitoring of the DL response indication, the UE starts a timer (RAR-like timer, supervision timer, TA establishment timer, etc.) when the UE transmits the first UL message and monitors a DL response indication from a serving cell (e.g., PCell, PScell, SCell). When the UE receives the DL response indication while the timer is running, the UE considers the transmission of the first UL message successful (based on that reception, the UE stops the supervision timer). When the timer expires (i.e., UE does not receive the DL response indication while the timer was running), the UE considers the transmission of the first UL message/signal as a failed transmission attempt, and in response to that, the UE transmits a second UL message (e.g., a second RA preamble) also to the LTM candidate cell, wherein the second UL message (e.g., second RA preamble) is transmitted to the LTM candidate cell according to: i) an incremented transmission power compared to the first transmission power; and/or ii) on a second UL resource (e.g., RA resources in time and frequency) associated to a second beam (e.g., SSB or CSI-RS of the LTM candidate cell) the UE selects.

In one set of embodiments, for monitoring of the DL response indication, the UE is configured with a time window with one or more of the following parameters: a start time, a duration and/or an end time. When the UE transmits the first UL message, the UE monitors whether a DL response indication from the serving cell is received within the time window duration (e.g., UE starts to monitor the DL response at the beginning of the time window, for the duration of the time window, and before the end of the time window). When the UE receives the DL response indication, the UE considers the transmission of the first UL message successful (based on that the UE stops the supervision timer). When the time window duration is over (i.e., UE does not receive the DL response indication while the timer was running), the UE considers the transmission of the first UL message/signal as a failed transmission attempt, and in response to that, the UE transmits a second UL message (e.g., a second RA preamble) also to the LTM candidate cell, wherein the second UL message (e.g., second RA preamble) is transmitted to the LTM candidate cell according to: i) an incremented transmission power compared to the first transmission power; and/or ii) on a second UL resource (e.g., RA resources in time and frequency) associated to a second beam (e.g., SSB or CSI-RS of the LTM candidate cell) the UE selects.

In one option, the start of the time window and/or the duration and/or end of the time window has as a time reference to a time unit in a serving cell, e.g., frame number, slot number, subframe number, etc.

In one option, the one or more parameters of the time window (e.g., duration, start and end) are received as part of a RAR configuration, even if the DL response indication is not a RAR. For example, the UE may rely on the RAR configuration in the serving cell configuration of the LTM candidate cell.

In one option, the DL response indication is a RAR received from a serving cell (i.e., with the UE's C-RNTI assigned for the serving cell and/or the cell group associated to the UE's MAC entity) for a preamble transmission in an LTM candidate cell. In other words, the UE receives the RAR scheduled in a PDCCH transmission from the serving cell addressed with the UE's C-RNTI and using the UE's PDCCH configuration for DL reception(s) in the serving cell.

In the UE-assisted fallback, the UE detects the preamble transmission failure for TA establishment/update (by the absence of the DL response indication from a serving cell) and triggers the fallback (transmission of a new preamble, re-transmissions, until the TA establishment is successful or until one or more conditions are reached). That means the S-DU did not transmit the DL response indication, because it may have not received a message from the C-DU (e.g., via the CU) including the timing advance value for the UE. As long as the UE needs to continue transmitting preamble(s) to an LTM candidate cell, as part of the TA establishment procedure, e.g. during fallback, the S-DU continues to apply scheduling restrictions (e.g., not transmit PDCCH to the UE on a serving cell, of the S-DU). When the S-DU detects that the first UL transmission was successful, the S-DU stops applying the scheduling restrictions and transmits the DL response indication. However, the S-DU, which may also be referred to as serving DU (with same acronym S-DU), needs to detect a failure TA establishment/update procedure to take further actions. The S-DU determines a TA establishment failure, based on or more of the options below.

In one option, the S-DU determines that a maximum number of preamble transmission attempts is reached without successful detection at the C-DU, e.g., by the reception of an indication from the UE (which knows that the maximum number has been reached) indicating that a maximum number of UL message transmission attempts has been reached. That may indicate a failure of the TA establishment procedure.

In one option, the S-DU determines the TA establishment failure when a validity timer monitored at the S-DU expires. The validity timer is started by the S-DU when the S-DU transmits the first DL indication to the UE, and is stopped when the S-DU receives a message from the C-DU (e.g., via the CU) including a timing advance value (e.g., either based on the first, second or the n-th transmission or re-transmission of the UL message from the UE). This is referred to as a validity timer, but the functionality may also be modeled as a time window in which the message from the C-DU is expected to be received, and when it is not received in the time window, the S-DU considers the TA establishment procedure as failed. The validity timer is not the same as the timer at the UE (supervision timer, RAR-like timer that is started/re-started at every transmission attempt). The expiry of the validity timer at the S-DU indicates to the S-DU the failure of the overall TA establishment procedure.

In another option, the S-DU receives from the C-DU (e.g., via the CU) an indication that a TA establishment procedure is failed, e.g., a message with the TA value absent. The C-DU may transmit the message with the TA value absent upon the expiry of a validity timer monitored at the C-DU (e.g., C-DU validity timer), wherein the validity timer is started by the C-DU when the C-DU is requested to configure a UE with a TA establishment/update procedure or when the C-DU confirms the request to the CU and/or the S-DU (e.g., when it provides the UL resources for the TA establishment/update).

In another option, the S-DU determines a UL transmission failed attempt by the UE based on one or more of the following. In one option, the S-DU detects the preamble transmission attempt failure for TA establishment/update by the expiry of a timer. The S-DU starts the timer when it transmits to the UE the first DL indication, and while the timer is running the S-DU expects from the candidate DU (C-DU), directly via an interface between the S-DU and C-DU (e.g., E5 interface) and/or the CU (via F1AP interface, from C-DU to S-DU), a message including a TA value calculated by the C-DU based on the reception of the UL message (RA preamble the UE transmits to the LTM candidate cell). When the timer expires and the S-DU does not receive the message including the TA value, the S-DU considers a preamble transmission failure for TA establishment/update; the timer is re-started and while it is running, the S-DU expects from the C-DU (e.g., via the CU) the message with the timing advance value associated to the subsequent UL transmissions; the process continues, and each time the timer is re-started associated with an UL transmission attempt, though there is an uncertainty, because there may be more UL transmission from the UE to an LTM candidate compared to the times the timer has been re-started.

In one option, the S-DU detects the preamble transmission attempt failure for TA establishment/update by the reception of a failure indication from the candidate DU (associated to the candidate cell in which the UE transmits the UL message), directly via an interface between the S-DU and C-DU (e.g., E5 interface) and/or the CU (via F1AP interface, from C-DU to S-DU). The S-DU transmits to the UE the first DL indication and expects a message including a TA value calculated by the C-DU based on the reception of the UL message (RA preamble the UE transmits to the LTM candidate cell). When the S-DU receives a failure indication from the C-DU, the S-DU considers a preamble transmission failure for TA establishment/update. In that case, the C-DU may start a timer when it configures the TA establishment and expects the first UL message and re-start the timer each timer the timer expires. The counting of the number of times the C-DU re-starts the timer represents a number of UL subsequent transmissions.

In one option, the S-DU detects the preamble transmission attempt failure for TA establishment/update by the reception of a message from the candidate DU (associated to the candidate cell in which the UE transmits the UL message), directly via an interface between the S-DU and C-DU (e.g., E5 interface) and/or the CU (via F1AP interface, from C-DU to S-DU), wherein a TA value is absent in the message. The S-DU transmits to the UE the first DL indication and expects a message including a TA value calculated by the C-DU based on the reception of the UL message (RA preamble the UE transmits to the LTM candidate cell). When the S-DU receives a message with a TA value absent from the C-DU, the S-DU considers a preamble transmission failure for TA establishment/update. In that case, the C-DU may start a timer when it configures the TA establishment and expects the first UL message and re-start the timer each time the timer expires. The counting of the number of times the C-DU re-starts the timer represents a number of UL subsequent transmissions.

When the S-DU detects that the first UL signal/message (e.g., RA preamble) is not successfully received at the C-DU (preamble transmission failure for TA establishment/update), the S-DU continues to apply one or more scheduling restrictions, which comprises the S-DU refraining from transmitting DL data to the UE and/or PDCCH to the UE, because the UE is expected to be transmitting a second UL signal/message (second RA preamble).

In one set of embodiments, the UE receives the first DL indication from the serving cell, transmits the first UL message to the LTM candidate cell and monitors the DL response indication from the serving cell.

In one set of embodiments, the UE receives the first DL indication, which means the UE is monitoring a serving cell. Based on the DL indication, the UE transmits the first UL message, i.e., the UE switches its transmitter to the LTM candidate cell in which it transmits the first UL message. After the transmission, the UE switches its receiver to the serving cell, i.e. while the UE transmits the first UL message the UE does not need to monitor the receptions from the serving cell(s) because the S-DU is applying scheduling restrictions. However, after the transmission of the first UL message, the UE switches its receiver to the serving cell to monitor the potential reception of the DL response indication.

Some embodiments include UE reception of the timing advance value in the DL response indication. In one set of embodiments, the UE receives in the DL response indication from a serving cell, including at least one TA value for an LTM candidate cell, e.g. including an indication of that LTM candidate cell, such as an LTM configuration identity, cell identity, LTM candidate cell group configuration identity. In response, the UE starts a time alignment timer (e.g., timeAlignmentTimer, whose value may have also been configured to the UE in an RRC Reconfiguration message) when the UE receives the TA value (i.e., the UE monitors the validity of the TA value for the LTM candidate cell). When the UE further receives an LTM cell switch command from the S-DU, for that LTM candidate cell, the UE perform the LTM cell switch without random access when the TA timer is running at the moment of the LTM cell switch, i.e., the UE transmits UL information on PUCCH/PUSCH of the LTM candidate cell (e.g., an UL message indicating the LTM cell switch execution); or, the UE performs the LTM cell switch with a RA procedure (e.g., preamble transmission followed by RAR in the LTM candidate cell) with the LTM candidate when the time alignment timer has expired (and the TA has not been updated). In other words, upon reception of the LTM cell switch command the for the LTM candidate cell, the UE checks whether the time alignment timer is still running for that LTM candidate cell before performing the LTM cell switch without a RA procedure.

In one embodiment, the UE receives a DL response indication that indicates the timing advance value for multiple LTM candidate cells. The Dl response indication may contain a timing advance value and indication(s) of one or more multiple LTM candidate cells for which that value is applicable (e.g., value X, for LTM candidates a, b, c, d). Each LTM candidate cell may be indicated by a cell ID, or an LTM configuration identity, or a cell identity, or an LTM candidate cell group configuration identity, etc. For example, the DL response indication may correspond to a MAC CE including a TA value (or an indication based on which the UE maps to a TA value) and the associated LTM configuration identities corresponding to the cells for which the TA value is applicable.

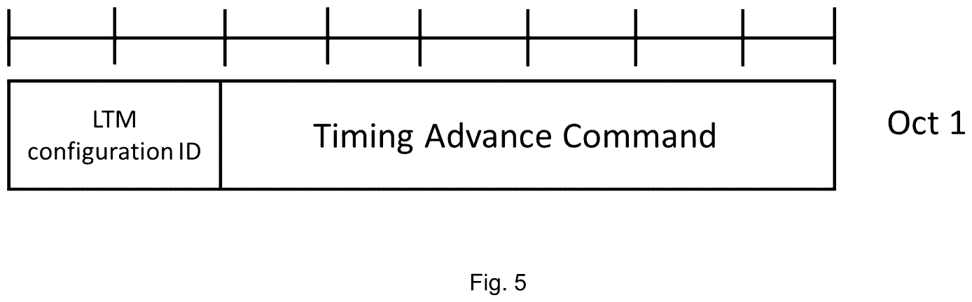

In one embodiment, the UE receives a DL response indication that corresponds to a MAC CE received by the UE from a serving cell (for the UL signal/message transmitted to the LTM candidate cell). The UE identifies the timing advance command MAC CE for an LTM candidate by the MAC subheader including a logical channel identifier (LCID) corresponding to that MAC CE. The MAC CE includes a timing advance command, which may indicate an index value TA (0, 1, 2 . . . 63) used to control the amount of timing adjustment that the MAC entity applies to an LTM candidate cell. The MAC CE also includes an indication of at least one LTM candidate cell, wherein each LTM candidate cell may be indicated by a cell ID, or an LTM configuration identity, or a cell identity, or an LTM candidate cell group configuration identity, etc. An example is illustrated in FIG. 5.

FIG. 5 illustrates an example of a MAC CE octet corresponding to the DL response indication. In the illustrated example, an LTM candidate configuration ID is used.

In one embodiment, the UE receives a DL response indication that corresponds to multiple MAC CE(s), potentially having received concatenated in the same MAC protocol data unit (PDU), received by the UE from a serving cell (for the UL signal/message transmitted to the LTM candidate cell), wherein each MAC CE corresponds to a timing advance command MAC CE for an LTM candidate by the MAC subheader including a logical channel identifier (LCID) corresponding to the MAC CE. Each MAC CE includes a timing advance command, which may indicate an index value TA (0, 1, 2 . . . 63) used to control the amount of timing adjustment that the MAC entity applies to an LTM candidate cell. The MAC CE also includes an indication of at least one LTM candidate cell, wherein each LTM candidate cell may be indicated by a cell ID, or an LTM configuration identity, or a cell identity, or an LTM candidate cell group configuration identity, etc.

In one embodiment, the UE receives a DL response indication which corresponds to a MAC CE, received by the UE from a serving cell (for the UL signal/message transmitted to the LTM candidate cell). The UE identifies the timing advance command MAC CE for an LTM candidate by the MAC subheader including a logical channel identifier (LCID) corresponding to that MAC CE. That MAC CE includes a timing advance command, which may indicate an index value TA (0, 1, 2 . . . 63) used to control the amount of timing adjustment the MAC entity applies to one or multiple LTM candidate cell(s) which may for a TA group (TAG) of LTM candidate cells. The MAC CE also includes an indication of at least one LTM candidate cell, wherein each LTM candidate cells may be indicated by a TAG Identity (TAG ID) allocated for a group or LTM candidate cells for which the UE may apply the same TA value.

In one embodiment, the DL response indication indicates multiple timing advance value(s), each potentially associated to one or multiple LTM candidate cells. Each timing advance value may be associated to a set/list or group of LTM candidate cells for which the value is applicable. The set/list or groups of LTM candidate cells may be indicated by one or more of a cell ID, LTM configuration identity, cell identity, LTM candidate cell group configuration identity, etc.

In one embodiment, the UE receives in the DL response indication an indication of at least one LTM cell for which the timing advance value is associated. This may be useful when the UE transmits multiple UL signal(s)/message(s) for establishing/updating the TA with multiple LTM candidate cell(s), potentially associated with multiple C-DU(s).

Some embodiments include UE reception of the timing advance value in a LTM cell switch command. In one set of embodiments, the UE receives the DL response indication from a serving cell (e.g., S-DU) and considers that the transmission of the UL signal/message was successful. In that case, one alternative is to leave the monitoring of the time alignment validity/UL synchronization to the network. For example, the UE does not start a TA timer for the LTM candidate cell to monitor whether the UE is UL synchronized with the LTM candidate cell. Instead, the UE further receives a timing advance value (calculated according to the second UL signal received at the candidate DU) during LTM the execution/cell switch to the LTM candidate cell, in the LTM cell switch command (e.g., in the MAC CE for LTM cell switch or in a MAC CE concatenated with the MAC CE for LTM cell switch).

In one embodiment, the UE receives an LTM cell switch command from the serving cell (e.g., S-DU) indicating the LTM candidate cell, wherein the LTM cell switch command includes the timing advance value for the indicated LTM candidate cell. In response, the UE transmits an UL message on a physical uplink control channel (PUCCH) or physical uplink shared channel (PUSCH) based on the received TA value.

In one set of embodiments, the attempts to establish TA (fallback) triggered by the UE (in response to the absence of a DL response indication after the UL signal/message transmission) is repeated until one or more conditions are fulfilled. The absence of the DL response indication after the transmission of the n-th UL signal/message triggers the UE to transmit an (n+1)-th UL message, either with an increased transmission power compared to the transmission power of the n-th UL message transmission, or indicating that the transmission of an (n+1)-th UL message is uses an (n+1)-th UL resource (e.g., RA resources in time and frequency) associated to an (n+1)-th beam the UE selects.

The one or more conditions may correspond to: the UE detects a preamble transmission failure for TA establishment/update; and/or the UE detects that a number of preamble transmission failures for TA establishment/update reaches a maximum value for a given LTM candidate cell (or groups/sets of cells).

In one option, the maximum value may have been configured at the UE by the Candidate DU responsible for the LTM candidate cell, which is the C-DU that has configured the UL resources for the TA establishment and/or TA updating.

In one option, the UE increments a counter each time it detects a preamble transmission failure for TA establishment/update (e.g., based on one or more of the solutions proposed above). The UE, before transmitting a preamble, checks if the counter reached the maximum value. When the UE determines that counter has reached the maximum value, the UE does not transmit the preamble considers the TA establishment as failure, also referred to as a TA establishment failure.

In other words, when the number of preamble transmission failure for TA establishment reaches its maximum value, the UE declares a TA establishment failure.

In one option, the maximum value for the number of preamble transmission failures for TA establishment may have been configured by the candidate DU responsible for the LTM candidate cell, which is the C-DU that has configured the UL resources for the TA establishment and/or TA updating. That may be configured in the RRC Reconfiguration message including the LTM configuration.

In some embodiments, the UE detects that a maximum transmission power for the UE to transmit the UL message to the LTM candidate cell has been reached. The maximum value may be reached after a number of transmission power increments, after preamble transmission failures for TA establishment.

In one option, the maximum transmission power for TA establishment may have been configured at the UE by the candidate DU responsible for the LTM candidate cell, which is the C-DU that has configured the UL resources for the TA establishment and/or TA updating. That may be configured in the RRC Reconfiguration message including the LTM configuration.

When the UE detects a TA establishment failure the UE can perform one or more of the following actions. The UE may transmit an indication to a serving cell (e.g., to the S-DU) indicating the TA establishment failure, potentially including one or more information associated to the failure such as: indication(s) of preambles transmitted, selected SSB(s) and/or CSI-RS(s), one or more radio measurements for the LTM candidates such as SSB RSRP, SSB RSRQ, CSI-RS RSRP, CSI-RS RSRQ, etc.

The indication may be included in an SCG Failure information message (even if this is not really an SCG failure). The indication may be included in a UE assistance information message. In one option, the UE is configured to transmit the message including the indication about the TA establishment failure when it occurs. The indication may be included in a Failure Information message. Because the message may be triggered due to various types of failure, the UE sets a failure type in the message to indicate this is a TA establishment failure.

As another option, the UE may: stop timers associated to the TA establishment; reset counters (e.g., set the value(s) to zero “0”) associated to the TA establishment; release one or more UL resources of the LTM candidate cell associated to the TA establishment, e.g., UL preambles; and/or log TA establishment failure information.

In one set of embodiments, the MAC entity at the UE detects a TA establishment failure and indicates to the higher layers, e.g. RRC, so further actions may be triggered by higher layers (e.g., transmission of a Failure Information message, as defined in TS 38.331).

In one set of embodiments, the UE performs in response to the detection of a TA establishment failure in RRC (e.g., transmission of a Failure Information message, as defined in TS 38.331), in response to an indication from lower layer (e.g., MAC entity detects the TA establishment failure and indicates to higher layers).

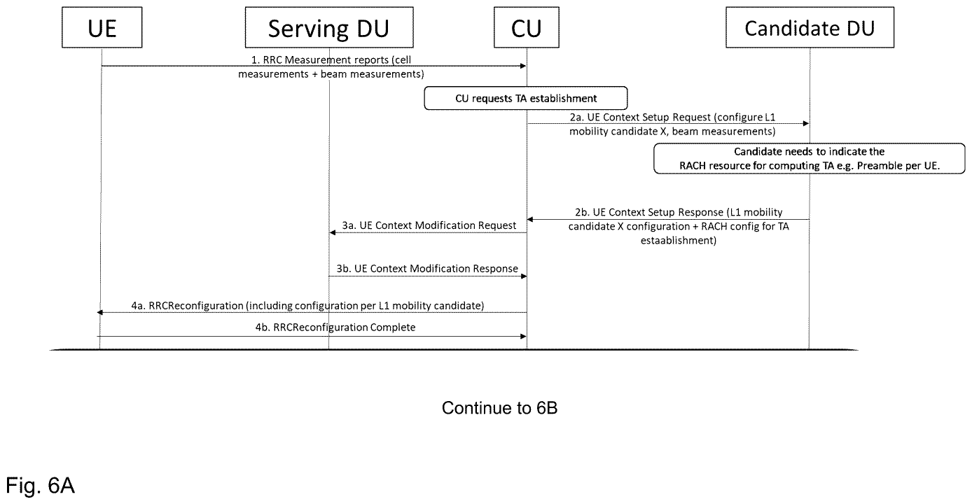

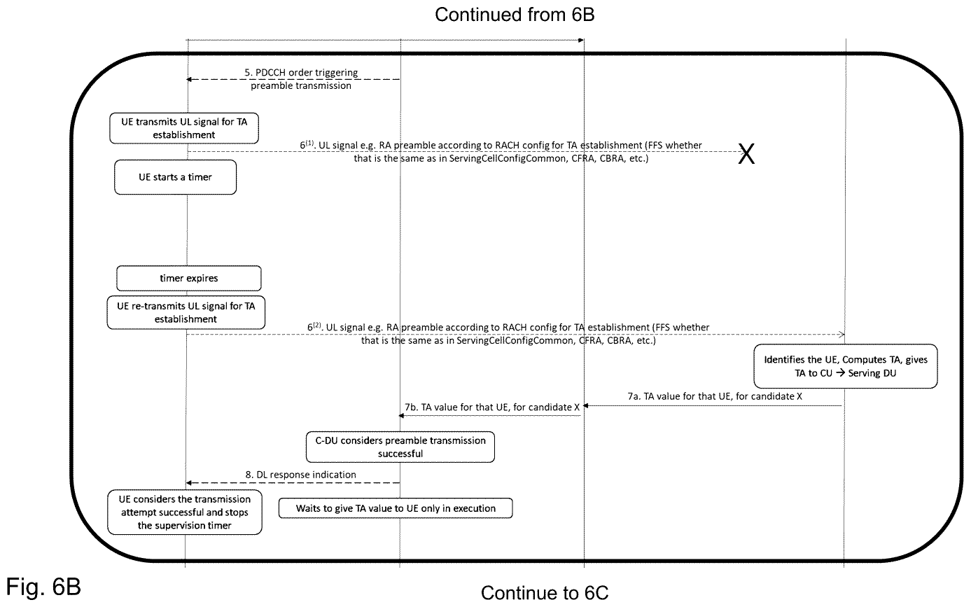

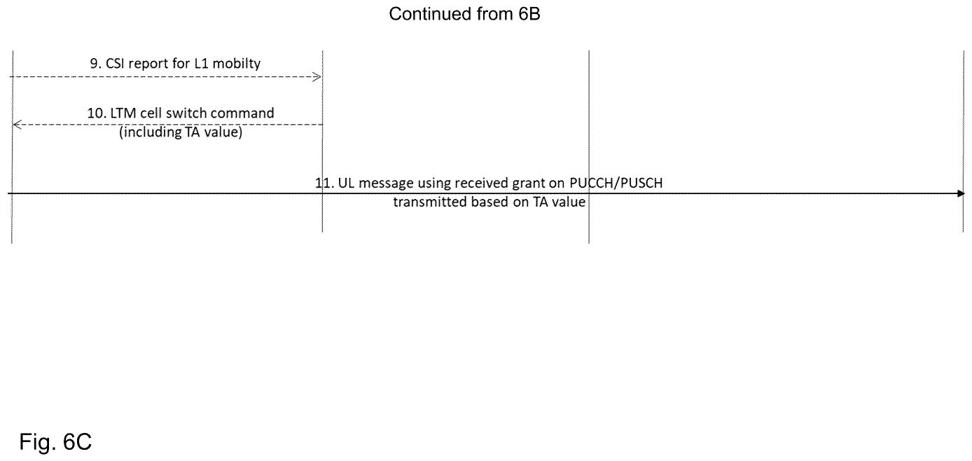

FIGS. 6A, 6B and 6C is a flowchart illustrating steps for the LTM configuration and UE-assisted TA establishment/updating, according to particular embodiments. The example illustrates failure of RA preamble transmission attempt for UE-assisted TA establishment for LTM. The steps include the following.

The steps from 1 to 4b in FIG. 6A comprise the steps for configuring an LTM candidate cell to the UE and configuring the TA establishment and/or updating.

In a set of embodiments, the UE transmits an RRC Measurement Report message to the network (e.g., CU) including measurements on one or more neighbor cells (e.g., cell based reference signal receive power (RSRP), reference signal receive quality (RSRQ) and/or signal to interference and noise ration (SINR)), in a frequency, wherein a neighbor cell, potentially including beam measurement information (to be later used for configuring the TA establishing procedure). The report is transmitted in response to a network configuration: the UE is configured by the network (e.g., by the CU) to transmit RRC measurement reports (e.g., based on the fulfillment of conditions associated to A3 and/or A5 measurement events, as defined in TS 38.331) including neighbor cells and serving cells.

The UE includes in the RRC Measurement Report (based on the measurement configuration) beam measurement information for the one or more neighbor cells, such as RSRP and/or RSRQ and/or SINR of one or more beams (e.g., of one or more SSBs and/or CSI-RS resources) of a neighbor cell with associated beam identifiers (e.g., SSB indexes and/or CSI-RS resource identifiers) or only beam identifiers, depending on the reporting configuration.

The network (e.g., the CU, CU-gNB) determines to configure the UE with L1/L2 inter-cell mobility. The network may determine to request the configuration of one or more neighbor cell(s) included in the RRC measurement report as target candidate cells for L1/L2 inter-cell mobility.

In a set of embodiments, the CU (e.g., CU-gNB, gNB) transmits a request message to a candidate DU (e.g., candidate gNB-DU, via the CU) to configure L1/L2 inter-cell mobility for at least one LTM candidate cell. In one option, the same request is used for a plurality of LTM candidate cell(s) of the same candidate DU. In one option, there is a request per target candidate cell, even if this is a request for cells of the same candidate DU. In one option, the CU transmits requests for multiple candidate DU(s), one per target candidate cell and/or one for multiple target candidate cell(s) in the same candidate DU. A requested target candidate cell may be one of the neighbor cells included in the RRC measurement report the CU may have received.

In one set of embodiments, the CU further requests to the candidate DU the establishment of the TA between the UE and the least one of its target candidate cell(s), for example, by including an indication for that in the request message described above. When the CU determines to configure L1/L2 inter-cell mobility for at least one target candidate cell in a candidate DU, the CU determines that the UE is not synchronized in the uplink with the at least one target candidate cell and decides to request the TA establishment to the candidate DU (responsible for that target candidate cell). This may be referred to as a CU-initiated TA establishment for L1/L2 inter-cell mobility.

In one embodiment, the CU includes a TA establishment request per target candidate cell for which the CU wants TA to be established, e.g., if the candidate cells are in different candidate DU(s), or in the same candidate DU but different TRP(s).

In one embodiment, the CU transmits requests for establishing TA to multiple candidate DU(s), one per target candidate cell. In one embodiment, the CU transmits requests for establishing TA for a set of target candidate cells in the same candidate DU.

In one embodiment, the CU further includes in the request to the candidate DU, the beam measurement information associated to a requested target candidate cell (e.g., beam measurements for one or more SSB of a requested target candidate cell of the candidate DU). That enables the candidate DU to generate an UL configuration based on the beam measurement information, e.g. physical random access channel (PRACH) preambles mapped to one or more SSB(s) reported as good enough/suitable in terms of RSRP and/or RSRQ and/or SINR.

In one embodiment, the request message from the CU to the candidate DU may correspond to a UE Context Setup Request (F1AP message).

In one embodiment, the request for the establishment of the TA between the UE and the least one of its target candidate cell(s) is an indication (encoded as an IE) in a UE Context Setup Request (F1AP message).

In one embodiment, the request message from the CU to the candidate DU may correspond to a UE Context Modification Request (F1AP message), e.g. when the candidate DU is the same as the serving DU.

In one embodiment, the request for the establishment of the TA between the UE and the least one of its target candidate cell(s) is an indication (encoded as an IE) in a UE Context Modification Request (F1AP message), e.g. when the candidate DU is the same as the serving DU.

In one embodiment, the request for the establishment of the UE assisted TA between the UE and the at least one of its candidate cells includes a request for the S-DU to perform TA establishment fallback(s) when detecting preamble transmissions failures for TA establishment.

In one set of embodiments, when the CU determines to configure LTM for at least one target candidate cell in a candidate DU, this represents for the candidate DU an implicit request that a TA establishment is needed. The candidate DU then decides by itself whether to provide one TA that is valid for all the L1/L2 inter-cell mobility target candidate cells that are being configured or one TA for each of the L1/L2 inter-cell mobility target candidate cells.

In one set of embodiments, when the CU determines to configure TA establishment for an LTM candidate cell in a candidate DU, this represents for the candidate DU an implicit request that a TA establishment fallback may be needed. The candidate DU may provide in response one or more parameters for the UE (and possibly to the S-DU and/or the CU) to control the TA establishment fallback procedure and/or to enable the UE (and possibly the S-DU, in addition to the UE) to perform the detection of a preamble transmission failures for TA establishment. The configuration may include any one or more of the following.

The configuration may include a maximum number of UL signal (e.g., RA preamble) transmission attempts by a UE for TA establishment, which is configured by the C-DU responsible for the LTM candidate cell, which is the C-DU that has configured the UL resources for the TA establishment and/or TA updating. In one option, this is configured per LTM candidate cell. In one option, this is configured per C-DU, i.e., a single value is valid for any LTM candidate cell from that C-DU. In one option, the UE receives that as part of the UL channel configuration for the UL signal/message transmission attempts.

The configuration may include a maximum number of transmission power increments for the UL message the UE transmits to the LTM candidate cell being configured. In one option, the transmission power increment (e.g., in dBs) and/or increment step is provided to the UE in the UL channel configuration for TA establishment.

The configuration may include a value for a supervision timer the UE monitors to detect an UL signal transmission failure for TA establishment/update. In one option, the UE detects the preamble transmission failure for TA establishment/update by the expiry of the supervision timer.

The configuration may include a value for a supervision timer the S-DU monitors to detect an UL signal transmission failure for TA establishment/update so the S-DU knows how to apply the scheduling restrictions. In one option, the S-DU detects the preamble transmission failure for TA establishment/update by the expiry of the supervision timer.

The S-DU may start the supervision timer when it transmits to the UE the first DL indication, and while the timer is running the S-DU expects from the candidate DU (C-DU), directly via an interface between the S-DU and C-DU (e.g., E5 interface) and/or the CU (via F1AP interface, from C-DU to S-DU), a message including a TA value (or an indication of that, as in the timing advance command MAC CE) calculated by the C-DU based on the reception of the UL message (RA preamble the UE transmits to the LTM candidate cell). When the timer expires and the S-DU does not receive the message including the TA value, the S-DU considers a preamble transmission failure for TA establishment/update. That is what makes the S-DU continue to apply scheduling restrictions to the UE, because the S-DU knows that the UE continues preamble transmission attempts until it reaches a maximum number of attempts.

The configuration may include one or more parameters of a time window (DL response indication time window, start time, duration, etc.) the UE monitors, wherein the absence of the DL response indication indicates to the UE an UL message/signal transmission failure for TA establishment/update. In one option, the S-DU detects the preamble transmission failure for TA establishment/update by the end of that time window.

In one set of embodiments, the candidate DU accepts the request for configuring LTM (for at least one LTM candidate cell) and accepts the request to establish TA for at least one LTM candidate cell (or a plurality of LTM candidate cells). In that case, the candidate DU responds to the request from the CU with a response message including the LTM candidate configuration (e.g., for LTM candidate cell X), and including an UL configuration for establishing the TA between the UE and the LTM candidate cell (e.g., LTM candidate cell X). The UE later receives the UL configuration (see step 4a).

In one embodiment, the response message also includes an indication that TA establishment has been accepted by the candidate DU, e.g. an indication in an IE of the F1AP message, in addition to the UL configuration. That may be used so the serving DU does not need to parse RRC fields in the response message to find the UL configuration and determine the acceptance for the TA establishment. The Serving DU may use that when the triggering of the TA establishment later leads to a message from the candidate DU to the serving DU (via the CU) with the TA value.

In one embodiment, the response from the candidate DU may correspond to a UE Context Setup Response (F1AP message).

In one embodiment, the response from the candidate DU may correspond to a UE Context Modification Response (F1AP message), e.g., if the candidate DU is the serving DU, which may be the case when a requested target candidate cell is in the serving DU.

In one embodiment, the UL configuration for establishing the TA between the UE and the LTM candidate cell (e.g., LTM candidate cell X) is valid for multiple UL signal/message transmissions to cover the fallback case when the first UL message is not successfully received in the C-DU.

In one embodiment, the response from the candidate DU includes one or more parameters for the UE to control the fallback for TA establishment/updates procedure and/or to enable the UE to perform the detection of a preamble transmission failures for TA establishment. The one or more parameters may comprise at least the parameters disclosed in the previous step, e.g. the maximum number of UL signal (e.g. RA preamble) transmission attempts by a UE for TA establishment, the maximum number of transmission power increments for the UL message the UE transmits to the LTM candidate cell being configured, the value for a supervision timer the UE monitors to detect an UL signal transmission failure for TA establishment/update, and/or the one or more parameters of a time window the UE monitors to detect an UL signal transmission failure for TA establishment/update.

Further details about the UL configuration for establishing the TA between the UE and the target candidate cell are provided later in step 4 and step 5, when the UE receives the UL configuration.

The UL configuration for TA establishment may contain one or more parameters for the TA establishment fallback such as: i) the initial transmission power for the UL signal/message; ii) the power step increment in case a fallback is triggered by the network, i.e. when the UE receives the second DL indication; iii) the association between beams (e.g., SSBs or CSI-RSs) and UL channel resources (e.g., PRACH occasions and/or time/frequency domain resources for preamble transmissions, RA preambles, etc.).

In one set of embodiments, the candidate DU accepts the request for configuring LTM (for at least one LTM candidate cell) but rejects the request to establish TA for at least one LTM candidate cell (or a plurality of LTM candidate cells). In that case, the candidate DU responds to the request from the CU with a response message including the LTM candidate configuration (e.g., for LTM candidate cell X). That may include an indication of the rejection of TA establishment, wherein the indication may comprise the inclusion or absence of a parameter or configuration in the response message (e.g., absence of an F1AP IE, or presence). In this scenario, the serving DU becomes aware that when LTM is to be executed to that target candidate cell, random access may be required with the target candidate during the execution for establishing the TA/UL synchronization.

In one set of embodiments, the candidate DU rejects the request for configuring LTM and transmits to the CU a message indicating the rejection, possibly including a cause value, e.g., overload.

In one set of embodiments, the candidate DU requests the establishment of a TA for the UE and a target candidate cell for LTM (for at least one target candidate cell). In that case, the candidate DU responds to the request from the CU for L1/L2 inter-cell mobility with a response message including the LTM candidate configuration (e.g., for LTM candidate cell X), and including an UL configuration for establishing the TA between the UE and the LTM candidate cell (e.g., LTM candidate cell X), which may serve as an indication that the candidate DU is requesting the TA establishment between the UE and one or more of its LTM candidate cell(s). The UE later receives the UL configuration (see step 4a).

The steps 3a) and 3b) may be used for including re-configuration(s) in the serving cell(s) by the serving DU before the UE is configured with LTM, e.g., to reconfigure CSI measurements. In that case, the CU generates an RRC Reconfiguration (e.g., RRCReconfiguration) message including a Cell Group Configuration generated by the serving DU. The CU also includes the LTM configuration with one or more LTM candidate cell configuration(s) and the necessary configuration for the UE to establish the TA with one or more target candidate cells for LTM.

In one embodiment, the S-DU determines the scheduling restrictions that the S-DU applies when the S-DU expects the UE to transmit the UL signal/message to the LTM candidate cell for TA establishment/updates and fallback(s) to the TA establishment/updates.

In one set of embodiments, the UE receives an RRCReconfiguration message (e.g., from the CU via serving DU) configuring LTM, the message including a LTM configuration configuring one or more LTM candidate cells, i.e. the LTM configuration including one or more LTM candidate cell configuration(s), and an UL configuration for establishing the TA between the UE and the LTM candidate cell (e.g., candidate cell X), as described in step 2(b).

In one embodiment, the UE receives an UL configuration for establishing the TA for an LTM candidate cell. The UL configuration may be for more than a single UL transmission, if a fallback is needed (when a first UL message transmission is not successfully received in the C-DU, as referred to herein as a preamble transmission failure during TA establishment).

In one embodiment, the UE receives multiple UL configuration(s) for establishing the TA for multiple LTM candidate cell(s), one per LTM candidate cell.

In one embodiment, the UE receives an indication associated to an LTM candidate cell, to indicate that this is a cell for which the UE shall establish TA, e.g. by transmitting an UL signal/message. The UE may have received at least one UL configuration for each target candidate cell for which it shall establish TA, based on which the UE transmits a message to the target candidate cell.

In one embodiment, the UE receives an indication associated to an LTM candidate cell to indicate that this is an LTM candidate cell for which a fallback is available when the UE tries to establish TA.

In one embodiment, the target candidate cells the UE is configured with, for which the UE establishes TA, comprises a subset of the LTM candidate cells. In other words, the UE may be configured with as number ‘N’ of LTM candidates and is configured to establish TA with a number ‘N1’ (with N1<N) candidate cells. The reason may be that some target candidate cells may not require TA to be established, e.g. if the target candidate cells are in the same serving DU and/or are synchronized with one or more serving cells, and/or some of the candidate cells are co-located with one or more of the other serving cell(s) so that the same TA value may be assumed (i.e., some target candidate cells may be assumed to be UL synchronized with the UE).

In one embodiment, the UE receives an indication of an LTM candidate cell for which the UE does not need to establish TA and, in addition, the UE receives an indication that for the candidate cell the UE may assume the same TA value used for a given serving cell. For example, the UE receives associated to the LTM candidate cell configuration a serving cell index of one of its configured serving cells. Then, when the UE receives the LTM cell switch command for LTM execution (e.g., MAC CE including an indication of a candidate cell configuration) the UE determines that this is a cell for which a TA value to be considered is the same as the TA value for the indicated serving cell, and the UE applies that TA value accordingly when accessing the LTM candidate cell.

In one embodiment, the UE receives an indication of an LTM candidate cell for which the UE does not need to establish TA, and in addition, the UE receives a TA value for the candidate cell. For example, the UE receives associated to the target cell configuration a serving cell index of one of its configured serving cells. Then, when the UE receives the LTM cell switch command (e.g., MAC CE including an indication of a candidate cell configuration) the UE applies that TA value provided in the LTM cell switch command.

In one related embodiment, the UE receives an indication of an LTM candidate cell for which the UE does not need to establish TA, and in addition, the UE receives the TA value 0 for the candidate cell. For example, the UE receives associated to the candidate cell configuration a serving cell index of one of its configured serving cells. Then, when the UE receives the LTM cell switch command (e.g., MAC CE including an indication of a candidate cell configuration) the UE applies that TA value 0 provided in the LTM cell switch command.

In one embodiment, the UE receives an indication of an LTM candidate cell for which the UE does not need to establish TA (e.g., absence of the UL configuration for TA establishment or an explicit indication in the LTM candidate cell configuration), and in addition, the UE receives an indication that for the candidate cell the UE may require random access with the LTM candidate cell upon reception of the LTM cell switch command (e.g., MAC CE including an indication of a candidate cell configuration).

In one embodiment, the UE receives the UL configuration for establishing the TA between the UE and the LTM candidate cell (e.g., candidate cell X), which may comprise an indication (e.g., an UL configuration for an LTM candidate cell) based on which the UE transmits one or more UL signal(s) or message(s) to the LTM candidate cell (e.g., one or more RA or PRACH preamble(s)), enabling the candidate DU to establish the TA and to indicate the TA value to the CU and the serving DU. The UL configuration may be valid for multiple UL transmissions from the UE to establish the TA to cover the fallback case when the C-DU does not successfully detect the UL message transmitted by the UE.

In one embodiment, the UE receives the UL configuration for establishing the TA between the UE and the LTM candidate cell (e.g., candidate cell X) (e.g., as a field, parameter, set of parameters and/or fields, IE, etc.) within the LTM candidate configuration (e.g., for candidate cell X, in an RRCReconfiguration container, and/or an IE CellGroupConfig and/or an SpCell configuration). That may be, e.g., one or more parameters in a random access configuration of the SpCell configuration in the target candidate configuration. The RA configuration may be valid for multiple UL transmissions from the UE to establish the TA to cover the fallback case when the C-DU does not successfully detect the UL message transmitted by the UE.

In one embodiment, the UE receives the UL configuration for establishing the TA between the UE and the LTM candidate cell (e.g., candidate cell X) configured as an IE and/or field and/or set of IEs and fields in the LTM configuration, which may correspond to an IE for configuring one or more LTM candidate cell(s) for LTM.

In one option, the UL configuration is set for an LTM candidate cell, e.g., a candidate cell has its UL configuration for TA establishment.

In one option, the UL configuration is set for a set of LTM candidate cell(s). The UL configuration may still be for a given LTM candidate cell, as the parameters are defined for a given UL channel of a given cell, but when the UE establishes TA for the single cell, the configuration is valid for a set of cells, which may be feasible if multiple cells are of the same candidate DU and/or the same TRP and/or have some common transceiver properties and/or are UL synchronized.

In one embodiment, the UE receives the UL configuration for establishing the TA between the UE and the LTM candidate cell (e.g. candidate cell X) configured as an IE and/or field and/or set of IEs and fields in the RRC Reconfiguration message in which the UE receives the LTM configuration.

In one embodiment, the UE receives the UL configuration for establishing TA between the UE and the LTM candidate cell (e.g., candidate cell X) comprising the configuration of an UL signal/message and/or the configuration of the channel(s) for the UE to transmit the UL signal/message (to be received at the candidate DU). The UL channel configuration (e.g., available time and/or frequency domain resources) may be valid for multiple UL transmissions from the UE to establish the TA to cover the fallback case when the C-DU does not successfully detect the UL message transmitted by the UE.

The UL signal/message may correspond to a random-access preamble (or an equivalent sequence defined in the physical layer), indicated by a random access preamble index (e.g., ra-PreambleIndex of IE INTEGER (0 . . . 63)) in the UL configuration.

The UL configuration may further include at least one beam identifier/index associated to an UL signal, such as an SSB index and/or a CSI-RS resource identifier. For example, when the UL signal corresponds to a preamble, the UL configuration may comprise at least one TA establishment resource, as the pair (ssb of IE SSB-Index, ra-PreambleIndex or IE INTEGER (0 . . . 63)). The UL configuration may comprise multiple of these pairs, as the Candidate DU is not aware which SSB and/or CSI-RS resource the UE may choose for establishing the TA. The configured beam(s), e.g. SSBs, may be referred to as candidate beams for TA establishment.

In the example ASN.1 below, the UE is provided with a list of TA establishment resource(s) for an LTM candidate cell, wherein each resource has a preamble index and an SSB index associated:

| | |
|---|---|
| TA-Config ::= | SEQUENCE { |

[...]

| | |
|---|---|
| candidateBeamList | SEQUENCE (SIZE(1..FFS)) OF TA-SSB-Resource OPTIONAL, |

[...]
}
[...]

| | |
|---|---|
| TA-SSB-Resource ::= | SEQUENCE { |
| ssb | SSB-Index, |
| ra-PreambleIndex | INTEGER (0..63), |

...
}

In another example, the UE is provided with a list of TA establishment resource(s) for an LTM candidate cell, wherein each resource has a preamble index and a CSI-RS resource associated. In addition to the pair, there is also per resource a random-access occasion list. These are RA occasions that the UE shall use when performing TA establishment (including potential subsequent transmissions of preambles if a fallback is needed, when there is a detection of a preamble transmission failure) with an LTM candidate cell upon selecting the candidate beam identified by the corresponding CSI-RS.

| | |
|---|---|
| TA-CSI-Resource ::= | SEQUENCE { |
| csi-RS | NZP-CSI-RS-ResourceId, |
| ra-PreambleIndex | INTEGER (0..63) |
| OPTIONAL, -- Need R | |
| ra-OccasionList | SEQUENCE (SIZE(1..maxRA-OccasionsPerCSIRS)) OF INTEGER |
| (0..maxRA-Occasions-1) | OPTIONAL, -- Need R |
| ... | |
| } | |

The candidate DU determines which beam identifier(s)/indexes of an LTM candidate cell to configure for TA establishment based on beam measurement information (e.g., measurement information on SSBs and/or CSI-RS of a target candidate cell) obtained from the CU in/with the request of LTM. The network (e.g., CU) may have configured the UE to report beam measurement information as it intended to trigger the UE to establish TA with an LTM candidate cell when it configures the UE with LTM. For example, for a neighbor cell included in the measurement report, the UE may have reported SSB index X and SSB index Y and their respective RSRP values (e.g., above a threshold in the reporting configuration), indicating these are suitable beams in the neighbor cell.

The UL configuration may further include one or more of the following parameters:

Root Sequence Index: PRACH root sequence index for TA establishment in LTM, to be possibly defined in TS 38.211. This may be a field, e.g. rootSequenceIndex of IE INTEGER (0 . . . 137)).

RSRP threshold for SSB: L1-RSRP threshold used for determining whether a candidate beam may be used by the UE to attempt contention free random access to establish TA with an LTM candidate cell. This may be a field rsrp-ThresholdSSB.

SSB(s) per RACH occasion(s): Number of SSBs per RACH occasion for contention free TA establishment with an LTM candidate cell. This may be the field ssb-perRACH-Occasion of IE ENUMERATED {oneEighth, oneFourth, oneHalf, one, two, four, eight, sixteen}.

RA SSB occasion mask index: Explicitly signaled PRACH Mask Index for RA resource selection, valid for one or more SSB resources. This may be the field ra-ssb-OccasionMaskIndex.

Subcarrier spacing for MSGT: Subcarrier spacing for contention free TA establishment with the target candidate cell, e.g. values 15 kHz or 30 kHz (FR1), and 60 kHz or 120 kHz (FR2). This may be the parameter msg1-SubcarrierSpacing of IE SubcarrierSpacing.

A triggering condition in the form of a measurement event A2, A3, A4 or A5 that is to be fulfilled before triggering TA establishment with an LTM candidate cell.

The UL configuration may correspond to contention-free resource and/or dedicated resources, so that when the candidate DU receives a preamble in an UL slot in a frequency resource it is able to determine which UE the resource has been configured for and/or which serving DU/CU is serving that UE.

The UL configuration may further include one or more parameters of a random access configuration, such as RACH parameters such as preamble(s), time and frequency resources for a PRACH, and/or one or more parameters, fields and/or IEs within the IE RACH-Config, RACH-ConfigCommon, RACH-ConfigDedicated, RACH-ConfigGeneric as defined in TS 38.331. This may be a special RACH configuration containing only the transmission parameters, i.e. no random access response parameters, because the UE is not expected to receive a response from the target candidate cell in response to the preamble transmission.

In one embodiment, the UE receives the UL configuration for establishing TA between the UE and the LTM candidate cell (e.g., candidate cell X) comprised within one or more parameters in the beam failure recovery (BFR) configuration of the target candidate cell (e.g., IE BeamFailureRecoveryConfig) associated with the UL BWP that may be assumed active upon L1/L2 inter-cell mobility execution. The candidate DU may distinguish preambles and RACH messages for the TA establishment from other preambles and RACH attempts. BFR is not used for the UE before the target candidate is accessed during L1/L2 inter-cell mobility execution, which makes this possible without the need of a further detailed configuration.

In one embodiment, the UE obtains the UL configuration, at least partially, from a random access configuration of the LTM candidate configuration, e.g. the RACH configuration of the SpCell configuration of the LTM candidate configuration. The UE may receive a time/frequency resource partitioning for PRACH and/or a preamble partitioning indicating a subset of RACH resource used for that purpose, so that the candidate DU is aware that a preamble transmitted shall not be responded in a RAR, but the TA shall be calculated and provided to a serving DU. In that sense, the candidate DU may provide different PRACH resource partitioning for UE(s) in different serving DU(s), in case of multiple requests.

In one embodiment, the UL configuration for TA establishment contains one or more parameters for the fallback of the TA establishment/updates if a fallback is triggered by the UE (e.g., by the absence of the DL response indication within the time window or while the supervision timer is running). For example: i) the initial transmission power for the UL signal/message; ii) the power step increment if a fallback is triggered by the UE; iii) the association between beams (e.g., SSBs or CSI-RSs) and UL channel resources (e.g., PRACH occasions and/or time/frequency domain resources for preamble transmissions, RA preambles, etc.).

The UE transmits an RRCReconfigurationComplete message after it successfully applies the RRCReconfiguration message.

In one set of embodiments, the UE receives an RRCReconfiguration message (e.g., from the CU via serving DU) including an UL configuration for establishing the TA between the UE and the LTM candidate cell (e.g., candidate cell X), only after that has received a LTM configuration configuring one or more LTM candidate cells. This basically means that the CU or serving DU may request the establishment of the TA to the candidate DU after LTM has been configured.

For example, the S-DU and/or CU may trigger the TA establishment when there is some certainty that there will be an LTM cell switch towards that candidate DU. This also means that the UL configuration is received by the serving DU before sending the lower layer switching command to the UE for executing the LTM. The UE transmits an RRCReconfigurationComplete message after it successfully applies the RRCReconfiguration message.

Some embodiments include UE assisted fallback for TA establishment/updates. According to a set of embodiments, the UE is responsible for monitoring whether the UE transmission of the UL message/signal to the candidate DU for TA establishment is successful. In other words, the UE determines whether there is a preamble transmission failure for TA establishment/update. There are different options on how to define these failure monitoring steps.

In one option, the UE detects the preamble transmission failure for TA establishment/update by the expiry of a timer (e.g., supervision timer, RAR-like timer, etc.).

There are different options for the starting criterion for the timer. In one option, the UE starts the timer when it receives from the network (e.g., a serving cell, of S-DU) the first DL indication (e.g., the RRC Reconfiguration including the LTM configuration). In one option, the UE starts the timer when the UE receives a subsequent PDCCH order transmitted after the RRC Reconfiguration including the LTM configuration. In one option, the UE starts the timer when it transmits the first UL signal/message in response to the first DL indication.

While the timer is running, the UE expects from the S-DU the DL response indication (possibly including a timing advance value or an indication of the TA value, e.g., within a TA command calculated by the C-DU based on the reception of the first UL message (RA preamble the UE transmits to the LTM candidate cell). When the UE receives the DL response indication (potentially including the timing advance value) the UE stops the timer and considers the TA establishment procedure successful. When the timer expires and the UE has not received the DL response indication (potentially including the timing advance value), the UE considers a preamble transmission failure for TA establishment/update.

In one option, the UE detects the preamble transmission failure for TA establishment/update at the end of a time window (whose properties are a starting point and a duration and/or an end point in time). The UE expects from a serving cell (from the S-DU) a DL response indication including a TA value (or indication of a TA value, e.g. TA command), calculated by the C-DU based on the reception of the first UL message (RA preamble the UE transmits to the LTM candidate cell). When the UE receives the DL response indication including the TA value within the time window, the UE considers the TA establishment procedure successful. When the time window ends and the UE has not received the DL response indication including the TA value, the UE considers a preamble transmission failure for TA establishment/update.

In one option, the properties of the time window are the same as the properties of a RAR time window configured as part of the UL channel configuration for TA establishment, provided to the UE.

In one set of embodiments, what triggers the UE to transmit the first UL signal/message to the LTM candidate cell is a subsequent message (e.g., MAC CE, PDCCH order, downlink control information (DCI), RRC message) received by the UE after the RRC reconfiguration (e.g., RRCReconfiguration message) configuring LTM including the indication for TA establishment for that LTM candidate cell. The subsequent message is shown in FIG. 6B as step 5.

The scenario in which the subsequent message may be useful is a scenario where the candidate DU accepts the TA establishment from the CU, but the serving DU has some freedom to trigger the TA establishment to the UE when an interruption time would not be so critical, because to transmit the first UL signal to the target candidate the UE may need to stop listening to the serving cell(s)/serving DU. Upon reception of the subsequent message (e.g., PDCCH order), the UE transmits the first UL signal/message based on the previously received UL configuration for the TA establishment in LTM configuration.

The first DL indication may correspond to the subsequent message (e.g., MAC CE, PDCCH order, DCI, RRC message), as exemplified in step 5.

In one embodiment, the subsequent message (first DL indication) includes one or more indications related to how the UE performs the transmission of the first UL message/signal to the LTM candidate cell, e.g., parameters of the RA preamble transmissions and/or RA resource(s). The one or more indications may correspond to a pointer or indication to one or more parameters in the UL configuration for establishing the TA between the UE and the LTM candidate cell (e.g., candidate cell X), as described in step 2(b).

In one option, the UE may receive in the UL configuration a set of RA preamble(s), e.g. p1, p2, p3, . . . , pK. Thus, the subsequent message (DL indication) may indicate one or more of the configured RA preambles, e.g. p3 and p2. Based on the indication(s) the UE knows which preambles it may transmit/select/use for transmission to the LTM candidate cell.

In one option, the UE receives in the subsequent message an RA preamble index (e.g., ra-PreambleIndex) of the LTM candidate cell explicitly provided by PDCCH.

In one option, the UE may receive in the UL configuration a set of RA resource(s), like sequence and/or time domain resources and/or frequency domain resources, associated to an RS index or identifier, e.g. SSB index. Thus, the subsequent message (DL indication) may indicate one or more of the configured RA resources, e.g., by indicating one or more SSBs. Based on that the UE knows which SSBs (and consequently which RA resources) it may select for transmission to the LTM candidate cell.

In one option, the UE may receive in the UL configuration a set of RS(s) indexes, e.g. SSB indexes. Thus, the subsequent message (DL indication) may indicate one or more of the SSB indexes associated to one or more RA resources, e.g., by indicating one or more SSBs. Based on that the UE knows which SSBs (and consequently which RA resources) the UE may select for transmission to the LTM candidate cell.

In one option, the UE may receive in the UL configuration one or more indications of LTM candidate cells (e.g., LTM candidate cell ID(s), LTM configuration IDs, etc.) in which the UE should send the second UL message/signal (and/or other UL messages after the first UL message). If multiple indications of LTM candidate cells are provided to the UE, each LTM candidate cell may be mapped to a set of RA preambles, RA preamble indexes, RA resources or RS(s) indexes (e.g., SSB indexes). Based on this, the UE knows which parameters to use for each LTM candidate cell that is indicated. The UE selects only one LTM candidate cell from the set of those configured to which to send the first UL message/signal. Alternatively, the UE may select one candidate cell to which to send the first UL message/signal according to the order in which they are received or according to some priority indicated in the UL configuration.

The scheme of a subsequent message used for the TA update/maintenance mechanism is shown in the following sections.

The following are steps for failure detection of the first UL preamble at the C-DU and UE assisted fallback for TA establishment. In the following steps, the sets of embodiments cover the cases where the UL signal/message for TA establishment is not successfully detected by the C-DU and the actions from the different nodes involved in response to that (e.g., S-DU, C-DU), in what is referred to herein as a fallback procedure for TA establishment.

In a set of embodiments (see Step 6(1)), the UE transmits the first UL signal/message (e.g., PRACH preamble, RA preamble) to an LTM candidate cell for which the UE needs to establish TA, based on the UL configuration described in Step 4.

In one set of embodiments, the UE transmits the first UL signal in response to the reception of the RRCReconfiguration configuring LTM (including the indication for TA establishment for that LTM candidate cell), as shown as in Step 4(a) in FIG. 6A.

In this case the first DL indication may correspond to the RRCReconfiguration message configuring LTM.

This may be the case in the first UL message, while subsequent messages may be used for fallback for TA establishment or TA updates.

In one set of embodiments, the UE transmits the first UL signal in response to the reception of the subsequent message (e.g., MAC CE, PDCCH order, DCI, RRC message) received by the UE after the RRCReconfiguration configuring LTM for that LTM candidate cell. The subsequent message is shown in FIG. 6B as Step 5(1).

In this case, the first DL indication may correspond to the subsequent message (e.g., MAC CE, PDCCH order, DCI, RRC message).

In one embodiment, the UL configuration is associated to a validity time so that the serving DU and/or the CU has a limited time to trigger the subsequent message. That may be used to limit the UL resources reserved for TA establishment, e.g., if these are UE dedicated/contention-free resources.

In one embodiment, upon triggering the TA establishment with an LTM candidate cell, the UE initiates a procedure (e.g., in response to the first DL indication, like the subsequent message of the RRC Reconfiguration with the LTM configuration). Some steps in such procedure may be considered similar to steps performed in a RA procedure, but there are some differences: for example, in the procedure for TA establishment herein the UE does not expect a RAR from the LTM candidate cell in response to a RA preamble transmitted in the LTM candidate cell. Instead, a DL response indication is expected from a serving cell (not from the LTM candidate cell), e.g. from the S-DU, not from the C-DU. The procedure for TA establishment (in particular the initial attempt and potentially relevant steps for the fallback when needed) comprises one or more of the following steps.

TA establishment may include performing one or more measurements on SSBs and/or CSI-RS resources of the LTM candidate cell for which the UE needs to establish the TA, e.g. SSB RSRP measurement(s) for one or more SSBs, such as SS-RSRP of SSB index=1, SS-RSRP of SSB index=2, . . . , SS-RSRP of SSB index=k; e.g. CSI-RS RSRP measurement(s) for one or more CSI-RS(s).

TA establishment may include performing an UL channel resource selection, e.g. RACH resource selection, associated to an SSB and/or CSI-RS resource of the LTM candidate cell for which the UE needs to establish the TA. For example, the UE selects an SSB or CSI-RS resource for which a measurement is above a threshold (possibly configured in the UL configuration), e.g. SSB RSRP>rsrp-ThresholdSSB; and the UE selects an UL channel resource (e.g., time/frequency resources and preamble) for TA establishment associated to the selected SSB, wherein the association is also part of the UL configuration.

TA establishment may include transmitting the first UL signal/message (e.g., selected preamble based on the selected SSB) in the selected RA resource to the LTM candidate cell, wherein the first UL message is transmitted with a first transmission power, wherein the selected RA resource corresponds to a first UL resource (e.g., RA resources in time and frequency) associated to the first beam the UE has selected (e.g., selected SSB).

In one option, the UE sets a variable for the preamble transmission to the signaled preamble, e.g., set the variable PREAMBLE_INDEX to the signaled ra-PreambleIndex.

In one option, the UE selects the SSB signaled, e.g. by PDCCH. In one option, the UE selects an SSB with SS-RSRP (as defined in TS 38.215) above rsrp-ThresholdSSB amongst the associated SSBs.

In one option, the UE sets the PREAMBLE_INDEX to a ra-PreambleIndex corresponding to the selected SSB.

In one option, the UE selects the CSI-RS signaled e.g. by PDCCH. In one option, the UE selects a CSI-RS resource with CSI-RSRP (as defined in TS 38.215) above rsrp-ThresholdCSI-RS amongst the associated CSI-RSs. In one option, the UE sets the PREAMBLE_INDEX to a ra-PreambleIndex corresponding to the selected CSI-RS.

In one option, the UE selects an SSB and when an SSB is selected, the UE determines the next available PRACH occasion from the PRACH occasions corresponding to the selected SSB permitted by the restrictions given by a configuration (e.g., the ra-ssb-OccasionMaskIndex, part of the UL configuration for TA establishment) if configured or indicated by PDCCH (the MAC entity at the UE selects select a PRACH occasion randomly with equal probability amongst the consecutive PRACH occasions, corresponding to the selected SSB.

In one option, the UE (e.g., the MAC entity at the UE) accounts for the possible occurrence of measurement gaps when determining the next available PRACH occasion corresponding to the selected SSB).

In one option, the UE selects a CSI-RS and determines the next available PRACH occasion from the PRACH occasions in a configured RA occasion list/set (e.g., ra-OccasionList) corresponding to the selected CSI-RS. The UE (e.g., the MAC entity at the UE) selects a PRACH occasion randomly with equal probability amongst the PRACH occasions occurring simultaneously but on different subcarriers, corresponding to the selected CSI-RS.

In one option, the UE (e.g., the MAC entity at the UE) accounts for the possible occurrence of measurement gaps when determining the next available PRACH occasion corresponding to the selected CSI-RS).

In one option, when the UE determines if there is an SSB with SS-RSRP above rsrp-ThresholdSSB or a CSI-RS with CSI-RSRP above rsrp-ThresholdCSI-RS, the UE uses the latest unfiltered L1-RSRP measurement.

In one option, the UE does not maintain a counter for preamble transmissions (e.g., PREAMBLE_TRANSMISSION_COUNTER) which would be maintained in a RA procedure. The reason is that this should be controlled by the network (e.g., S-DU), which controls the need for a fallback procedure (i.e., RA preamble re-transmissions with power ramping and/or beam/SSB/CSI-RS reselection without reaching a maximum number of preamble transmissions attempts). Thus, in this network controlled fallback, it would be the network (e.g., S-DU) that monitors the number of preamble transmissions, e.g. by controlling a preamble transmission counter, which is incremented each time the UE is indicated to transmit a RA preamble for the TA establishment for LTM.

In one option, the UE sets the first transmission power (PREAMBLE_RECEIVED_TARGET_POWER) by adding up one or more of a value provided in the UL configuration (e.g., preambleReceivedTargetPower); a delta value which depends on the RA preamble format (e.g., 0 dB for preamble format 0), e.g. DELTA_PREAMBLE; and/or a value indicated in the DL indication or an indication in the DL indication which enables the UE to derive a value which is to be added to the first transmission power.

In one option, the UE (e.g., the MAC entity at the UE) instructs the physical layer at the UE to transmit the selected or indicated RA preamble using the selected PRACH occasion, and the first transmission power (e.g., PREAMBLE_RECEIVED_TARGET_POWER).

In a set of embodiments, when the UE transmits the UL signal/message (e.g., RA preamble) to the LTM candidate cell (e.g., to the C-DU responsible for the LTM candidate cell) in the selected resources (based on the selected beam/SSB or CSI-RS), the UE monitors a DL response indication on a serving cell (e.g., from the S-DU), wherein the reception of the DL response indication indicates to the UE that the transmitted UL signal/message was successfully received on the LTM candidate cell (e.g., on the candidate DU), and the absence of the reception of the DL response indication indicates that the UL signal/message was not successfully received on the LTM candidate cell, which triggers the UE to transmit a second UL message/preamble to the LTM candidate cell.

In one embodiment, the UE detects the preamble transmission failure for TA establishment/update at the end of a time window (whose properties are a starting point and a duration and/or an end point in time). The UE expects from a serving cell (from the S-DU) a DL response indication possibly including a TA value (or indication of a TA value, e.g., TA command), calculated by the C-DU based on the reception of the first UL message (RA preamble the UE transmits to the LTM candidate cell). When the UE receives the DL response indication (e.g., including the TA value) within the time window, the UE considers the TA establishment procedure successful. When the time window ends and the UE has not received the DL response indication (possibly including the TA value), the UE considers a preamble transmission failure for TA establishment/update. The properties of the time window may be the same as the properties of a RAR time window configured as part of the UL channel configuration for TA establishment, provided to the UE. Below is an example of how this may be implemented.

In one option, after the RA preamble is transmitted by the UE (e.g., MAC entity) to the LTM candidate cell, the UE starts the time window (e.g., DL indication response window) on the serving cell (e.g., at the first PDCCH occasion in a serving cell in which the DL response indication is expected to be received).

The time window (e.g., DL indication response window) may have been configured as part of the UL configuration for the TA establishment, e.g., as part of a RACH configuration wherein transmission of UL signal is on the LTM candidate cell and reception of the DL response indication is expected on a serving cell. The time window may comprise a parameter indicating its length of the window in number of time units (e.g., slots, frames, subframes, orthogonal frequency division multiplexing (OFDM) symbols).

The starting point of the time window may also be part of the time window configuration, e.g. n-th PDCCH occasion in a serving cell. Alternatively, the UE uses the m-th PDCCH occasion in a serving cell (no need to be configured in a message to the UE).

In any of these two cases, there may be different references for the n-th PDCCH occasions.

In one option, the UE uses as a reference the UL preamble transmission to the LTM candidate cell, i.e. after the preamble transmission, the UE starts to monitor the n-th PDCCH occasion on the serving cell (e.g., PCell or PSCell), for example, the first after preamble transmission.

In one option, the UE uses as a reference the first DL indication from the serving cell, i.e. after the reception of the first DL indication, the UE starts to monitor the n-th PDCCH occasion on the serving cell (e.g., PCell or PSCell).

In one option, the UE monitors the PDCCH of the SpCell for the DL response indication identified by the UE's C-RNTI in the SpCell/the cell group of the UE's SpCell, while the time window is running/has not ended. Different from a legacy RA procedure, the UE relies on its serving cell C-RNTI (or cell group's MAC entity C-RNTI) for the PDCCH reception of the DL response indication, because that is expected to be received on the SpCell (not identified by an RA-RNTI).

In one option, the UE considering a failed attempt of the RA preamble transmission comprises the occurrence of one or more conditions, as follows: when the configured time window for the DL response indication in response to the UL preamble transmission to the LTM candidate expires (or when that is over, the duration is over); and/or when a PDCCH transmission on a search space in the serving cell addressed to the UE's C-RNTI has not been received on the serving cell (not the cell where the preamble was transmitted).

In one option, when the UE considers a failed attempt of the RA preamble transmission, the UE performs one or more of the following steps, as disclosed in sets of embodiments of Step 6(1).

In a set of embodiments, the candidate DU does not successfully receive the first UL message/signal (e.g., a PRACH preamble). In other words, the C-DU detects that the first UL message was not successfully received. Thus, the C-DU is not able to calculate a TA value for a UE and at least one LTM candidate cell. The C-DU detects that it is not possible to calculate the TA value, and may have a cause value associated and possibly indicated to the S-DU, e.g. UL signal transmission attempt failed. There may be different options for the C-DU to determine that the first UL message/signal is not successfully detected.

In one option, the C-DU starts a timer (e.g., preamble reception timer) when it transmits to the CU and/or S-DU the UL configuration for TA establishment (e.g., Step 2(b), transmission of the UE Context Setup Response) and, when a configured RA preamble for TA establishment is not received while the preamble reception timer is running, the C-DU considers the preamble transmission attempt as failed. In other words, the preamble transmission attempt is considered as failed in the C-DU when the preamble reception timer expires. When the RA preamble is received while the preamble reception timer is running, the timer is stopped because the attempt is considered successful.

In response to a preamble transmission failure detection, the C-DU may transmit a message to the CU and/or the S-DU to indicate the preamble transmission failure detection (in one sub-option that may provide further input enabling the fallback, e.g., new SSBs and/or parameters settings for further preamble re-transmissions). That may be the same message which may possibly contain a TA value, but when that field is empty it indicates that the C-DU was not able to calculate a TA value because the RA preamble was not properly received.

In a set of embodiments, the S-DU detects that the first UL message/signal (e.g., a PRACH preamble) is not successfully received at the C-DU, e.g., by reception of a failure indication from the C-DU, the end of a time window or by the expiry of a supervision timer (which the S-DU may have started when it has transmitted to the UE the first DL indication). The RA preamble transmission attempt failure is detected when a supervision timer expires when the S-DU does not receive a message from the C-DU (e.g., via the CU) including the expected TA value, or the S-DU receives the expected message from the C-DU (e.g., via the CU) but not including the expected TA value (one advantage of that is that the S-DU may detect the failure faster, without the need to wait for the timer to expire). The S-DU may apply scheduling restrictions for the UE that is transmitting a first UL message/signal for TA establishment, i.e., the S-DU does transmit PDCCH to that UE on a serving cell, wherein the scheduling restrictions start when the first DL indication is transmitted to the UE; and, when the S-DU receives an indication of a failed attempt from the C-DU (e.g., via CU), the S-DU continues to apply scheduling restrictions for the UE.

In Step 6(2), when the UE detects the failed attempt to transmit the RA preamble for TA establishment, e.g. according to one or more conditions disclosed herein such as the expiry of the time window, the UE transmits a second UL message/signal to the LTM candidate cell for the TA establishment. That may be referred to as a fallback triggered by the UE upon detecting the failed attempt to transmit RA preamble. That may be referred to as UE assisted because it is the UE that monitors the reception of the DL response indication for determining whether the UL transmission attempt to the LTM candidate cell was successful.

In a set of embodiments, the UE transmits the second UL message/signal (e.g., in response to the expiry of the time window) and when a maximum number of UL signal (e.g., RA preamble) transmission attempts (e.g., parameter max_attemtps_TA_establishment_LTM, set by the C-DU and indicated to the UE) has not been reached. In other words, this is a pre-condition for transmitting the second DL indication. When the maximum number has been reached, the UE does not transmit the second UL message/signal, and instead the UE declares a TA establishment failure.

When the UE transmits the first UL signal/message to the LTM candidate cell, the UE initializes a counter for preamble transmission attempts as follows: PREAMBLE_TRANSMISSION_COUNTER=1. Thus, before the UE transmits the second UL signal/message (or any other UL signal/message for TA establishment after the first UL signal/message) the UE determines whether the maximum number of UL signal (e.g., RA preamble) transmission attempts has been reached. For example, the C-DU may have configured the UE with the maximum number of UL signal (e.g., RA preamble) transmission attempts to 5. Thus, when the UE verifies that PREAMBLE_TRANSMISSION_COUNTER<5, the UE transmits the second UL signal/message for TA establishment/update and increments the counter as follows PREAMBLE_TRANSMISSION_COUNTER=PREAMBLE_TRANSMISSION_COUNTER+1.

Based on the monitoring of the counter, the UE prevents an infinite amount of UL signal retransmissions/UL signal transmission attempts to an LTM candidate cell that may be out of reach by the UE, so unnecessary UL interference is prevented in the LTM candidate. This may also give the opportunity to the UE to indicate such a failure to the S-DU (or the CU), so the network may trigger the release of a candidate LTM (remove the LTM candidate at the UE and at the C-DU) that cannot be reached by the UE in the UL.

In a set of embodiments, if the UE received in the first DL signal one or more indications of LTM candidate cells (e.g., LTM candidate cell ID(s), LTM configuration IDs) the UE selects only one LTM candidate cell from the set of those configured to which to send the first UL message/signal. The UE may select the LTM candidate cell to which to send the first UL message/signal according to the order in which they are received or according to a priority indicated in the UL configuration. Also, if the selected LTM candidate cell is different from the LTM candidate cell in which the first UL signal/message has been transmitted, the UE may reset active counter or timer started or initialized upon sending the first UL signal/message and may also transmit the second UL signal/message by using the same transmission power used for the first UL signal/message (meaning no power ramping is applied).

In a set of embodiments, the UE transmits the second UL signal/message, in response to the expiry or the end of the time window (or the supervision timer, e.g., RAR like timer) but only when the maximum UL signal (RA preamble) transmission power has not been reached, after a number of transmissions by the UE.

The method comprises different solutions for the UE, in response to the expiry of the time window (or the supervision counter), on how the UE transmits the second UL signal, e.g. whether to perform power ramping for the second UL signal transmission.

In one option, the UE re-transmits the previously transmitted preamble and/or according to the previously transmitted RA resource configuration with an incremented transmission power, in comparison to the previously used transmission power for the first UL signal/message.

In one option, the UE selects a beam (e.g., SSB or CSI-RS) of the LTM candidate cell that is different than the previously selected beam (e.g., SSB or CSI-RS) of the LTM candidate cell that led to a failed attempt of RA preamble transmission.

In one option, the UE determines to either select a new beam/SSB/CSI-RS of the LTM candidate cell or perform power ramping for the UL signal/message transmission.

In one option, the UE determines whether it performs power ramping based on the RA resource selection. The UE performs power ramping when the RA resource selection leads to the UE selecting the same SSB or CSI-RS or beam of the LTM candidate cell that was selected in the failed attempt. The UE does not perform power ramping when the RA resource selection leads to the UE selecting a different SSB or CSI-RS or beam of the LTM candidate cell than selected in the failed attempt.

In Step 6(2), in a set of embodiments, the UE transmits a second UL message/signal (e.g., a second RA preamble) to the candidate cell according to: i) an incremented transmission power compared to the first transmission power (e.g., the initial RA preamble power potentially defined by a parameter/field preambleReceivedTargetPower), or ii) to a second UL resource (e.g., RA resources in time and frequency) associated to a second beam the UE selects.

In a set of embodiments, before the UE transmits a second UL message/signal, the UE performs an UL resource selection (e.g., RA resource selection based on a beam selection) for the TA establishment/update fallback, comprising one or more of the following steps.

UL resource selection may include performing or updating one or more measurements on beams and/or SSBs and/or CSI-RS resources of the LTM candidate cell for which the UE needs to perform the fallback of the TA establishment, e.g. SSB RSRP measurement(s) for one or more SSBs, such as SS-RSRP of SSB index=1, SS-RSRP of SSB index=2, . . . , SS-RSRP of SSB index=k; e.g. CSI-RS RSRP measurement(s) for one or more CSI-RS(s).

UL resource selection may include performing an UL channel resource selection based on a selected beam/SSB/CSI-RS, e.g. RACH resource selection, associated to an SSB and/or CSI-RS resource of the LTM candidate cell for which the UE needs to establish the TA. For example, the UE selects an SSB or CSI-RS resource for which a measurement is above a threshold (possibly configured in the UL configuration), e.g. SSB RSRP>rsrp-ThresholdSSB; and the UE selects an UL channel resource (e.g., time/frequency resources and preamble) for TA establishment associated to the selected SSB, wherein the association is also part of the UL configuration.

Transmitting a second UL message (e.g., a second RA preamble) to the LTM candidate cell, wherein the second UL message (e.g., second RA preamble) is transmitted to the LTM candidate cell according to: i) an incremented transmission power compared to the first transmission power, or ii) on a second UL resource (e.g., RA resources in time and frequency) associated to a second beam (e.g., SSB or CSI-RS of the LTM candidate cell) the UE selects.

In one option, when an indication of the second UL signal (e.g., RA preamble) is provided to the UE (ra-PreambleIndex by PDCCH, or other UL signal indication in the second DL indication) the UE selects the SSB signaled by the second DL indication, e.g., by PDCCH (so the UE uses the RA resource(s) mapped to that selected SSB).

In one option, the UE selects the indicated SSB when the RSRP of the indicated SSB is above the SSB threshold. This is likely the case when the UE is sending CSI reports to the S-DU for SSBs of the LTM candidate cells, so the S-DU would indicate in the DL indication and SSB that is known to the S-DU to be in good enough radio conditions.

In one option, the UE uses the indicated RA preamble for the second UL signal/message transmission (e.g., by setting the PREAMBLE_INDEX to the signaled preamble). In one option, the UE sets a variable for the preamble transmission to the signaled preamble, e.g. set the variable PREAMBLE_INDEX to the signaled ra-PreambleIndex.

In one option, the UE selects an SSB with SS-RSRP (as defined in TS 38.215) above rsrp-ThresholdSSB amongst the associated SSBs. In one option, the UE sets the PREAMBLE_INDEX to a ra-PreambleIndex corresponding to the selected SSB.

In one option, the UE selects the CSI-RS signaled e.g. by PDCCH. In one option, the UE selects a CSI-RS resource with CSI-RSRP (as defined in TS 38.215) above rsrp-ThresholdCSI-RS amongst the associated CSI-RSs. In one option, the UE sets the PREAMBLE_INDEX to a ra-PreambleIndex corresponding to the selected CSI-RS.

In one option, the UE selects an SSB and when an SSB is selected, the UE determines the next available PRACH occasion from the PRACH occasions corresponding to the selected SSB permitted by the restrictions given by a configuration (e.g., the ra-ssb-OccasionMaskIndex, part of the UL configuration for TA establishment) if configured or indicated by PDCCH (the MAC entity at the UE selects select a PRACH occasion randomly with equal probability amongst the consecutive PRACH occasions, corresponding to the selected SSB).

In one option, the UE (e.g., the MAC entity at the UE) accounts for the possible occurrence of measurement gaps when determining the next available PRACH occasion corresponding to the selected SSB.

In one option, the UE selects a CSI-RS and determines the next available PRACH occasion from the PRACH occasions in a configured RA occasion list/set (e.g., ra-OccasionList) corresponding to the selected CSI-RS. The UE (e.g., the MAC entity at the UE) selects a PRACH occasion randomly with equal probability amongst the PRACH occasions occurring simultaneously but on different subcarriers, corresponding to the selected CSI-RS.

In one option, the UE (e.g., the MAC entity at the UE) accounts for the possible occurrence of measurement gaps when determining the next available PRACH occasion corresponding to the selected CSI-RS.

In one option, when the UE determines if there is an SSB with SS-RSRP above rsrp-ThresholdSSB or a CSI-RS with CSI-RSRP above rsrp-ThresholdCSI-RS, the UE uses the latest unfiltered L1-RSRP measurement.

In one option, the UE maintains a counter for preamble transmissions (e.g., PREAMBLE_TRANSMISSION_COUNTER), i.e. the UE starts the counter with value set to 1 when the first UL signal/message is transmitted and increments the counter when a new preamble is transmitted for the same TA establishment procedure.

In a set of embodiments, the UE transmits a second UL message/signal for the TA establishment/update fallback with a power ramping step compared to the first transmission power transmit when the selected beam (e.g., SSB or CSI-RS) is the same beam the UE has selected during resource selection for the transmission of the first UL message/signal.

In one option, the UE sets the transmission power for the second UL message/signal (PREAMBLE_RECEIVED_TARGET_POWER(2)) to be an incremented power compared to the first transmission power, wherein the transmission power for the second UL message/signal is set by adding up one or more of: a value provided in the UL configuration (e.g., preambleReceivedTargetPower); a delta value which depends on the RA preamble format (e.g., 0 dB for preamble format 0), e.g. DELTA_PREAMBLE; a value indicated in the LTM configuration for the LTM candidate cell; and/or an increment step based on a preamble power ramping step (e.g., PREAMBLE_POWER_RAMPING_STEP) and a preamble power ramping counter (e.g., PREAMBLE_POWER_RAMPING_COUNTER). For example: Increment step=(PREAMBLE_POWER_RAMPING_COUNTER−1)×PREAMBLE_POWER_RAMPING_STEP, so that the transmission power may be, for example, set as: PREAMBLE_RECEIVED_TARGET_POWER=preambleReceivedTargetPower+DELTA_PREAMBLE+Increment step; á PREAMBLE_RECEIVED_TARGET_POWER to preambleReceivedTargetPower+DELTA_PREAMBLE+(PREAMBLE_POWER_RAMPING_COUNTER−1)×PREAMBLE_POWER_RAMPING_STEP.

In one option, the UE monitors the power ramping counter (e.g., PREAMBLE_POWER_RAMPING_COUNTER). The power ramping counter is incremented by 1 when a RA preamble is transmitted/re-transmitted as part of the same TA establishment/update procedure. The power ramping counter has a maximum value associated to it, and the UE may be configured with that maximum value as part of the UL channel configuration.

In one option, the UE is configured with a PREAMBLE_POWER_RAMPING_STEP, e.g., received in the RRC Reconfiguration including the LTM configuration, and/or as part of the UL channel configuration.

In one option, the UE receives in a DL indication (e.g., second DL indication that triggers the RA preamble transmission for TA establishment) an indication of a PREAMBLE_POWER_RAMPING_STEP, e.g., a pointer to a value.

In a set of embodiments, the UE transmits a second UL message/signal for the TA establishment/update to an LTM candidate cell and, when the UE receives a DL response indication from a serving cell (e.g., from the S-DU), the UE considers the TA establishment procedure successful.

In a set of embodiments, the UE transmits an n-th UL message/signal for the TA establishment/update to an LTM candidate cell and, when the UE receives the n-th DL response indication from a serving cell (e.g., from the S-DU), the UE considers the TA establishment procedure successful. The term n-th DL response indication refers to the fact that this is a response to the n-th preamble transmission, not an n-th response the UE receives. Based on that the UE performs one or more actions, such as the reset of at least one counter (set them to zero) and the stopping of at least one timer associated to the TA establishment procedure.

In a set of embodiments, the UE further transmits a third UL message (e.g., a third RA preamble) to the candidate cell, when the time window started when the UE transmits the second UL signal/message expires, wherein the third UL message (e.g., third RA preamble) transmitted to the candidate cell is transmitted according to: i) an incremented transmission power compared to the second transmission power, or ii) to a third UL resource (e.g., RA resources in time and frequency) associated to a third beam the UE selects.

Some embodiments include fallback repetition. In a set of embodiments, the UE-assisted fallback for TA establishment is repeated until one or more conditions are fulfilled. The fallback for TA establishment comprises the UE transmitting an n-th UL signal/message and not receiving in response an n-th DL response indication while a time window (or supervision timer) is running (which is evidence that there has been a failure in the n-th UL signal/message transmission attempt). In response, the UE transmits an (n+1)-th UL message, either with an increased an incremented transmission power compared to the transmission power of the n-th UL message transmission, or indicating that the transmission of an (n+1)-th UL message is to be towards an (n+1)-th UL resource (e.g., RA resources in time and frequency) associated to an (n+1)-th beam the UE selects.

The one or more conditions may correspond to: the UE detects the success of the preamble transmission for TA establishment/update; and/or the UE detects that a number of preamble transmission failure for TA establishment/update reaches a maximum value, for a given LTM candidate cell and/or UE.

In one option, the maximum value may have been configured by the candidate DU responsible for the LTM candidate cell, which is the C-DU that has configured the UL resources for the TA establishment and/or TA updating.

In one option, the UE increments a counter each time the UE detects a preamble transmission failure for TA establishment/update (e.g., based on one or more of the solutions proposed above), e.g., by the expiry of the time window. The UE, before transmitting an UL signal/message to the LTM candidate for TA establishment, checks if the counter reached the maximum value. When the UE determines the counter has reached the maximum value, the UE does not transmit the UL signal/message to the LTM candidate cell and considers the TA establishment as failure, referred to as a TA establishment failure.

In other words, when the number of preamble transmission failure for TA establishment reaches its maximum value, the UE declares a TA establishment failure.

In one option, the maximum value for the number of preamble transmission failures for TA establishment may have been configured by the candidate DU responsible at the UE for the LTM candidate cell, which is the C-DU th that has configured the UL resources for the TA establishment and/or TA updating.

The UE detects that a maximum transmission power for the UE to transmit the UL message to the LTM candidate cell has been reached. The maximum value may be reached after a number of transmission power increments, after preamble transmission failures for TA establishment.

In one option, the maximum transmission power for TA establishment may have been configured by the candidate DU responsible for the LTM candidate cell, which is the C-DU that has configured the UL resources for the TA establishment and/or TA updating.

In a set of embodiments, the candidate DU successfully receives the first UL message/signal (e.g., a PRACH preamble) and is able to calculate a TA value for a UE and at least one LTM candidate cell. The candidate DU transmits a message to the CU including the at least one TA value (or an indication of a TA value, like in a TA command MAC CE).

In one embodiment, the candidate DU transmits the message to the CU comprising a timing advance value (or an indication of a timing advance value) and one or more associated LTM candidate cell(s), for which the timing advance value is applicable. Thus, the CU (and possibly the Serving DU, also receiving that information) know that a given timing advance value is applicable to one or more LTM candidate cell(s) the UE is configured with, which may be needed during LTM execution (also referred to as LTM cell switch) to one of the candidate cells.

In one embodiment, the candidate DU transmits the message to the CU using a UE signaling connection, so that the CU is aware that a TA value (or indication of a TA value) associated to a target candidate cell corresponds to the UE for the UE signaling connection.

In one embodiment, when the candidate DU transmits the message to the CU the candidate DU starts a timer (may be referred to as a time alignment timer—TA timer at the C-DU), and while the timer is running the candidate DU considers the TA value that it has provided to the CU as “valid,” which means that while the timer is running the candidate DU may receive that incoming UE with LTM without random access, because TA is valid, assuming that TA value is provided to the UE via CU and/or serving DU. When the TA timer expires the candidate DU considers the TA value as “not valid,” and when the TA value is not valid, the candidate DU may trigger a TA update procedure (e.g., C-DU initiated TA update).

In one embodiment, the CU receives the message including the TA value (or an indication of the TA timer) associated to an LTM candidate cell and a UE configured for LTM and the CU starts a time alignment timer. While the TA timer is running, the CU considers the TA value as “valid,” when the TA timer expires, the CU considers the TA value as “not valid.” When the TA value is not valid, the CU may trigger an TA update procedure.

In one option, the candidate DU further includes in the message to the CU the TA timer value associated to a TA value (applicable for at least one target candidate cell), wherein the TA value is considered “valid” while the TA timer is running, and not valid when the TA timer expires. In that case, it may be an option that the candidate DU also starts a TA timer with the same or similar value, so that the C-DU may also be aware when the TA value is not valid for that UE and the LTM candidate cell.

In one embodiment, the first UL signal and/or RA resource may have been configured for a specific UE (e.g., per UE resource, contention-free preamble and/or PRACH resources for TA establishment), so that at the reception the candidate DU knows to which UE this is associated, and consequently to which CU this is associated, because for that UE there is a UE-signaling connection (as that is a UE for which the candidate DU has accepted the request for configuring LTM). The candidate DU, based on the reception of the first UL signal/message, calculates the TA value for the UE and the target candidate cell, and transmits the TA value to the serving DU (via the CU), to be used by the UE in the LTM execution (i.e., the LTM cell switch, at a later moment).

In one set of embodiments, the CU transmits a message to the serving DU in which the UE is connected, including the at least one TA value (or an indication of the TA value, like the indication in a TA command MAC CE as defined in TS 38.321). As in Step (7a), the candidate DU receives the second UL signal (e.g., a PRACH preamble) in an UL channel (PRACH time/frequency resource slot) allocated for the purpose of TA establishment for LTM, calculates a TA value, valid for a UE and at least one LTM candidate cell, and the candidate DU transmits a message to the CU comprising the at least one TA value (or an indication of the TA value), so that the CU transmits to the serving DU.

In one embodiment, the serving DU receives the message from the CU comprising a TA value (or indication of the TA value) and one or more indication(s) of associated LTM candidate cell(s) for which the TA value is applicable. Thus, the serving DU knows that a given TA value is applicable to one or more LTM candidate cell(s) the UE is configured with, which may be needed during LTM execution (LTM cell switch) to one of these candidate cells.

In one embodiment, the serving DU receives the message from the CU in a UE signaling connection, so that the serving DU is aware that a TA value associated to an LTM candidate cell corresponds to the UE for that UE signaling connection.

In one embodiment, the serving DU receives the message including the TA value (or indication of a TA value) associated to an LTM candidate cell and a UE configured for LTM and the serving DU starts a timer (may be referred to as time alignment timer). While the TA timer is running the serving DU considers the TA value as “valid”; when the TA timer expires the serving DU considers the TA value as “not valid”. When the TA value is not valid, the Serving DU may trigger an TA update procedure.

In one option the serving DU receives in the message from the CU the TA timer value associated to a TA value (applicable for at least one target candidate cell), wherein the TA value is considered “valid” while the TA timer is running, and not valid when the TA timer expires. In that case, it may be an option that the candidate DU and/or the CU also starts a TA timer with the same or similar value, so that it may also be aware when the TA value is not valid for that UE and the LTM candidate cell.

In the following steps, the S-DU is responsible for managing the validity of the TA value. In other words, the S-DU monitors a TA timer and verifies whether the UE is able to perform LTM cell switch to the LTM candidate cell without random access.

In a set of embodiments, the UE receives on a serving cell (from the S-DU) a DL response indication in response to the UL signal/message transmission to the LTM candidate cell. The DL response is received within the time window (or while the time window is running, or while the supervision time monitored at the UE is running) and based on that the UE considers the TA establishment procedure successful.

In a set of embodiments, the UE may transmit measurements to assist the serving DU and/or the candidate DU and/or the CU to trigger the LTM execution (LTM cell switch), e.g., including CSI measurements for an LTM candidate cell for which the UE has triggered the establishment of the TA.

Potentially in response to the reported measurements (L1 RSRP) for a given LTM candidate cell, the network (e.g., the serving DU) determines to trigger LTM cell switch for the UE to the LTM candidate cell for which the UE has triggered the establishment of the TA.

In one embodiment, the serving DU performs one or more of the following actions.

If the LTM candidate cell (e.g., cell X) for which the serving DU determines to trigger LTM execution (cell switch) is a cell for which the serving DU has a valid TA value (e.g., TA timer is running) for the UE and that LTM candidate cell, the serving DU transmits to the UE a lower layer signaling (e.g., MAC CE) indicating that LTM candidate cell and includes the TA value to be applied by the UE for communication with the LTM candidate cell (which becomes the target cell). If the LTM candidate cell (e.g., cell X) for which the serving DU determines to trigger LTM execution (LTM cell switch) is a cell for which the serving DU does not have a valid TA value (e.g., TA timer has expired) for the UE and that target candidate cell, the serving DU transmits to the UE a lower layer signaling (e.g., MAC CE) indicating that the LTM candidate cell and not including a TA value.

In one embodiment, the serving DU performs one or more of the following actions.

If the TA timer is running, the network (e.g., serving DU) transmits to the UE a lower layer signaling (e.g., MAC CE) indicating the LTM candidate cell and includes the TA value. If the TA timer has expired or stopped, the network (e.g., serving DU) transmits to the UE a lower layer signaling (e.g., MAC CE) indicating the LTM candidate cell for L1/L2 inter-cell mobility that does not include a TA value.

In one embodiment, the serving DU performs one or more of the following actions. If the LTM candidate cell (e.g., cell X) for which the serving DU LTM execution (LTM cell switch) is a cell for which the serving DU has a valid TA value (e.g., TA timer is running) for the UE and that LTM candidate cell which is the same as the TA value for a serving cell the UE is configured with, the serving DU transmits to the UE a lower layer signaling (e.g., MAC CE) indicating that LTM candidate cell and includes that TA value for that serving cell the UE is configured with, to be applied by the UE for communication with the LTM candidate cell. Another alternative is that instead of providing the TA value, the serving DU provides a serving cell index, indicating to the UE that the UE shall use the TA value between the UE and the serving cell whose index has been indicated as the TA value for the UE and the LTM candidate cell, also indicated in the lower layer signaling.

The UE receives the lower layer signaling (e.g., MAC CE) indicating that LTM candidate cell. If the signaling includes the TA value (or an indication of the TA value), the UE applies that TA value for the LTM candidate cell (for UL transmissions). If the signaling does not include the TA value or the indicated LTM candidate cell is a cell for which TA is the same as a serving cell (and the UE is aware of that based on the LTM candidate configuration), the UE applies that TA value of the associated serving cell for that LTM candidate cell (for UL transmissions). If the signaling does not include the TA value or the indicated LTM candidate cell is a cell for which TA has not been established, the UE performs random access to the LTM candidate cell indicated. If the signaling includes a serving cell index, the UE uses the TA value between the UE and the serving cell whose index has been indicated as the TA value for the UE and the LTM candidate cell, also indicated in the lower layer signaling.

The UE transmits an UL message to the target candidate (e.g., over PUCCH and/or PUSCH) after having applied the indicated TA value for the LTM candidate cell according to the method.

In alternative steps, the UE is responsible for managing the validity of the TA value. In other words, the UE receives a TA value (or an indication of a TA value), e.g., in or with the DL response indication, and starts a TA timer, and while the TA timer is running, the UE considers itself to be time aligned with the associated LTM candidate cell.

When the UE further receives the LTM cell switch command indicating the LTM candidate cell, and the TA timer is running for that LTM candidate cell, the UE performs the cell switch to the LTM candidate cell without a RA procedure, e.g. the UE transmits UL information over PUSCH or PUCCH.

When the UE further receives the LTM cell switch command indicating the LTM candidate cell, and the TA timer has expired for that LTM candidate cell, the UE performs the cell switch to the LTM candidate cell with a RA procedure, e.g. the UE transmits an UL preamble to a PRACH resource of the LTM candidate cell.

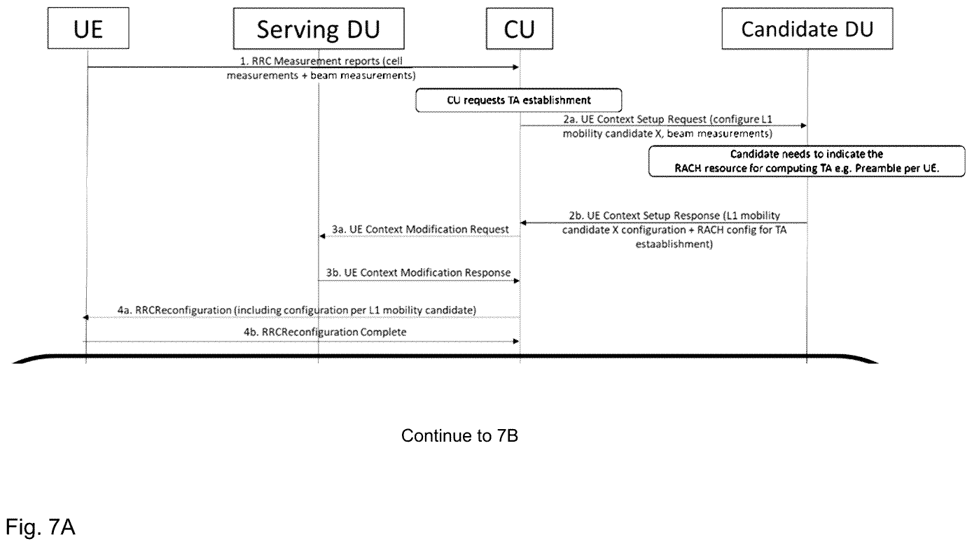

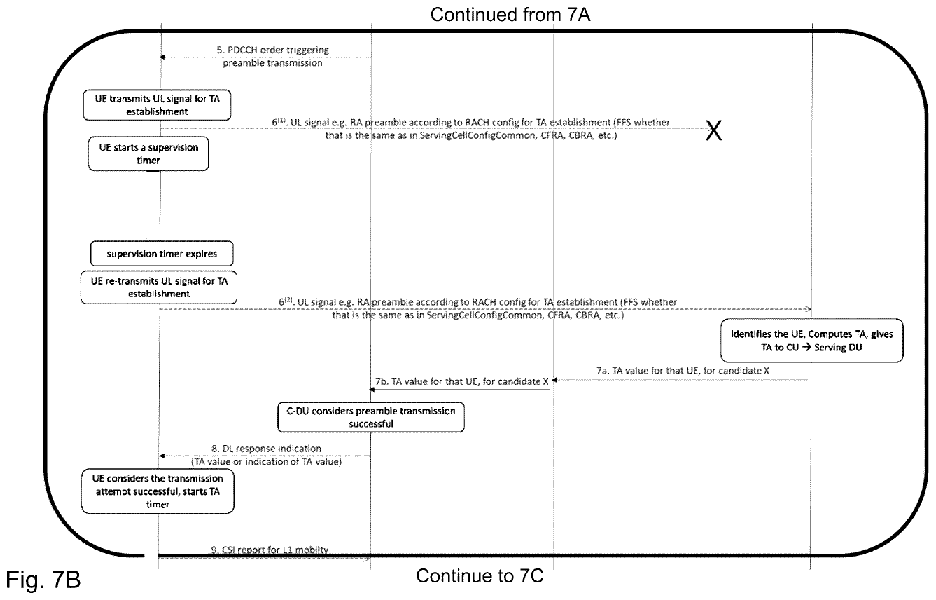

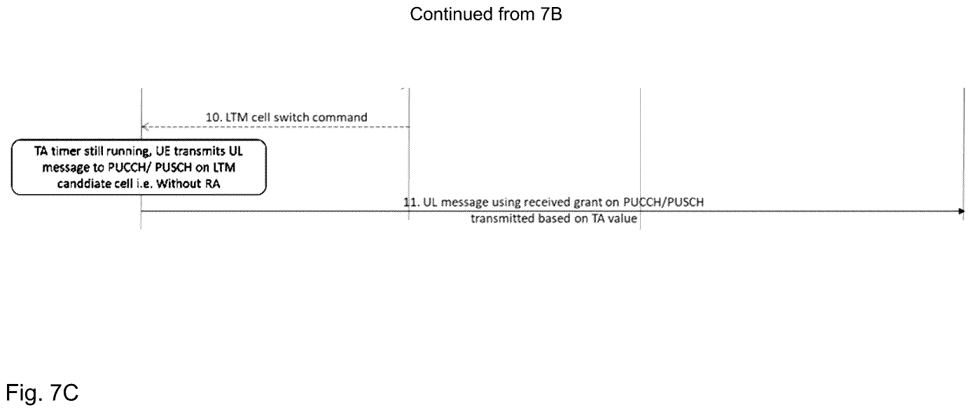

FIGS. 7A, 7B and 7C is a flow diagram illustrating UE assisted fallback with TA management at the UE side, according to particular embodiments. Some embodiments include UE-assisted fallback for TA update for LTM. In a set of embodiments, one or more steps disclosed with respect to TA establishment fallback may be performed in the case of a TA update, i.e. when the TA value is not valid for the UE and an LTM candidate and the network and/or the UE determines to calculate a new TA value.

According to particular embodiments, the TA updates may be trigger by: i) the CU; ii) the S-DU; iii) the C-DU; and/or iv) the UE. That may depend on which of these are managing the validity of the TA value which has been previously calculated by the C-DU and provided to the S-DU.

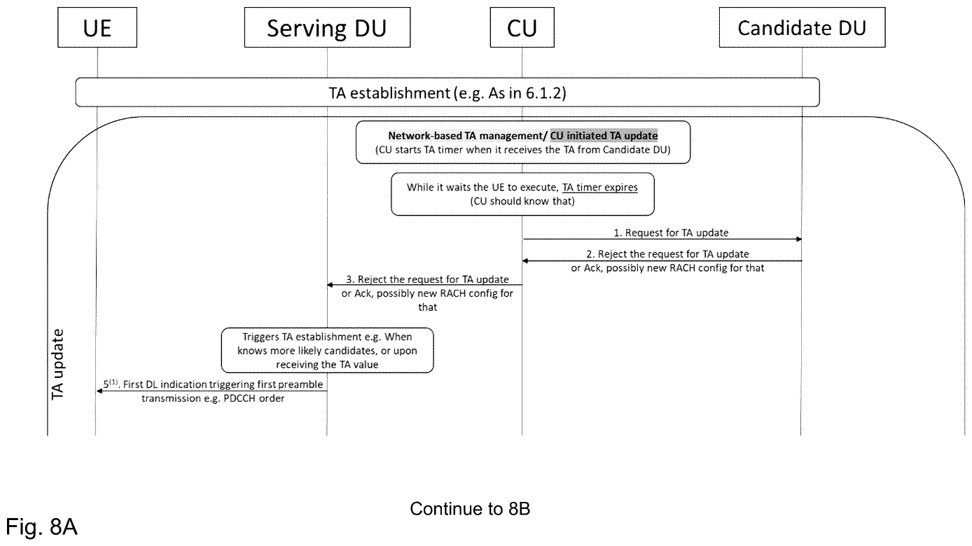

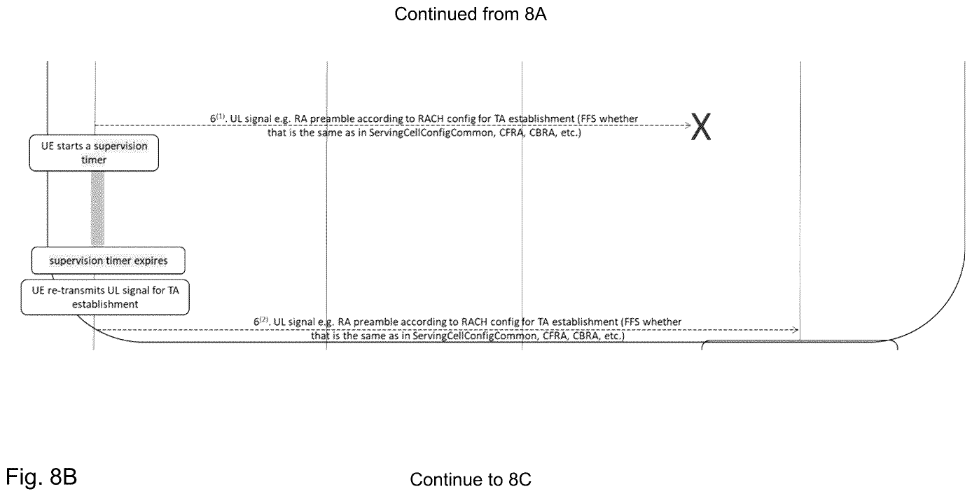

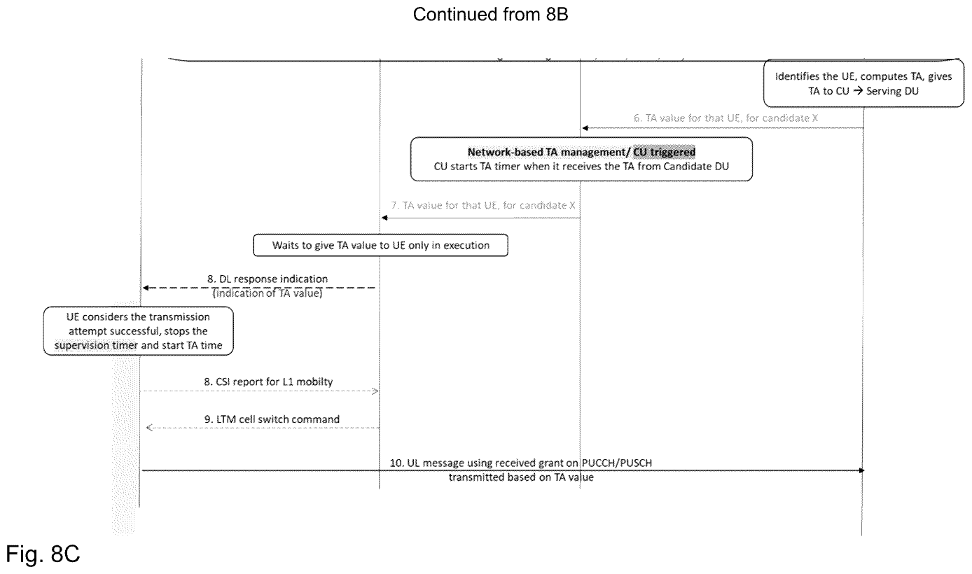

In a set of embodiments, the TA establishment between a UE and an LTM candidate is performed, and the CU determines that the TA value is not valid, e.g., upon expiry of a TA timer value. That TA timer may have been started when the TA value was provided to the CU and/or the S-DU. When the CU detects that the TA value is not valid (which may be equivalent to determining that the UE has lost synchronization in the UL with the LTM candidate cell) the CU sends a request for TA update to the C-DU (response for the LTM candidate cell for which the UE has lost UL synchronization, e.g., for which the TA timer has expired). In response the C-DU may reject or accept (ACK) the request, potentially with anew UL channel configuration for UL transmissions (e.g., RACH config) for the UE, because the previously provided configuration(s) may contain one or more parameters which are not valid. The CU transmits an indication of reject or acceptance (ACK) to the S-DU which triggers the TA establishment/update to the UE, e.g., by transmitting a first DL indication. From that point the steps for monitoring the failed transmission attempts for the first UL message by the UE are similar to the steps disclosed above and as shown in FIGS. 8A, 8B and 8C.

FIGS. 8A, 8B and 8C are a flow diagram illustrating a fallback procedure for the UE-assisted TA update procedure for a CU initiated TA update and a network-based TA management, according to some embodiments. FIGS. 8A, 8B and 8C consider a case where the CU may trigger the update of the TA even if the monitoring of a TA time may also be ongoing at the UE.

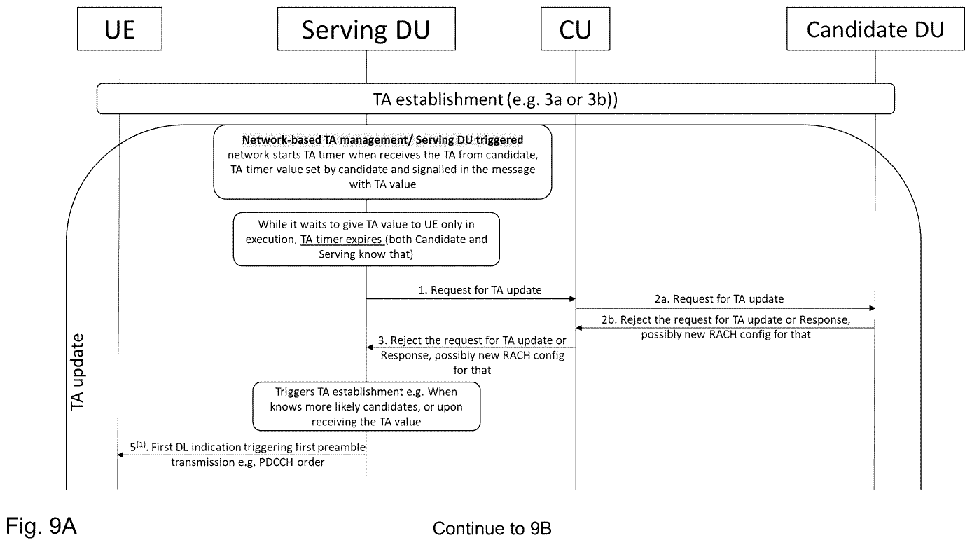

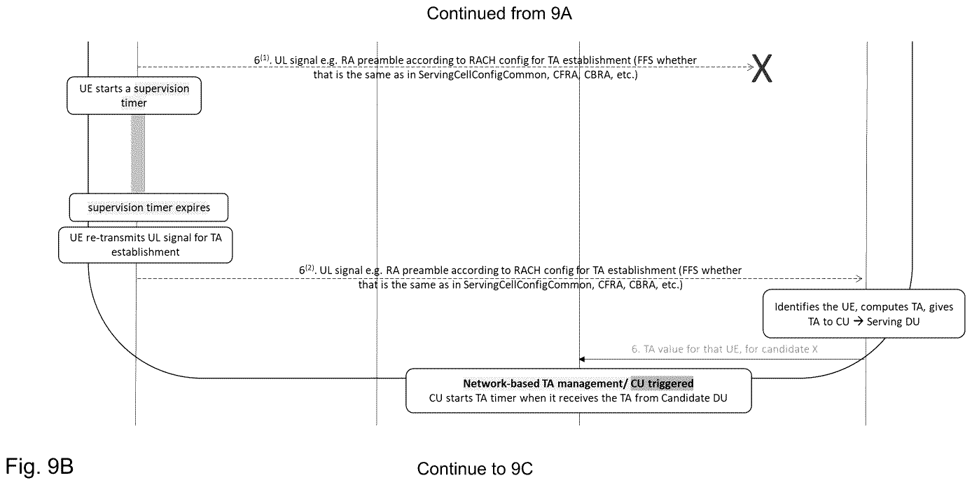

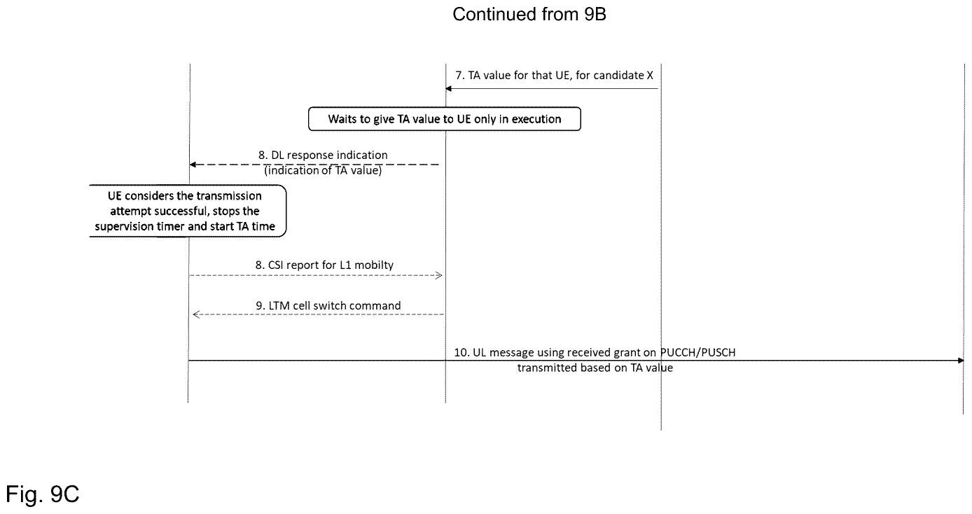

In a set of embodiments, the TA establishment between a UE and an LTM candidate is performed, and the S-DU determines that the TA value is not valid, e.g., upon expiry of a TA timer value. The TA timer may have been started when the TA value was provided to the S-DU, e.g., from the C-DU upon reception of an UL signal from the UE in a TA establishment procedure. When the S-DU detects that the TA value is not valid (which may be equivalent to determining that the UE has lost synchronization in the UL with the LTM candidate cell) the S-DU sends a request for TA update to the CU, which transmits the request to the C-DU (wherein the C-DU is responsible for the LTM candidate cell for which the UE has lost UL synchronization, e.g. for which the TA timer has expired). In response, the C-DU may reject or accept (ACK) the request, potentially with a new UL channel configuration for UL transmissions (e.g., RACH config) for the UE, because the previously provided configuration(s) may contain one or more parameters which are not valid. The CU transmits an indication of reject or acceptance (ACK) to the S-DU which triggers the TA establishment/update to the UE, e.g., by transmitting a first DL indication. From that point the procedure for monitoring the failed transmission attempts for the first UL message is similar to the steps disclosed above, as shown in FIGS. 9A, 9B and 9C.

FIGS. 9A, 9B and 9C are a flowchart illustrating UE-assisted fallback procedure for the TA update procedure for an S-DU initiate TA update and a network-based TA management, according to particular embodiments. FIGS. 9A, 9B and 9C consider a case where the CU may trigger the update of the TA even if the monitoring of a TA time may also be ongoing at the UE.

Some embodiments include UE actions upon detecting a TA establishment failure. In a set of embodiments, the UE detects a TA establishment failure (e.g., when the maximum number of RA preamble transmission attempts for TA establishment is reached) and reports that to the network (e.g., S-DU, CU), so the network (e.g., S-DU, CU) may take one or more of the following further actions.

In some embodiments, the CU cancels the TA establishment for LTM towards the C-DU for the LTM candidate cell in which the UE has attempted to establish or update the TA and has failed. In one option, the CU transmits a UE Context Modification Request to the C-DU for canceling the TA establishment. In response, the C-DU releases and/or cancels one or more UL resources reserved for the TA establishment/update procedure.

In some embodiments, the CU cancels the TA establishment at the UE, e.g., by generating and transmitting to the UE an RRC Reconfiguration message removing/releasing/canceling/deactivating one or more configuration(s) for the TA establishment/update for the LTM candidate cell.

In one option, as the UE transmits reports the TA establishment failure to the network, the UE cancels the TA establishment, which may comprise the UE removing/releasing/canceling/deactivating one or more configuration(s) for the TA establishment/update for the LTM candidate cell.

In some embodiments, the CU cancels LTM towards the C-DU for the LTM candidate cell in which the UE has attempted to establish TA and has failed.

In some embodiments, the CU provides to the C-DU (or to another network node, e.g. operation and maintenance (OAM) information related to the TA establishment failure, e.g. measurements on beams (e.g., SSBs and/or CSI-RS) of the LTM candidate cell in which the UE has attempted to establish TA and has failed and/or beams which were not selected by the UE for TA establishment.

In a set of embodiments, the UE monitors the TA establishment failure. The UE detects that a maximum number of RA preamble transmission(s) have been reached and, upon detecting the failure the UE releases one or more TA establishment resources, such as the UL configuration for TA establishment/updates.

In a set of embodiments, it is the UE's MAC entity (e.g., the MAC entity for the TA establishment with the LTM candidate cell) that detects the TA establishment/update failure, e.g., if it is the MAC entity monitoring that the UE has reached the maximum number of preamble transmission attempts without having received the DL response indication. In this case, a MAC entity of the UE indicates TA establishment failure to the higher layers, e.g. RRC layer, wherein it is at the higher layers that one or more further actions are triggered.

When the UE detects a TA establishment failure, the UE may perform one or more of the following actions.

The UE may transmit an indication to a serving cell (e.g., to the S-DU) indicating the TA establishment failure, possibly including one or more information associated to the failure such as: indication(s) of preambles transmitted (e.g., one or more preamble indexes or indications of these); indication(s) of selected SSB(s) and/or CSI-RS(s); and/or indication(s) of the LTM candidate cell for which the TA establishment has failed. This may be especially relevant when the UE may have tried to establish TA with more than one LTM candidate cell. The indication may be a cell identity, an LTM configuration identity, an LTM candidate cell group identity, etc.

The indication may include one or more radio measurements for the LTM candidates such as SSB RSRP, SSB RSRQ, CSI-RS RSRP, CSI-RS RSRQ. One benefit in indicating radio measurements on the LTM candidate cell is to indicate to the network whether there are good enough candidates for TA establishment.

In one option, the measurements are L3 measurements, i.e., performed according to an RRC MeasConfig.

In one option, the measurements are L1 or L2 measurements, i.e. performed according to an LTM MeasConfig, e.g. a CSI-MeasConfig indicating measurements on LTM candidate cells.

In one option, the measurements are included when available. In other words, the UE first checks if measurements are available, and if they are, the UE includes them with the indication of TA establishment failure.

Some embodiments include one or more radio measurements for cells which are not LTM candidates, e.g. L3 measurement such as RSRP and/or RSRQ, but are on the same frequency (e.g., SSB frequency) as the LTM candidate(s). One benefit of indicating radio measurements on non-LTM candidate cell(s), but on the same frequency is to indicate to the network whether there may be other good candidates for LTM and, consequently, for TA establishment.

In one option, only the best cells are reported, e.g., the one with strongest RSRP, RSRQ, SINR, etc. This may be seen as the reporting of best neighbors in the LTM candidate cell frequency(ies) when the UE detects a TA establishment failure.

The TA establishment failure indication may be a cause value, or another IE, parameter or field, in an RRC message transmitted by the UE to the network. The TA establishment failure indication may be included in an SCG Failure information message (even if this is not really an SCG failure). The TA establishment failure indication may be included in a UE assistance information message.

In one option, the UE is configured to transmit the message including the indication about the TA establishment failure when it occurs. The indication may be included in a Failure Information message. Because the message may be triggered due to various types of failure, the UE sets a failure type in the message to indicate this is a TA establishment failure.

The UE may stop timers associated to the TA establishment. The UE may reset counters associated to the TA establishment. The UE may release one or more UL resources of the LTM candidate cell associated to the TA establishment, e.g. UL preambles. The UE may log TA establishment failure information.

In one set of embodiments, the MAC entity at the UE detects a TA establishment failure and indicates to the higher layers, e.g. RRC, so further actions may be triggered by higher layers (e.g., transmission of a Failure Information message, as defined in TS 38.331).

In one set of embodiments, the UE performs in response to the detection of a TA establishment failure in RRC (e.g., transmission of a Failure Information message, as defined in TS 38.331), in response to an indication from lower layer (e.g., MAC entity detects the TA establishment failure and indicates to higher layers).

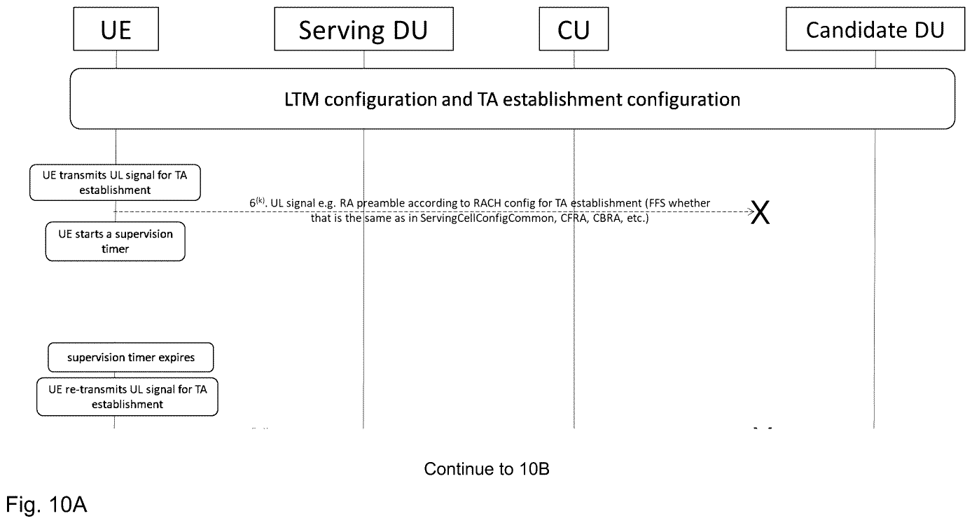

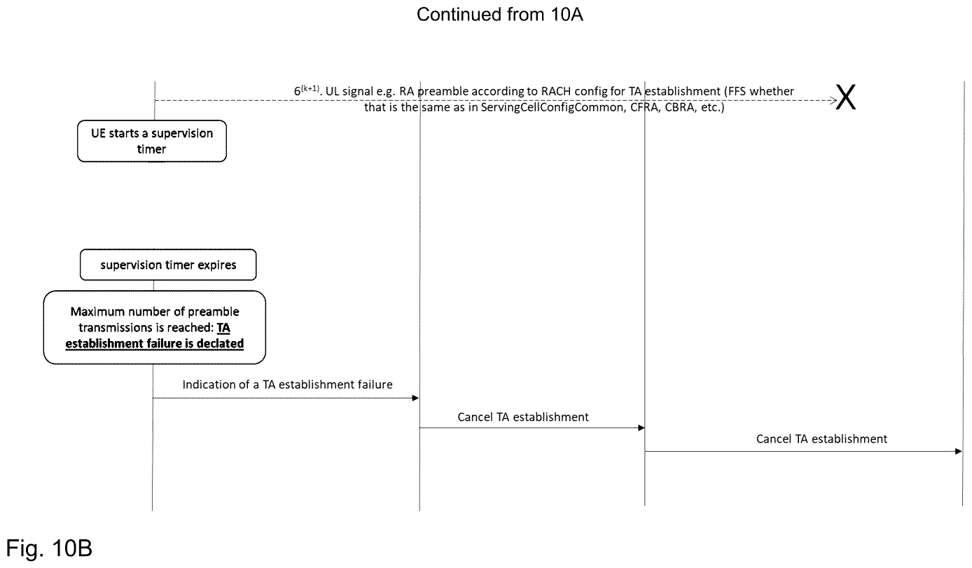

In one set of embodiments the UE performs, in response to receiving an indication to perform an LTM cell switch procedure for an LTM candidate cell for which the UE has detected a TA establishment failure, an LTM cell switch procedure that includes performing a random access procedure in the target cell of the cell switch procedure. In an example, when the UE receives an indication to not perform a random access procedure in the LTM candidate cell of the LTM cell switch procedure, the UE does not perform the random access procedure there even when the TA establishment procedure was declared as failed. An example is illustrated in FIGS. 10A and 10B.

FIGS. 10A and 10B are a flow diagram illustrating an example of actions at the S-DU upon detecting a TA establishment failure, according to particular embodiments.

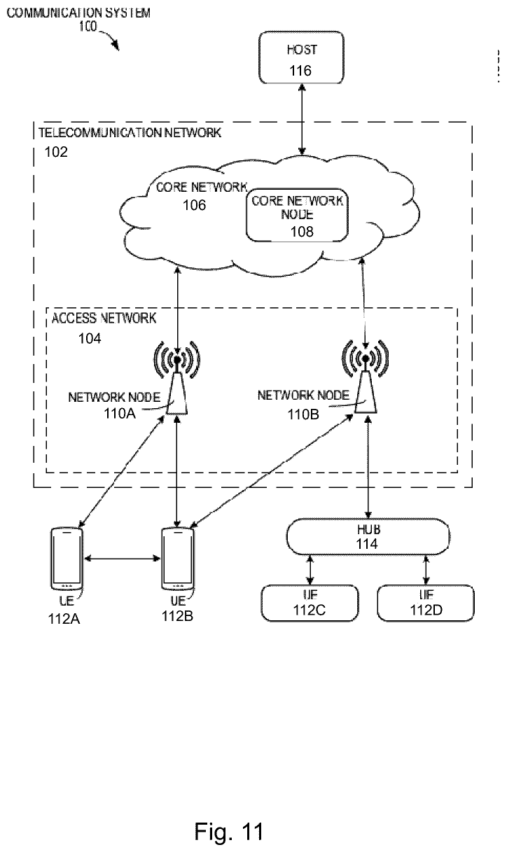

FIG. 11 illustrates an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of 1 FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

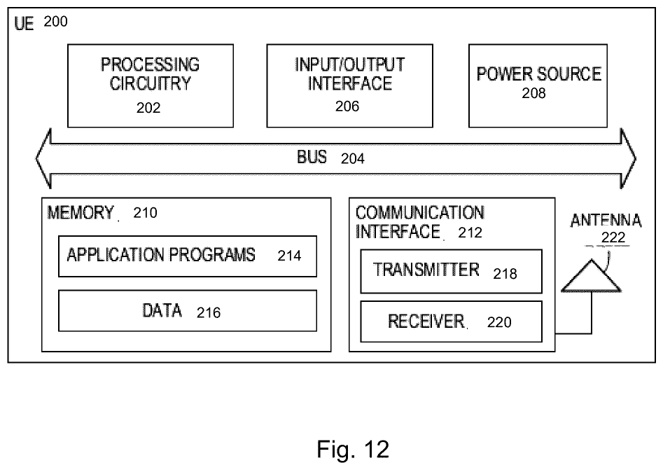

FIG. 12 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

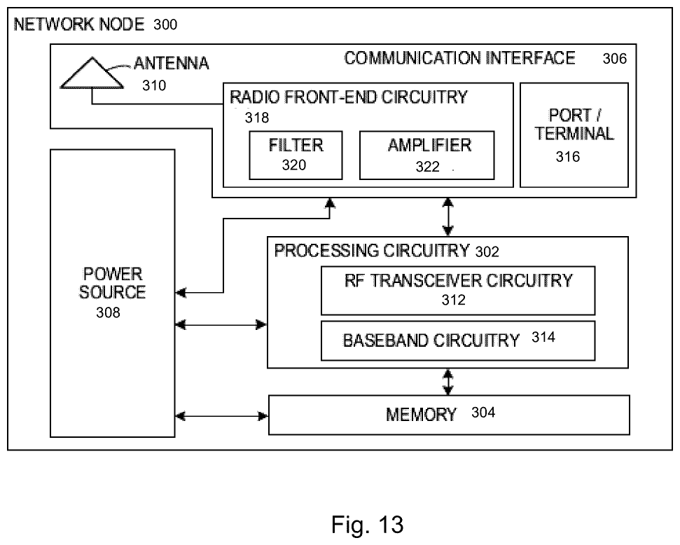

FIG. 13 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 13 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

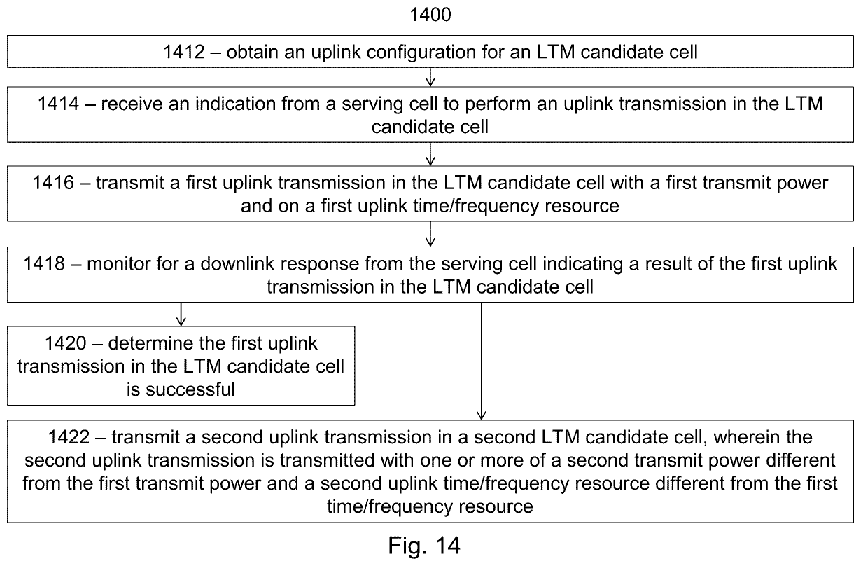

FIG. 14 is a flowchart illustrating an example method in a wireless device, according to certain embodiments. In particular embodiments, one or more steps of FIG. 14 may be performed by user equipment 200 described with respect to FIG. 12. The wireless device is capable of LTM.

The method begins at step 1412, where the wireless device (e.g., UE 200) obtains an uplink configuration for an LTM candidate cell. For example, the wireless device may obtain the uplink configuration for the LTM candidate cell via RRC. Examples of uplink configurations for LTM candidate cells are described in more detail with respect to the embodiments and examples described above.

At step 1414, the wireless device receives an indication (e.g., PDCCH order, RRC message, MAC CE, etc.) from a serving cell to perform an uplink transmission in the LTM candidate cell.

In particular embodiments, the uplink configuration for the uplink candidate cell comprises one or more random access parameters and the indication comprises an indication of which of the one or more random access parameters to use for the first uplink transmission.

In particular embodiments, the indication comprises an indication of a SSB associated with the first uplink transmission.

In particular embodiments, the uplink configuration for the uplink candidate cell comprises more than one uplink configuration for more than one uplink candidate cell and the indication comprises an indication of which uplink candidate cell in which to transmit the first uplink transmission.

Examples of the indication are described in more detail with respect to the embodiments and examples described above.

At step 1416, the wireless device transmits a first uplink transmission (e.g., random access preamble) in the LTM candidate cell with a first transmit power and on a first uplink time/frequency resource. The wireless device does not expect a response (e.g., RAR) to the first uplink transmission.

In some embodiments, the wireless device selects a first beam, and based on the selected first beam, the UE selects a first uplink resource associated to the first beam for transmitting the first uplink message.

Examples of transmitting the uplink transmission are described in more detail with respect to the embodiments and examples described above.

The first uplink transmission may not have been received by the LTM candidate cell, or the LTM candidate cell may not have been able to calculate a timing advance for the wireless device, for example. To determine whether the first uplink transmission was successful, the method continues to step 1418.

At step 1418, the wireless device monitors for a downlink response from the serving cell indicating a result of the first uplink transmission in the LTM candidate cell. Examples of monitoring for the downlink response are described in more detail with respect to the embodiments and examples described above.

When the downlink response is received from the serving cell within a preconfigured threshold time, the method continues to step 1420, where the wireless device determines the first uplink transmission in the LTM candidate cell is successful. Examples of threshold times (e.g., time windows, etc.) are described in more detail with respect to the embodiments and examples described above.

In particular embodiments, the downlink response received from the serving cell comprises a timing advance value for use in a LTM candidate cell.

When the downlink response is not received from the serving cell within the preconfigured threshold time, the first uplink transmission in the LTM candidate cell is determined to be unsuccessful and the method continues to step 1422, where the wireless device transmits a second uplink transmission (e.g., RA preamble) in a second LTM candidate cell. The second uplink transmission is transmitted with one or more of a second transmit power different from the first transmit power and a second uplink time/frequency resource different from the first time/frequency resource.

In particular embodiments, the second LTM candidate cell is the same cell as the first LTM candidate cell or the second LTM candidate cell is a different cell than the first LTM candidate cell.

In particular embodiments, the first uplink transmission uses a first beam and in response to determining to perform the second uplink transmission, the method further comprises selecting a second beam to use for the second uplink transmission and when the second beam is the same as the first beam the second uplink transmission is transmitted with a second transmit power different from the first transmit power and when the second beam is different from the first beam the second uplink transmission is transmitted with a second uplink time/frequency resource different from the first time/frequency resource.

Modifications, additions, or omissions may be made to method 1400 of FIG. 14. Additionally, one or more steps in the method of FIG. 14 may be performed in parallel or in any suitable order.

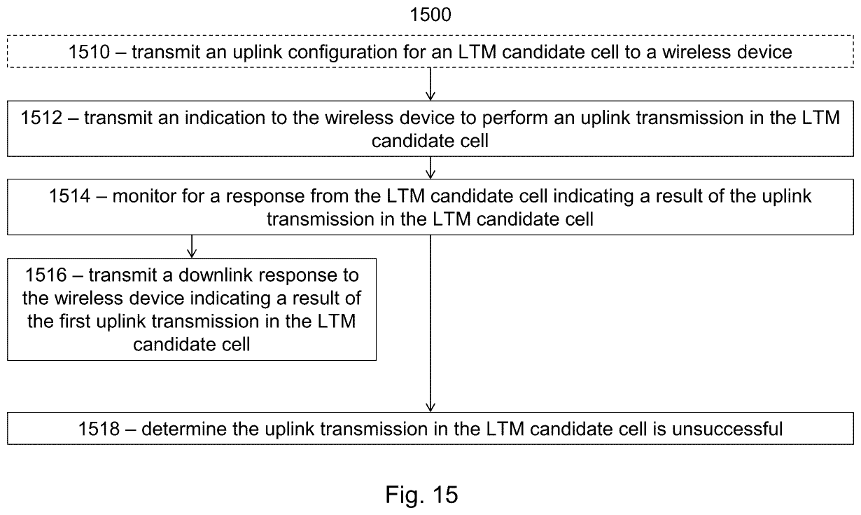

FIG. 15 is a flowchart illustrating an example method in a network node, according to certain embodiments. In particular embodiments, one or more steps of FIG. 15 may be performed by network node 300 described with respect to FIG. 13. The network node is capable of operating as S-DU for TA management between a wireless device and at least one LTM candidate cell.

The method may begin at step 1510, where the network node (e.g., network node 300) transmits an uplink configuration for an LTM candidate cell to a wireless device. Examples of uplink configurations are described in more detail with respect to the embodiments and examples described above.

At step 1512, the network node transmits an indication to the wireless device to perform an uplink transmission in the LTM candidate cell. Examples of the indication are described in more detail with respect to the embodiments and examples described above.

At step 1514, the network node monitors for a response from the LTM candidate cell indicating a result of the uplink transmission in the LTM candidate cell. Examples of monitoring for a response are described in more detail with respect to the embodiments and examples described above.

When a response is received from the LTM candidate cell within a preconfigured threshold time, the method continues to step 1516, where the network node transmits a downlink response to the wireless device indicating a result of the first uplink transmission in the LTM candidate cell. In particular embodiments, the downlink response comprises a timing advance value for use in the LTM candidate cell.

When the response is not received from the LTM candidate cell within the preconfigured threshold time, the method continues to step 1518, where the network node determines the uplink transmission in the LTM candidate cell is unsuccessful.

In some embodiments, not receiving a response may refer to not receiving a response indicating successful reception of the first uplink transmission. For example, in some embodiments, the LTM candidate cell may respond with an indication that the first uplink transmission in the LTM candidate cell was unsuccessful.

Modifications, additions, or omissions may be made to method 1300 of FIG. 15. Additionally, one or more steps in the method of FIG. 15 may be performed in parallel or in any suitable order.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

Some example embodiments are included below.

### Group A Embodiments

1. A method performed by a wireless device for L1/L2 triggered mobility (LTM), the method comprising:
   obtaining an uplink configuration for a LTM candidate cell;
   receiving an indication from a serving cell to perform an uplink transmission in the LTM candidate cell;
   transmitting a first uplink transmission in the LTM candidate cell with a first transmit power and on a first uplink time/frequency resource;
   monitoring for a downlink response from the serving cell indicating a result of the first uplink transmission in the LTM candidate cell;
   when the downlink response is received from the serving cell within a preconfigured threshold time, the first uplink transmission in the LTM candidate cell is determined to be successful; and
   when the downlink response is not received from the serving cell within the preconfigured threshold time, the first uplink transmission in the LTM candidate cell is determined to be unsuccessful and the method further comprises transmitting a second uplink transmission in a second LTM candidate cell, wherein the second uplink transmission is transmitted with one or more of a second transmit power different from the first transmit power and a second uplink time/frequency resource different from the first time/frequency resource.
2. The method of embodiment 1, wherein the second LTM candidate cell is the same cell as the first LTM candidate cell.
3. The method of embodiment 1, wherein the second LTM candidate cell is a different cell than the first LTM candidate cell.
4. A method performed by a wireless device, the method comprising:
   any of the wireless device steps, features, or functions described above, either alone or in combination with other steps, features, or functions described above.
5. The method of the previous embodiment, further comprising one or more additional wireless device steps, features or functions described above.
6. The method of any of the previous embodiments, further comprising:
   providing user data; and
   forwarding the user data to a host computer via the transmission to the base station.

### Group B Embodiments

7. A method performed by a base station operating as a Serving Distributed Unit (SDU) for timing advance (TA) management between a wireless device and at least one L1/L2 triggered mobility (LTM) candidate cell, the method comprising:
   transmitting an indication to a wireless device to perform an uplink transmission in the LTM candidate cell;
   monitoring for a response from the LTM candidate cell indicating a result of the uplink transmission in the LTM candidate cell;
   when the response is received from the LTM candidate cell within a preconfigured threshold time, the uplink transmission in the LTM candidate cell is determined to be successful; and
   when the response is not received from the LTM candidate cell within the preconfigured threshold time, the uplink transmission in the LTM candidate cell is determined to be unsuccessful.
8. A method performed by a base station, the method comprising:
   any of the steps, features, or functions described above with respect to base station (e.g., Serving DU, Candidate DU, etc.), either alone or in combination with other steps, features, or functions described above.
9. The method of the previous embodiment, further comprising one or more additional base station steps, features or functions described above.
10. The method of any of the previous embodiments, further comprising:
   obtaining user data; and
   forwarding the user data to a host computer or a wireless device.

### Group C Embodiments

11. A mobile terminal comprising:
   processing circuitry configured to perform any of the steps of any of the Group A embodiments; and
   power supply circuitry configured to supply power to the wireless device.
12. A base station comprising:
   processing circuitry configured to perform any of the steps of any of the Group B embodiments;
   power supply circuitry configured to supply power to the wireless device.
13. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
14. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
15. The communication system of the pervious embodiment further including the base station.
16. The communication system of the previous 2 embodiments, further including the UE, wherein the UE is configured to communicate with the base station.
17. The communication system of the previous 3 embodiments, wherein:
   the processing circuitry of the host computer is configured to execute a host application, thereby providing the user data; and
   the UE comprises processing circuitry configured to execute a client application associated with the host application.
18. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
19. The method of the previous embodiment, further comprising, at the base station, transmitting the user data.
20. The method of the previous 2 embodiments, wherein the user data is provided at the host computer by executing a host application, the method further comprising, at the UE, executing a client application associated with the host application.
21. A user equipment (UE) configured to communicate with a base station, the UE comprising a radio interface and processing circuitry configured to performs any of the previous 3 embodiments.
22. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
23. The communication system of the previous embodiment, wherein the cellular network further includes a base station configured to communicate with the UE.
24. The communication system of the previous 2 embodiments, wherein:
   the processing circuitry of the host computer is configured to execute a host application, thereby providing the user data; and
   the UE's processing circuitry is configured to execute a client application associated with the host application.
25. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
26. The method of the previous embodiment, further comprising at the UE, receiving the user data from the base station.
27. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
28. The communication system of the previous embodiment, further including the UE.
29. The communication system of the previous 2 embodiments, further including the base station, wherein the base station comprises a radio interface configured to communicate with the UE and a communication interface configured to forward to the host computer the user data carried by a transmission from the UE to the base station.
30. The communication system of the previous 3 embodiments, wherein:
   the processing circuitry of the host computer is configured to execute a host application; and
   the UE's processing circuitry is configured to execute a client application associated with the host application, thereby providing the user data.
31. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
32. A method implemented in a communication system including a host computer, a base station and a user equipment (UE), the method comprising:
   at the host computer, receiving user data transmitted to the base station from the UE, wherein the UE performs any of the steps of any of the Group A embodiments.
33. The method of the previous embodiment, further comprising, at the UE, providing the user data to the base station.
34. The method of the previous 2 embodiments, further comprising:
   at the UE, executing a client application, thereby providing the user data to be transmitted; and
   at the host computer, executing a host application associated with the client application.
35. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
36. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
37. The communication system of the previous embodiment further including the base station.
38. The communication system of the previous 2 embodiments, further including the UE, wherein the UE is configured to communicate with the base station.
39. The communication system of the previous 3 embodiments, wherein:
   the processing circuitry of the host computer is configured to execute a host application;
   the UE is configured to execute a client application associated with the host application, thereby providing the user data to be received by the host computer.
40. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
41. The method of the previous embodiment, further comprising at the base station, receiving the user data from the UE.
42. The method of the previous 2 embodiments, further comprising at the base station, initiating a transmission of the received user data to the host computer.

1. A method performed by a wireless device for layer one, L1/layer two, L2, triggered mobility, LTM, the method comprising:
obtaining an uplink configuration for an LTM candidate cell;
receiving an indication from a serving cell to perform an uplink transmission in the LTM candidate cell;
transmitting a first uplink transmission in the LTM candidate cell with a first transmit power and on a first uplink time/frequency resource;
monitoring for a downlink response from the serving cell indicating a result of the first uplink transmission in the LTM candidate cell;
when the downlink response is received from the serving cell within a preconfigured threshold time, determining the first uplink transmission in the LTM candidate cell is successful; and
when the downlink response is not received from the serving cell within the preconfigured threshold time, the first uplink transmission in the LTM candidate cell is determined to be unsuccessful and the method further comprises transmitting a second uplink transmission in a second LTM candidate cell, wherein the second uplink transmission is transmitted with one or more of a second transmit power different from the first transmit power and a second uplink time/frequency resource different from the first time/frequency resource.

2. The method of claim 1, wherein the second LTM candidate cell is the same cell as the first LTM candidate cell.

3. The method of claim 1, wherein the second LTM candidate cell is a different cell than the first LTM candidate cell.

4. The method of claim 1, wherein the downlink response received from the serving cell comprises a timing advance value for use in a LTM candidate cell.

5. The method of claim 1, wherein the first uplink transmission and the second uplink transmission comprise transmission of a random access preamble.

6. (canceled)

7. The method of claim 1, wherein the first uplink transmission uses a first beam and in response to determining to perform the second uplink transmission, the method further comprises selecting a second beam to use for the second uplink transmission and when the second beam is the same as the first beam the second uplink transmission is transmitted with a second transmit power different from the first transmit power and when the second beam is different from the first beam the second uplink transmission is transmitted with a second uplink time/frequency resource different from the first time/frequency resource.

8. The method of claim 1, wherein the indication comprises a physical downlink control channel, PDCCH, order.

9. The method of claim 1, wherein the uplink configuration for the uplink candidate cell comprises one or more random access parameters and the indication comprises an indication of which of the one or more random access parameters to use for the first uplink transmission.

10. The method of claim 1, wherein the indication comprises an indication of a synchronization signal block, SSB, associated with the first uplink transmission.

11. The method of claim 1, wherein the uplink configuration for the uplink candidate cell comprises more than one uplink configuration for more than one uplink candidate cell and the indication comprises an indication of which uplink candidate cell in which to transmit the first uplink transmission.

12. A wireless device capable of layer one, L1/layer two, L2, triggered mobility, LTM, the wireless device comprising processing circuitry operable to:
obtain an uplink configuration for an LTM candidate cell;
receive an indication from a serving cell to perform an uplink transmission in the LTM candidate cell;
transmit a first uplink transmission in the LTM candidate cell with a first transmit power and on a first uplink time/frequency resource;
monitor for a downlink response from the serving cell indicating a result of the first uplink transmission in the LTM candidate cell;
when the downlink response is received from the serving cell within a preconfigured threshold time, determine the first uplink transmission in the LTM candidate cell is successful; and
when the downlink response is not received from the serving cell within the preconfigured threshold time, the first uplink transmission in the LTM candidate cell is determined to be unsuccessful and the processing circuitry is further operable to transmit a second uplink transmission in a second LTM candidate cell, wherein the second uplink transmission is transmitted with one or more of a second transmit power different from the first transmit power and a second uplink time/frequency resource different from the first time/frequency resource.

13-22. (canceled)

23. A method performed by a network node operating as a serving distributed unit, S-DU, for timing advance, TA, management between a wireless device and at least one layer one, L1/layer two, L2, triggered mobility, LTM, candidate cell, the method comprising:
transmitting an indication to the wireless device to perform an uplink transmission in the LTM candidate cell;
monitoring for a response from the LTM candidate cell indicating a result of the uplink transmission in the LTM candidate cell;
when the response is received from the LTM candidate cell within a preconfigured threshold time, transmitting a downlink response to the wireless device indicating a result of the first uplink transmission in the LTM candidate cell; and
when the response is not received from the LTM candidate cell within the preconfigured threshold time, determining the uplink transmission in the LTM candidate cell is unsuccessful.

24. The method of claim 23, further comprising transmitting an uplink configuration for the LTM candidate cell to the wireless device.

25. The method of claim 23, wherein the downlink response comprises a timing advance value for use in the LTM candidate cell.

26. The method of claim 23, wherein the first uplink transmission comprises transmission of a random access preamble.

27. The method of claim 23, wherein the indication comprises a physical downlink control channel, PDCCH, order.

28. The method of claim 24, wherein the uplink configuration for the LTM candidate cell comprises one or more random access parameters and the indication comprises an indication of which of the one or more random access parameters to use for the first uplink transmission.

29. The method of claim 24, wherein the uplink configuration for the uplink candidate cell comprises more than one uplink configuration for more than one uplink candidate cell and the indication comprises an indication of which uplink candidate cell in which to transmit the first uplink transmission.

30. The method of claim 23, wherein the indication comprises an indication of a synchronization signal block, SSB, associated with the first uplink transmission.

31. A network node capable of operating as a serving distributed unit, S-DU, for timing advance, TA, management between a wireless device and at least one layer one, L1/layer two, L2, triggered mobility, LTM, candidate cell, the network node comprising processing circuitry operable to:
transmit an indication to the wireless device to perform an uplink transmission in the LTM candidate cell;
monitor for a response from the LTM candidate cell indicating a result of the uplink transmission in the LTM candidate cell;
when the response is received from the LTM candidate cell within a preconfigured threshold time, transmit a downlink response to the wireless device indicating a result of the first uplink transmission in the LTM candidate cell; and
when the response is not received from the LTM candidate cell within the preconfigured threshold time, determine the uplink transmission in the LTM candidate cell is unsuccessful.

32.-38. (canceled)
